(19) United States
(12) Patent Application Publication
(10) Pub. No.: US 2009/0043584 A1
(43) Pub. Date: Feb. 12, 2009

(54) System and method for phonetic representation

(76) Inventor: Lawrence Brooke Frank Philips, Oakland, CA (US)

Correspondence Address: Lawrence Philips, 1708 Indian Way, Oakland, CA, 94611, US

(21) Appl. No.: 11/890,334

(22) Filed: Aug. 6, 2007

(51) Int. Cl. G10L 13/00

(52) U.S. Cl. 704/260; 704/E13.001

(57) ABSTRACT

A method for generating an Approximate Phonetic Representation (APR) of a given word, the word having a sequence of characters, the method comprising: Receiving the word; Generating the APR by applying at least one metaphone3 translation rule to encode one or more of the characters of the given word into a resulting APR; and Returning either the generated APR and/or one or more words matching the APR from a dictionary of words.

### BACKGROUND OF THE INVENTION

1. Field of the Invention

This invention relates, in general, to approximate phonetic representation of phonetically spelled words and more particularly to generating, comparing, and identifying the corresponding intended English word(s).

2. Description of Related Art

Phonetic representations are used in a number of computer applications, such as a web search engine. Here a user may initiate a search based on a phonetic spelling of a word, based on a relatively common pronunciation, which however is misspelled compared to the spelling as found in a dictionary definition. The web search engine may provide some automated correction for commonly misspelled words, and may provide the user with alternative correctly spelled words as suggestions for the intended spelling for the misspelled word. Some search engines attempt to identify the intended word based on the phonetic representation of the user's misspelled keyword using a set of phonetic rules. Understandably, individuals would greatly benefit from a system and method for phonetic representation of a given word that more accurately correlates phonetically misspelled words with the intended word. Unfortunately, existing systems and methods for phonetic representations are limited.

Many of the current phonetic representation systems provide a very limited number of rules that are very generic, and typically generate an inaccurate phonetic representation for many English words. Use of the existing systems is limited because they often fail to correlate a user's phonetically spelled word with the formal or correct spelling of the intended word. These systems frequently require the user to retry spelling a word or perform alternative searches. As a result users often become frustrated with a search.

Different systems and methods typically require many attempts to correlate a given word with the user intended word. Additionally, the many and inconsistent spelling rules of the English language add to the inherent complexity of properly spelling the intended word.

An exemplar of the prior art is U.S. Pat. No. 1,261,167 and U.S. Pat. No. 1,435,663, commonly known as ‘Soundex’. Unfortunately, although Soundex has become very widely implemented, this approach is limited with respect to its encoding strategy, which groups letters together according to only a very general similarity which often leads to inaccurate results, mostly when ignoring the different pronunciations a letter may receive according to the context in which it is found in an English word. One example is the encoding which maps ‘c’, ‘g’, ‘j’, ‘k’, ‘s’, and ‘z’ to the same phonetic encoding symbol, apparently because a ‘c’ may be pronounced with an ‘s’ sound or a ‘k’ sound. This results, in a search for phonetic similarity matches, to “cajun” returning “cygna”. On the other hand, Soundex does not encode the diphthong ‘ph’ to its usual English pronunciation of ‘f’, thus failing to match “Steven” to “Stephan”. Soundex encodes the first letter as is, and encodes subsequent letters with a numeric code. Encoding the first letter as is can often lead to missing words that have identical initial sounds that are spelled with a different letter, such as ‘philip’ vs. ‘filip’. Encoding subsequent letters with a numeric code makes it difficult for the implementer of the algorithm to determine whether the encoding for a particular word is correct.

An exemplar of the prior art is U.S. Pat. No. 4,773,009. While this method makes some small improvements over Soundex, its attempts to arrive at a more accurate encoding are limited, the algorithm uses a complicated two-pass technique, and generally attempts too precise an encoding to be useful for resolving alternate spellings. Among other things, the algorithm always encodes ‘-ght-’ to ‘te’, which would miscode ‘laughter’. Although it is the first patent to attempt to encode non-initial vowels, the approach that it takes in this regard is limited in two respects: 1) if non-initial vowels are always encoded, a common case of misspelling, transposition of letters when it is a vowel and a consonant that are transposed, would not be detected and the desired word would not be retrieved; and 2) the Kucera algorithm attempts to detect different classes of vowels and encode them differently. An example of where this approach would miss the intended word might be mis-spelling ‘dew’ as ‘do’, where the algorithm encodes the first as ‘doo’ and the second as ‘dO’, thus giving different phonetic encodings for two words which are in fact total homophones.

### Non-Patent Public Domain Algorithms

An exemplar of the prior art is NYSIIS, published by the State of New York in 1970. This algorithm is a limited attempt aimed mainly at reducing common variants on similar names that are common in the United States. While recognizing that ‘pf-’ and ‘-ph-’ are usually pronounced as ‘f’, mapping ‘Mac-’ and ‘Mc-’ to the same spelling, and eliminating ‘s’ from the end of all names so as to match e.g. ‘Roberts’ to ‘Robert’, it does not seriously address the problem of matching non-name words.

An exemplar of the prior art is Metaphone, published by Lawrence Philips in 1990 and proposed as a replacement for Soundex. This algorithm improves on previous approaches by, among other things, attempting to correctly code cases where ‘gh’ is pronounced as ‘f’ as in ‘laugh’ and when it is silent, as in ‘dough’, or where ‘t’, ‘c’, and ‘s’ are pronounced as ‘sh’ (or ‘ch’, which is treated as a sound that is similar enough to ‘sh’ to be mapped to the same encoding value) as in ‘ratio’, ‘ciao’, and ‘erosion’. Metaphone encodes to an all letter key instead of using the mixed letter and number key of Soundex, which greatly improves the ease of detecting errors for the implementer and user. However, once in use it became apparent that while Metaphone resulted in an improvement in accuracy over Soundex that caused it to become widely used, it still failed to encode many common words accurately, including the silent ‘l’ in ‘lincoln’, and the case of ‘school’ where ‘-ch-’ is pronounced as ‘k’. Also, by using the Soundex style of encoding an initial vowel as is, the algorithm ends up with different encodings for ‘Otto’ and ‘auto’, which should be similar enough to match.

An exemplar of the prior art is Double Metaphone, published by Lawrence Philips in 2000, attempts to further improve accuracy over what was achieved by Metaphone. It maps all initial vowels to ‘A’, matching e.g. ‘Otto’ to ‘auto’. It attempts to correctly encode a number of common words and names commonly found in the United States that are of non-english origin and are usually pronounced correctly according to their non-english spellings, by Americans, such as ‘jose’ or ‘pizza’. In addition, it attempts to account for cases where more than one pronunciation may be common in the United States, such as the Spanish name ‘Cabrillo’ which might be plausibly pronounced as ‘cabreeyo’ or ‘cabrillo’. It also introduced a considerably more detailed treatment of exceptions in regular English pronunciation, such as the many cases of silent consonants, such as the silent ‘l’ in ‘lincoln’ or the silent ‘s’ in ‘island’, as well as the pronunciation of ‘s’ as ‘sh’ in ‘sugar’, or an anomaly like ‘caesar’, an unusual case of a ‘c’ followed by an ‘a’ where the ‘c’ is pronounced as ‘s’. However, even with this much more detailed approach, it turns out that a number of common exceptions were still missed, such as the silent ‘p’ in ‘receipt’, many cases where ‘ch’ is pronounced as ‘k’ instead of ‘ch’ as e.g. ‘monarch’, many cases where Americans pronounce words that are familiar but of non-english origin according to the non-english pronunciations, such as ‘chutzpah’, and exceptions such as ‘colonel’, pronounced ‘kernal’, and ‘tucson’, pronounced ‘tooson’. In some environments, a more focused result set was desired, especially when a very large set of candidate words resulted, that could only be supplied by giving the implementer the ability to specify the encoding of non-initial vowels, but there was no existing system that gave a completely correct approximate encoding of vowels, especially in cases where the spelling transposes the pronounced sounds, such as the very common spelling at the end of English words where the consonant and the ‘e’ are pronounced in different order than they are spelled, e.g. ‘apple’ is pronounced as ‘appel’. In short, it developed that considerably more research in anomalies of the American pronunciation of words in common usage in the United States would be required.

What is needed is a more comprehensive set of rules for generating a more useful phonetic representation for identifying, correcting, and/or suggesting the intended word(s) and that overcomes the above and other disadvantages of known phonetic generators. Ideally, such the generator should support both generating a phonetic representation and providing one or more candidate replacement words. The phonetic system may include storage for phonetic representations for a set of words, an ability to receive a word, a generator to generate a phonetic representation for the received word, and a comparison and/or lookup to help identify the intended word. The phonetic system should be relatively easy to use and typically embedded in a software application, such as, for example, client/server system. The phonetic generator should also be relatively easy to configure to support and or customized for individual users and/or large groups of users. Operation of the phonetic generator should also be capable of using a comprehensive set of Metaphone3 rules.

### BRIEF SUMMARY OF THE INVENTION

In summary, one aspect of the present invention is directed to a method for generating an Approximate Phonetic Representation (APR) of a given word, the word having a sequence of characters. Receiving the word and then generating the APR by applying at least one metaphone3 translation rule to encode one or more of the characters of the given word into a resulting APR. The APR can then be returned and/or one or more dictionary words with the same APR can be returned.

The system and method for phonetic representation of the present invention has other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is a block diagram of an Approximate Phonetic Representation (APR) employing a personal computer, input device, and output device, in accordance with the present invention.

FIG. 2 is a block diagram of a word, in accordance with the present invention

FIG. 3 is limited set of M3 rules executed in conjunction with the method of FIG. 4, to illustrate the method of generating a phonetic representation of the example English word.

FIG. 4 is a flowchart illustrating the generation of an APR word, in accordance with the present invention.

FIG. 5 is a flowchart illustrating the approximate phonetic representation method, in accordance with the present invention.

FIG. 6 is a flowchart illustrating the method of identifying an approximate word, in accordance with the present invention.

FIG. 7 depicts an embodiment of a method implemented on a computer readable media, according to the present invention.

FIG. 8 depicts an embodiment of a method executed by a computer system, according to the present invention.

### TABLES

TABLE 1 describes Unique Metaphone3 rules, according to the present invention.

TABLE 2 describes the Complete Metaphone3 rule set which includes both the Unique Metaphone3 rules and at least a subset of the public domain rules, according to the present invention.

TABLE 3 describes the known public domain rules which may be incorporated to form the Complete Metaphone3 rule set, according to the present invention.

TABLE 4 describes the correspondence of the Complete Metaphone3 rule set to the Double Metaphone rule set.

TABLE 5 describes the correspondence of the Complete Metaphone3 rule set to the Original Metaphone rule set.

TABLE 6 describes the correspondence of the Complete Metaphone3 rule set to the Kucera rule set.

TABLE 7 describes the correspondence of the Complete Metaphone3 rule set to the Soundex rule set.

TABLE 8 describes a complete list of encodings according to Double Metaphone, Original Metaphone, and Kucera rule sets.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

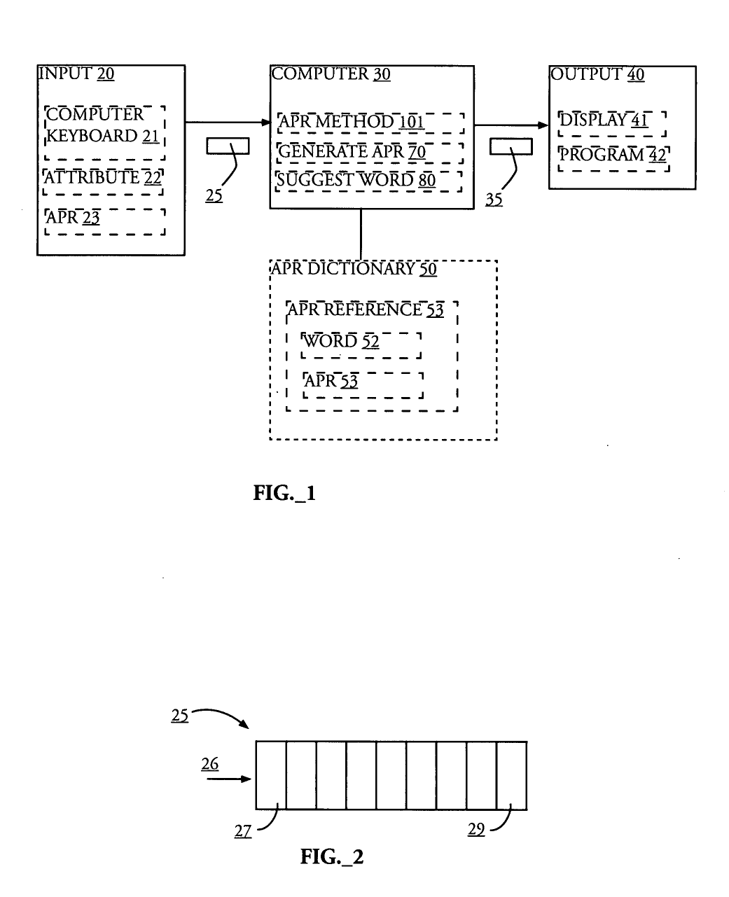

Turning now to the drawings, wherein like components are designated by like reference numerals throughout the various figures, attention is directed to FIGS. 1-4 where a computer, generally designated 30, is illustrated with an input device 20, an output 40, and an APR dictionary 50. According to one embodiment, the computer 30 receives a word 25, generates an APR 70, and sends the generated information 35 to an output 40 such as a display 41 or a computer program 42. According to another embodiment, the computer 30 receives the word 25, generates an APR 70 and suggests one or more words 80 by looks up the generated APR in an APR dictionary 50, which includes mapping of Words 52 and their corresponding APR encodings 53. In yet another embodiment, the computer performs the APR method outline in 101.

FIG. 2 generally illustrates a word 25 with a series of characters starting with a first character 27 and a last character 29 received by the computer 30. Generally encoding an APR for the word 25 will be performed left to right 26 starting with the first character 27 and proceeds to the last character 29.

FIG. 3 generally illustrates a portion of the M3 rules 60, and includes Rule group 61, letters 62, digraph 63, M3 subrules 64, and encoding 65. The M3 rules 60 are defined in Table 1, M3 Rules. Each of the rows represents a Rule Group 61 that may be used to encode a given character of the word 25. The Rule Group 61 is used to encode a given character of the word 25, if the given character matches the letter 62, the context of the Digraph 63 matches, and any Subrule(s) 64 match, then the given character is encoded as a character specified in the encoding 65.

As a general illustration, the word “APPLE” will be encoded using the M3 rules. Starting with the first character and proceeding to the last character to generate an APR representation of the word “APPLE”. The first character “A” matches a letter 62 of Rule Group “0”, no Digraph is identified, Subrule 64 match because the character “A” is the first character. Accordingly, the first character “A” is encoded as an “A” in the APR representation. The second character “P” matches a letter 62 of Rule Group “110” and Rule “110.b”, the Digraph 63 is “PP” that matches the context of “APPLE” because the second character “P” is followed by a third character “P”. Subrule 64 match. Accordingly, the second character “P” and the third character “P” are encoded as a “P” in the APR representation. The fourth character “L” is now compared against Rule Groups 61 for the Letter 62 “L”, Specific cases are typically reviewed first but don't apply because the specific Subrules are not met. The first rule #85 is not applied because the “L” is not followed by “ely”. Continuing to evaluate additional Rule Groups 61, “L” is encodes as “L” according to Rule Group “92” that has a single rule in the rule group. The fifth character “E” is a vowel and is not encode according to this embodiment of the invention. The resulting APR encoding for the word “APPLE” is “APL”.

The word “APPEAL” is similarly encode using the M3 rules. Starting with the first character “A”, matching Rule Group 61, Letter “A”, no Digraph, and matches the subrule as a first letter is encoded as “A”. The second character “P” matches Rule Group 110, with the Digraph of “PP” and is encoded as “P”. The fourth character “E” is a non-initial vowel and is not encoded according to this embodiment of the invention where the switch indicating that non-initials vowels are to be encoded is set to ‘off’. The fifth character “A” is another non-initial vowel and is not encoded. The sixth character “L” matches Rule Group #92 and is encoded as an “L”. The resulting APR encoding of the word “APPEAL” is “APL”.

The word “APUL” is similarly encoded using the M3 rules. The “A” matching Rule Group #0 as an initial vowel is encoded as “A”. The second character “P” matches Rule Group #111 and is encodes as “P”. The third character “U” is a non-initial vowel and is not encoded. The fourth character “L” matches Rule Group #92 and is encoded as “L”. The resulting APR encoding of the word “APUL” is “APL”.

The word “APEL” is similarly encoded using the M3 rules. The “A” matching Rule Group #0 as an initial vowel is encoded as “A”. The second character “P” matches Rule Group #111 and is encodes as “P”. The third character “E” is a non-initial vowel and is not encoded. The fourth character “L” matches Rule Group #92 and is encoded as “L”. The resulting APR encoding of the word “APUL” is “APL”.

The word “ABLE” is similarly encoded using the M3 rules. The “A” matching Rule Group #0 as an initial vowel is encoded as “A”. The second character “B” matches Rule Group #3 and is encodes as “P”. The third character “L” matches Rule Group #92 and is encoded as “L”. The fourth character “E” is a non-initial vowel and is not encoded. The resulting APR encoding of the word “ABLE” is “APL”.

The word “APRIL” is similarly encoded using the M3 rules. The “A” matching Rule Group #0 as an initial vowel is encoded as “A”. The second character “P” matches Rule Group #111 and is encodes as “P”. The third character. The fourth character “I” is a non-initial vowel and is not encoded. The fifth character “L” matches Rule Group #92 and is encoded as “L”. The resulting APR encoding of the word “APRIL” is “APRL”.

APR Dictionary 50 may include a number of words and their corresponding Approximate Phonetic Representations, such as for example the following Word, APR pairs: APRIL, APRL; ABLE, APL; APEAL, APL, APPLE, APL. A number of different correlations will be apparent to one skilled in the art.

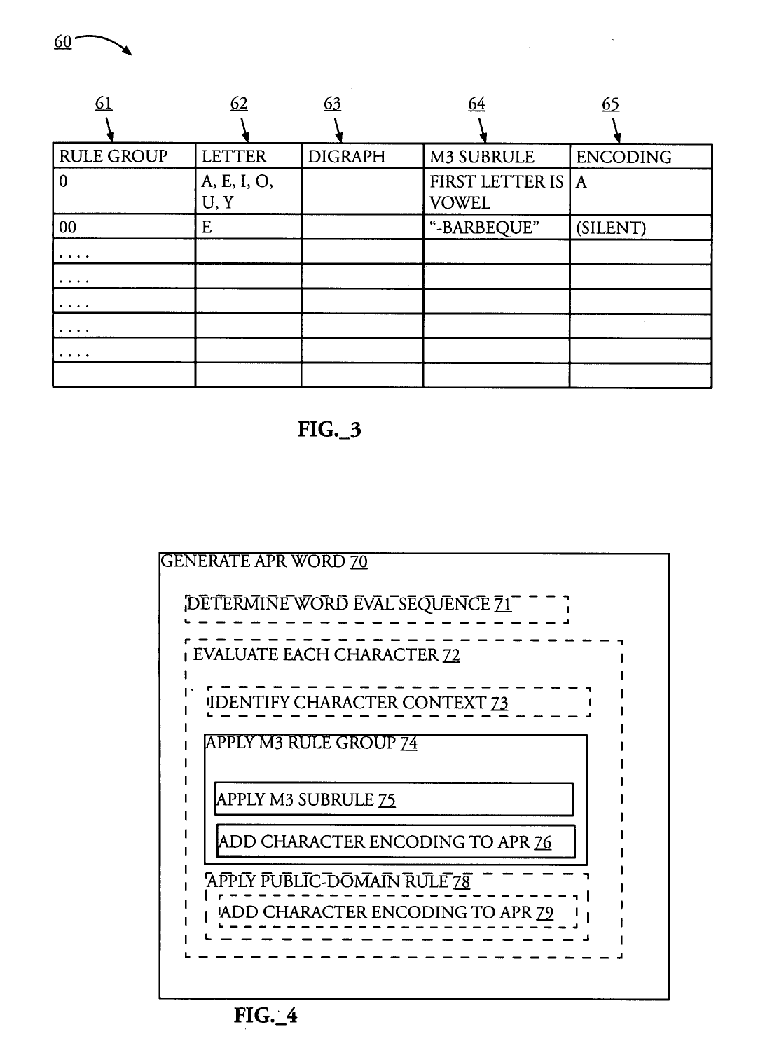

FIG. 4 illustrates generating an APR word 70 including determining a word evaluation sequence 71, and evaluating each character 72 to encode a representative APR. The Evaluation Sequence 71 is typically performed left to right, potentially skipping characters based on the Digraph. One skilled in the art will appreciate a number of other approaches for an evaluation sequences.

Evaluating each character 72 of a given word is performed based, in part, on the context of the character 73, the application of at least one Metaphone3 rule group 74. As illustrated in the above examples, encoding a character of the given word can include an evaluation of the Rule group 61, based on the matching letter 62, character context described by the Digraph 63, and further qualifications identified by the M3 Subrule 64, for the encoding 65 of the given character or character group. The Encoding 65 is added to the APR 76. As illustrated above the character group “P” followed by the letter “P” was encoded as a single character “P”. In addition to the application of Metaphone 3 rule group, Public-Domain rule 78 may also be used to add character encoding to APR 79. For example the Rule Group #0 was previously available in Double Metaphone, and provides that any vowel as the first letter of a word should be encoded as an “A”.

Metaphone 3 rules provide many additional rules that improve word encoding such that a typical user attempting to spell a given word phonetically has a higher probability of matching the provided word match the intend word.

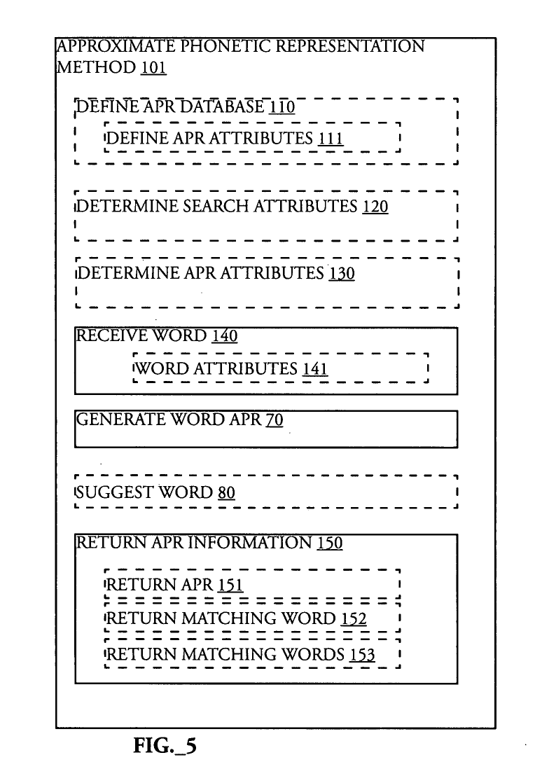

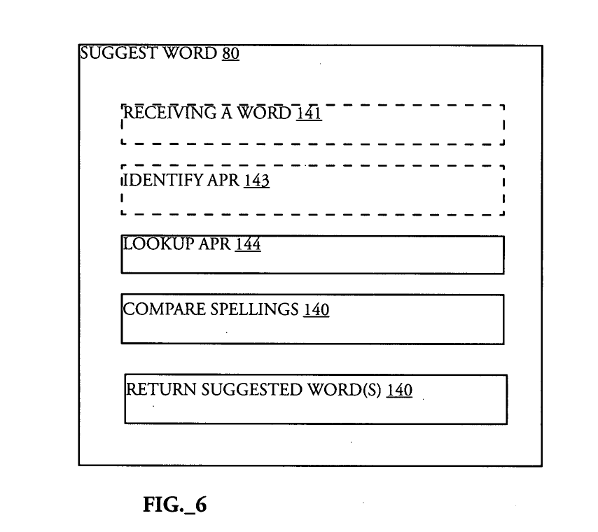

FIG. 5 provides an overview of an approximate Phonetic Representation Method 101 according to one embodiment of the present invention. A received word 140 is used to generate an APR 70 and results in the return of APR information 150. The received word may include word attributes that are included in the generation of the word APR 70. According to one embodiment, the word attributes 141 may indicate trailing vowel encoding, a request to return a set of dictionary words with the same APR value, and/or a request to return a set of dictionary words with the same APR value if the word received in 140 does not match the spelling of any dictionary words with the same APR value.

An APR database is defined 110 and may include a number of APR attributes 111. Ideally the APR database is a relational database that correlates each word in a large dictionary of words with at least one representative APR. For example, a given dictionary word may be associated with a first APR based on a set of default rule groups such as both the M3 translation rules and the set of public-domain translation rules, and a second APR that allows for non-initial vowel encoding. A variety of alternative implementations will be apparent to one skilled in the art.

Determining the search attributes 120 can be used to direct the search according to one embodiment of the present invention. Search attributes may define which APR database(s) to search, the search purpose, and the desired search results. Multiple APR database(s) may be available, such as for example of a client server network. Selection of a given APR database(s) may be based on performance, cost, speed, and/or APR attributes. The search purpose may be to verify spelling, provide alternative similarly pronounced words, provide alternative similarly pronounced words and definitions, and/or web searching, In web searching, the search may be performed with verified correctly spelled words, and/or a selection of similarly pronounced words. Alternatively, for a misspelled word, a selection of alternative words and brief descriptions may be provided such that the user can select the intended word or words and complete the web search. A variety of alternative uses will be apparent to one skilled in the art.

Determine APR attributes 130 may be defined in the APR database 110, may be provided with the received word 140 as a word attribute 141. The APR attributes can identify which translation rules to use to generate the word APR 70 and/or which APR set of APR's in the APR Database to compare with the generated APR. For example, if non-initial vowels are encoded into a generated APR then the resulting APR would be compared against corresponding APR's for an APR database that were also generated with the encoding of non-initial vowels. The APR attributes may be static for one implementation and dynamic for another. For example, user input may provide an attribute to encode trailing vowels, such as Vowel_Encoding_Setting with two potential values of Initial_Only and All_Vowels. Only the initial vowel is encode with the Initial_Only value, and all vowels would be encoded with the All_Vowel value. In another embodiment of the present invention, a second search by the same user will be realized by the software, and return more detailed information instead of return the same information. A variety of other APR attributes will also be appreciated by one skilled in the art.

One or more candidate words may be suggested 80. A given word, the word's attributes and context, and/or attributes of a client sending the word may be used to suggest a candidate word(s), word definition, and/or similar phonetic words. For example, a word attribute may suggest or define the words placement on a sentence and the type of word. The type of word may be a noun, verb, or specific to a particular industry. According to one embodiment, the APR database may include Word, APR, and Word attributes for use in suggesting and/or ordering suggested words based in part on the Word attributes. Accordingly the more attributes that correspond to a given word and/or requestor can be used to suggest one or more intended words. Suggested words can also be prioritized based on the available attributes to provide a higher success rate.

Returning APR information 150 may include returning the APR 151, a matching word 152, and/or returning one or more matching words 153. Additional information may also be returned, based in part on the various attributes, such as for example, the search attributes, the APR attributes, the word attributes, a particular implementation, and/or the APR database(s).

FIG. 6 illustrates on method for suggesting a word 80 according to the present invention. Receiving a word 141 identifying an APR 143, looking up the APR 144 to identify candidate words, comparing 140 the spelling of candidate word with the received word, and returning one or more suggested word 140.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

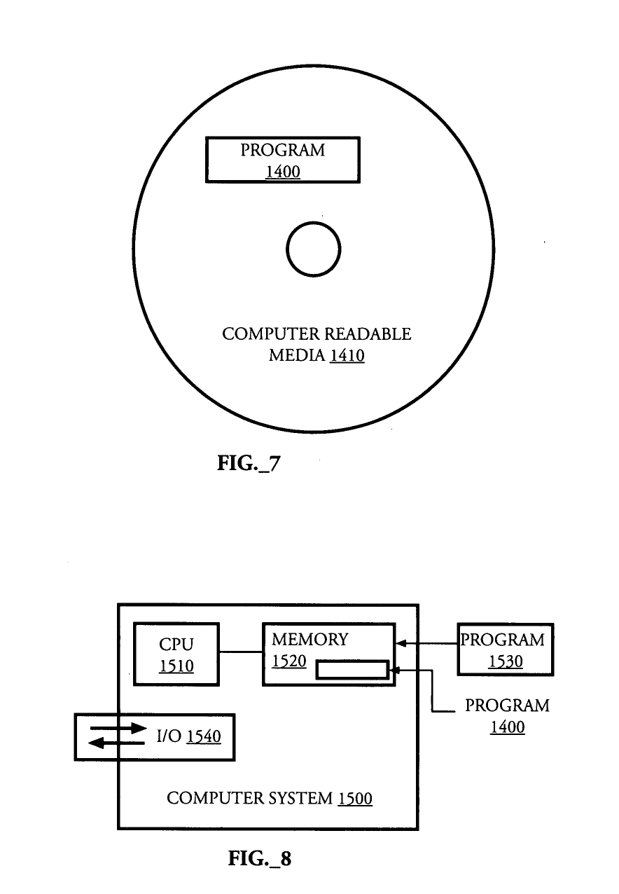

FIG. 7 depicts an embodiment of the method according to the present invention on a computer readable media. A computer program 1200 representing at least one of the methods described herein. The program 1200 is coupled with a computer readable media 1210, such that a computer or computer system could read and execute the computer program 1200.

FIG. 8 depicts a computer system 1300 including a CPU 1310, a memory 1320, and support for input and output 1340. The computer program 1330 may be loaded into a memory 1320 accessible to the computer or the computer system 1300, which is capable of executing the program 1330. Alternatively, the program 1330 may be permanently embedded in the memory 1320. The support for input and output 1340 typically interacts with the program 1200.

Table 1 provides a list of Unique Metaphone 3 rules that follow the outline described above with FIG. 3. A given rule is used to encode a character matching the Letter 62, if context matches the Digraph 63, and any M3 subrule 64 matches such that the word character

Subrules 64 include a context matching syntax with exact matching context, leading character, ending character, non-first character, non-last character, and a matching substring. An exact matching substring includes “ABCD”, indicating that the character(s) match and that there are no other characters in the given word. A leading character matching substring might be “A-” describes a context with the character “A” followed by zero or more characters. An ending-character substring might be “-A”, describing the character “A” preceded by one or more characters. The matching substring “-ABLE-” matches the 4 characters “able” with at least zero or more leading characters and zero or more trailing characters.

Metaphone3 Consonant vowel transposition rules include metaphone3 rules number: 000.

Metaphone3 Familiar non-English rules include metaphone3 rules number: 00, 4, 5, 8, 9 and 10, 11, 12, 17.a, 27, 31, 33, 36, 49, 52, 60, 62, 69, 70, 74, 75, 77, 78, 80, 87, 88, 90, 91, 107, 108, 114, 117, 126, 127, 158, 178, 180, 185, 186, 187.

Metaphone3 Vowel following consonant rules include metaphone3 rules number: 5, 6, 8 and 14, 15, 26, 33, 53-67, 129-148, 159-163.

Metaphone3 H following consonant rules include metaphone3 rules number: 9-12, 35-45, 105, 106, 125-128, 152-156, 174, 175, 188.

Metaphone3 Unpronounced consonant rules include metaphone3 rules number: 1, 2, 4, 11, 13, 16, 17, 18, 27, 31, 39, 41, 43, 46, 47, 49, 50, 52, 69, 71, 81-83, 85, 87-89, 93, 97, 102-104, 107-110, 112, 114, 115, 117-12, 151, 155, 158, 164, 172, 180.

Metaphone3 Letter group rules include metaphone3 rules number: 000, 2, 6-13, 17, 17.a, 18, 21-25, 29, 32-45, 69, 79, 83, 90, 91, 94, 95, 98, 103-107, 110, 112, 115, 119-121, 124, 126-128, 134-136, 143-146, 149, 152, 154-157, 165-168, 170, 174, 175, 175.b, 181, 183, 185, 188, 189.

Metaphone3 Exception Rules include metaphone3 rules number: 55, 66, 86, 107, 122, 155, 165, 177, 178.

TABLE 1 describes Unique Metaphone3 rules, according to the present invention. TABLE 2 describes the Complete Metaphone3 rule set which includes both the Unique Metaphone3 rules and at least a subset of the public domain rules, according to the present invention. TABLE 3 describes the known public domain rules which may be incorporated to form the Complete Metaphone3 rule set, according to the present invention. TABLE 4 describes the correspondence of the Complete Metaphone3 rule set to the Double Metaphone rule set.

Advantageously, the approximate phonetic representation can receive a word, generate a corresponding APR that can be compared against a dictionary to identify one or more correctly spelled words with the same phonetic representation. Consequently, a user can spell words phonetically resulting in the intended word, based in part on a phonetic dictionary.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

TABLE 1
TABLE OF ENCODING RULES UNIQUE TO METAPHONE 3

| | | | METAPHONE 3: | | | |
|---|---|---|---|---|---|---|
| Rule Group | Letter | Digraph | Rule | Encoding | Alternate | Remarks |
| 00 | E or UE | | a.) [“-GUE” AND NOT: | (silent) | | VOWEL |
| | | | “-ARGUE” (vowel pron in | | | ENCODING |
| | | | ‘ague’??) | | | RULES - ‘E’ |
| | | | “-SEGUE” | | | mostly |
| | | | “-PIROGUE”] | | | French, |
| | | | b.)[“-QUE” AND NOT: | | | Spanish, and |
| | | | “-BARBEQUE” | | | transliterated |
| | | | “-PALENQUE” | | | greek words |
| | | | “-APPLIQUE” | | | where vowel |
| | | | “-RISQUE” | | | pronounced |
| | | | “-COMMUNIQUE”] | | | in contexts |
| | | | c.) [“-<consonant>E” AND | | | where it |
| | | | NOT: (ADD THESE RULES TO | | | ordinarily |
| | | | CODE!!!) | | | would not be. |
| | | | “-PERSEPHONE-” | | | ALL NEW |
| | | | “-ANDROMACHE-” | | | |
| | | | “-NIETSCHE-” | | | |
| | | | “-RILKE-” & etc.] | | | |
| | | | d.) [“-<consonant>ES” OR “- | | | |
| | | | <consonant>ED” AND NOT: | | | |
| | | | “-TED” | | | |
| | | | “-SES” | | | |
| | | | “-ACLES” | | | |
| | | | “-OCLES” | | | |
| | | | “-AKLES”] | | | |
| | | | (ADD RULE TO CODE: | | | |
| | | | “HERCULES”) | | | |
| | | | e.)“-<consonant>ELESS” | | | |
| | | | f.)“-<consonant>ENESS” | | | |
| | | | g.)“-<consonant>ELY” | | | |
| | | | h.)“-LES” | | | |
| | | | i.)“-LED” | | | |
| | | | j.)“-RLEST-” | | | |
| | | | k.)[“- | | | |
| | | | <letter><vowel>LE<consonant>” | | | |
| | | | AND NOT: | | | |
| | | | “-LER” | | | |
| | | | “-LET” | | | |
| | | | OR IN RULE 000] | | | |
| | | | 1.)[“-<letter><vowel>LE” AND | | | |
| | | | NOT IN RULE 000] | | | |
| 000 | E | LE | a.)[“-<consonant>LE-” AND | AL | | SPECIAL |
| | | | NOT: | | | VOWEL |
| | | | “-LLE-” | | | ENCODING |
| | | | “-RLE-” | | | (WHEN |
| | | | “-HLE-” | | | TURNED ON) |
| | | | “-WLE-” | | | RULES |
| | | | “-ECCLESI-” | | | GOVERNING |
| | | | “-COMPLEC-” | | | TRANSPOSITION |
| | | | “-EMBLEM-” | | | OF ‘E’ |
| | | | “-LE<vowel>-” | | | AND ‘L’ AS |
| | | | “-LET” | | | IN, E.G., |
| | | | “-LETTING-” | | | “TABLE” => |
| | | | “-LETELY-” | | | TAPAL AND |
| | | | “-LETTER-” | | | NOT => |
| | | | “-LETION-” | | | TAPL |
| | | | “-LETIAN-” | | | ALL NEW |
| | | | “-LETING-” | | | |
| | | | “-LETORY-” | | | |
| | | | “-LETUS-” | | | |
| | | | “-LETIV-” | | | |
| | | | “-LESS-” | | | |
| | | | “-LESQ-” | | | |
| | | | “-LECT-” | | | |
| | | | “-LEDG-” | | | |
| | | | “-LETE-” | | | |
| | | | “-LETH-” | | | |
| | | | “-LETS-” | | | |
| | | | “-LEG-” | | | |
| | | | “-LER-” | | | |
| | | | “-LEX-” | | | |
| | | | [“-LEMENT” UNLESS: | | | |
| | | | “-BATTLE-” | | | |
| | | | “-TANGLE-” | | | |
| | | | “-PUZZLE-” | | | |
| | | | “-RABBLE-” | | | |
| | | | “-BABBLE-” | | | |
| | | | “-TABLE-”] | | | |
| | | | “-ACLES” | | | |
| | | | “-OCLES” | | | |
| | | | “-AKLES” | | | |
| | | | “-LISLE-” | | | |
| | | | “-AISLE-” | | | |
| | | | “-PROBLEM-” | | | |
| | | | “-RESPLEN-” | | | |
| | | | “-REPLEN-” | | | |
| | | | “-SPLE-” | | | |
| 1 | B | | a.)“-DEBT-” | (silent) | P | ‘B’ dropped |
| | | | b.)“-SUBTL-” | | | because of |
| | | | c.)“-SUBTIL-” | | | difficulty of |
| | | | d.)“-DOUBT-” | | | pronouncing |
| | | | h.)[“-LAMB-” h.1)AND NOT: | | | consonant |
| | | | “-LAMBEN-” | | | group |
| | | | “-LAMBER-” | | | NEW: |
| | | | “-LAMBET-” | | | a.), b.), c.), |
| | | | “-LAMBRE-”] | | | d.), h.1), i.1), j.1), |
| | | | i.)[“-NUMB-” i.1)AND NOT: | | | j.1.a), |
| | | | “-NUMBER-”] | | | |
| | | | j.)[“-TOMB-” j.1)AND NOT: | | | |
| | | | “-TOMBIG-”] | | | |
| | | | j.1.a)AND NOT: | | | |
| | | | “-MBO-” | | | |
| | | | [“-MBA-” j.1.a.1)AND NOT: | | | |
| | | | “-DUMBASS-”]} | | | |
| 2 | B | BB | b.)“-BP-” | P | | 2.a NOT NEW |
| | | BP | | | | 2.b NEW |
| 4 | C | | a.)“CT-” | (silent) | | At start of |
| | | | b.)“CN-” | | | word. |
| | | | | | | Possibly |
| | | | | | | retention |
| | | | | | | representing |
| | | | | | | sound in |
| | | | | | | original |
| | | | | | | language that |
| | | | | | | was never |
| | | | | | | pronounced |
| | | | | | | by English |
| | | | | | | speakers. |
| | | | | | | E.g, |
| | | | | | | “Ctesiphon” |
| | | | | | | NEW |
| 5 | C | | b.)“CAEC-” | S | K | Greek roots, |
| | | | c.)“CAEM-” | | | words |
| | | | d.)“COEL-” | | | normally |
| | | | e.)“COENA-” | | | spelled with a |
| | | | f.)“COENO-” | | | cedilla to |
| | | | g.)“-FLACCID-” | | | indicate C as |
| | | | h.)“FRANCAIS” | | | S (french and |
| | | | i.)“FRANCAIX” | | | portugese), |
| | | | j.)“FRANCOIS” | | | other |
| | | | k.)“LINGUICA” | | | exceptions |
| | | | l.)“FACADE-” | | | ALL NEW |
| | | | m.)“GARCON” | | | EXCEPT FOR |
| | | | | | | a.) |
| 6 | C | CC | a.){[“-CCI-” a.1)AND NOT: | KS | | E.g., |
| | | | 8.a)-8.e) | | | “accident”, |
| | | | OR “-FLACCID-”] | | | “accede” |
| | | | c.)“-CCY-” | | | NEW: |
| | | | 6.a)-6.c) c.1)AND NOT: | | | a.), c.) |
| | | | 7.c} | | | |
| 8 | C | CC | a.)“-CCIA-” | X | | Italian |
| | | | b.)“-CCI” | | | familiar to |
| | | | c.)“-CCIO-” | | | Americans, |
| | | | d.)“-CCINO” | | | e.g., |
| | | | e.)“-CCINI” | | | “focaccia” |
| | | | | | | a.) NEW |
| | | | | | | SINCE |
| | | | | | | RESTRICTS |
| | | | | | | TO DOUBLE |
| | | | | | | ‘C’ |
| 9 | C | CH | b.)[“ACH-” b.1)AND NOT: | K | X | Michael |
| | | | “ACHES-” | | | German |
| | | | “ACHEU-” | | | names |
| | | | “ACHIE-” | | | words with |
| | | | b.1.a)UNLESS: | | | Greek roots |
| | | | “EARACH-” | | | b.1) NEW |
| | | | “HEADACH-”, | | | SINCE |
| | | | “BACKACH-” | | | RESTRICTS |
| | | | “HEARTACH-”, | | | MORE |
| | | | “BELLYACH-”, | | | NEW: |
| | | | “TOOTHACH-”] | | | b.1.a), |
| | | | c.)“ECHO-” | | | c.), d.), f.1), |
| | | | d.)[“<not vowel>ACH<not I or | | | i.)through |
| | | | E>” | | | j.), m.) |
| | | | f.)“-MACHER-” f.1)AND NOT: | | | through r.), |
| | | | IN RULES: 12.g)-12.m)] | | | w.) through |
| | | | i.)[“-ARCH-” i.1)AND NOT: | | | mm.) |
| | | | IN RULES: 12.n)-12.cc)] | | | |
| | | | j.)“-CHAMOM-” | | | |
| | | | m.)“-CHARTO-” | | | |
| | | | n.)“-CHARTU-” | | | |
| | | | o.)“-CHARYB-” | | | |
| | | | p.)“-CHRIST-” | | | |
| | | | q.)“-CHEMIC-” | | | |
| | | | r.)“-CHILIA-” | | | |
| | | | w.)“-CHOND-” | | | |
| | | | x.)“-CHONA-” | | | |
| | | | y.)“-CHONI-” | | | |
| | | | z.)“-CHOIR-” | | | |
| | | | aa.)“-CHASM-” | | | |
| | | | bb.)“-CHARO-” | | | |
| | | | cc.)“-CHROM-” | | | |
| | | | dd.)“-CHROI-” | | | |
| | | | ee.)“-CHAMA-” | | | |
| | | | ff.)“-CHALC-” | | | |
| | | | gg.)“-CHALD-” | | | |
| | | | hh.)“-CHAET-” | | | |
| | | | ii.)“-CHIRO-” | | | |
| | | | jj.)“-CHILO-” | | | |
| | | | kk.)“-CHELA-” | | | |
| | | | ll.)“-CHOUS-” | | | |
| | | | mm.)“-CHEIL-” | | | |
| | C | CH | nn.)“-CHEIR-” | | X | Greek roots |
| | | | oo.)“-CHEIM-” | | | NEW: |
| | | | pp.)“-CHITI-” | | | nn.) through |
| | | | qq.)[“-CHISM-” qq.1)AND NOT: | | | rr.) |
| | | | “MACHISMO” | | | ss.1.b) |
| | | | “REVANCHISM”] | | | tt.), vv.), |
| | | | rr.)[“-CHELI-” rr.1)AND NOT: | | | xx.), yy.), |
| | | | “RICHELIEU”] | | | zz.), |
| | | | ss.)[“-CHOR-” ss.1)AND NOT: | | | aaa.1), bbb.) |
| | | | ss.1.a)“CHORE-” | | | through |
| | | | ss.1.b)“CHORT-”] | | | kkk.), mmm.) |
| | | | tt.)[“-CHOL-” tt.1)AND NOT: | | | uuuuu.), |
| | | | “CHOLO-”] | | | wwwww.) |
| | | | vv.)“-CHYL-” | | | through |
| | | | xx.)“-CHAO-” | | | aaaaaa.), |
| | | | yy.)[“-CHOS-” yy.1)AND NOT: | | | cccccc.1), |
| | | | “-CHOSE-”] | | | gggggg.1) |
| | | | zz.)“-CHUS-” | | | |
| | | | aaa.)[“-CHIA-” aaa.1)AND | | | |
| | | | NOT: | | | |
| | | | “APPALACHIA”] | | | |
| | | | bbb.)“-CHIMERA-” | | | |
| | | | ccc.)“-CHIMAER-” | | | |
| | | | ddd.)“-CHIMERI-” | | | |
| | | | eee.)“CHAME-” | | | |
| | | | fff.)“CHELO-” | | | |
| | | | ggg.)“CHITO-” | | | |
| | | | hhh.)“-OCHETE” | | | |
| | | | iii.)“-OCHETES” | | | |
| | | | jjj.)“CHY-” [DM - “-CHYM-”] | | | |
| | | | kkk.)“SCHR-” | | | |
| | | | mmm.)“-NICHOL-” | | | |
| | | | nnn.)“-MECHAN-” | | | |
| | | | ooo.)“-LICHEN-” | | | |
| | | | ppp.)“-MACHIC-” | | | |
| | | | qqq.)“-PACHEL-” | | | |
| | | | rrr.)“-RACHIF-” | | | |
| | | | sss.)“-RACHID-” | | | |
| | | | ttt.)“-RACHIS-” | | | |
| | | | uuu.)“-RACHIC-” | | | |
| | | | vvv.)“-MELCH-” | | | |
| | | | www.)“-GLOCH-” | | | |
| | | | xxx.)“-JOACH-” | | | |
| | | | yyy.)“-TRACH-” | | | |
| | | | zzz.)“-TROCH-” | | | |
| | | | aaaa.)“-BRACH-” | | | |
| | | | bbbb.)“-SYNCH-” | | | |
| | | | cccc.)“-PSYCH-” | | | |
| | C | CH | dddd.)“-STICH-” | | X | |
| | | | eeee.)“-ERICH-” | | | |
| | | | ffff.)“-DRICH-” | | | |
| | | | gggg.)“-NRICH-” | | | |
| | | | hhhh.)“-PULCH-” | | | |
| | | | iiii.)“-EPOCH-” | | | |
| | | | jjjj.)“-JOACH-” | | | |
| | | | kkkk.)“-ERICH-” | | | |
| | | | llll.)[“-TRICH-” AND NOT: | | | |
| | | | “OSTRICH”] | | | |
| | | | mmmm.)“-TYCH-” | | | |
| | | | oooo.)“-TOCH-” | | | |
| | | | pppp.)“-BUCH-” | | | |
| | | | qqqq.)“-DACH-” | | | |
| | | | rrrr.)“-MOCH-” | | | |
| | | | ssss.)“-CICH-” | | | |
| | | | tttt.)“-DICH-” | | | |
| | | | uuuu.)“-NUCH-” | | | |
| | | | vvvv.)“-EICH-” | | | |
| | | | wwww.)“-LOCH-” | | | |
| | | | xxxx.)[“-DOCH-” AND NOT: | | | |
| | | | IN RULES: 12.dd)-12.hh)] | | | |
| | | | yyyy.)“-ZECH-” | | | |
| | | | zzzz.)“-LYCHN-” | | | |
| | | | aaaaa.)“-TACHO-” | | | |
| | | | bbbbb.)“-ORCHO-” | | | |
| | | | ccccc.)“-ORCHI-” | | | |
| | | | ddddd.)“-LICHO-” | | | |
| | | | eeeee.)“-OCHER-” | | | |
| | | | fffff.)“ECHIN-” | | | |
| | | | ggggg.)“<letter>OCHER-” | | | |
| | | | hhhhh.)“<letter>ECHIN-” | | | |
| | | | iiiii.)“-BRONCH-” | | | |
| | | | jjjjj.)“-STOICH-” | | | |
| | | | kkkkk.)“-STRYCH-” | | | |
| | | | lllll.)“-TELECH-” | | | |
| | | | mmmmm.)“-PLANCH-” | | | |
| | | | nnnnn.)“-CATECH-” | | | |
| | | | ooooo.)“-MANICH-” | | | |
| | | | ppppp.)“-MALACH-” | | | |
| | | | qqqqq.)“-ZURICH-” | | | |
| | | | rrrrr.)“ICHA-” | | | |
| | | | sssss.)“ICHN-” | | | |
| | | | ttttt.)“-LEPRECH-” | | | |
| | | | uuuuu.)“-WEYRICH-” | | | |
| | | | vvvvv.)“-ORCHESTR-” [DM] | | | |
| | | | wwwww.)“-BRANCHIO-” | | | |
| | | | xxxxx.)“-BRANCHIF-” | | | |
| | | | yyyyy.)“INCHOA-” | | | |
| | | | zzzzz.)“ISCH-” | | | |
| | | | aaaaaa.)“-NICH” | | | |
| | | | bbbbbb.)[“-CHT-” [DM] | | | |
| | | | cccccc.)“-CHS-” [DM] | | | |
| | | | cccccc.1)AND NOT: | | | |
| | | | “WHICHSOEVER”] | | | |
| | C | CH | gggggg.)“-ECH” gggggg.1)AND | | X | |
| | | | NOT: | | | |
| | | | “DEBAUCH” | | | |
| | | | OR IN RULES: 12.dd)-12.hh)] | | | |
| 10 | C | CH | a.)“CHAIM” | H | | Hebrew, |
| | | | b.)“CHETH” | | | therefore |
| | | | c.)“CHELM” | | | encode KH |
| | | | d.)“CHASID” | | | sound as H |
| | | | e.)“CHAZAN” | | | since this is |
| | | | f.)“CHUPPAH” | | | conventional |
| | | | g.)“CHUTZPA” | | | in English |
| | | | h.)“CHALLAH” | | | ALL NEW |
| | | | i.)“CHALUTZ” | | | |
| | | | j.)“CHAMETZ” | | | |
| | | | k.)“CHESHVAN” | | | |
| | | | l.)“CHADARIM” | | | |
| | | | m.)“CHANUKAH” | | | |
| | | | n.)“CHALLLOTH” | | | |
| | | | o.)“CHANNUKAH” | | | |
| | | | p.)“CHAROSETH” | | | |
| 11 | C | CH | a.)“FUCHSIA” | (silent) | | ‘KH’ sound in |
| | | | b.)“YACHT” | | | dutch and |
| | | | | | | german not |
| | | | | | | pronounced |
| | | | | | | by English |
| | | | | | | speakers |
| | | | | | | NEW |
| 12 | C | CH | d.)“-OUCH-” | X | | Normal |
| | | | e.)“-OOCH-” | | | English |
| | | | f.)“-SEARCH-” | | | pronounciation |
| | | | g.)“-ATTACH-” | | | NEW: |
| | | | h.)“-DETACH-” | | | d.) through |
| | | | i.)“SPINACH” | | | hh.) |
| | | | j.)“PARACHUT-” | | | |
| | | | k.)“MASSACHU-” | | | |
| | | | l.)“-THACH-” | | | |
| | | | m.)“-CH<last letter, not A | | | |
| | | | or O>” | | | |
| | | | n.)“-ARCH-” [IF NOT ALREADY | | | |
| | | | COVERED UNDER 9.i) ABOVE] | | | |
| | | | o.)[“-MARCH-” AND NOT: | | | |
| | | | “-NOMARCH-” | | | |
| | | | “-MARCHESE-” | | | |
| | | | “-MARCHESA-”] | | | |
| | | | p.)[“-LARCH-” AND NOT: | | | |
| | | | “-EXILARCH-” | | | |
| | | | “-SCHOLARCH-”] | | | |
| | | | q.)[“-PARCH-” AND NOT: | | | |
| | | | “-EPARCH-” | | | |
| | | | “-HIPPARCH-”] | | | |
| | | | r.)[“-STARCH-” AND NOT: | | | |
| | | | “-ARISTARCH-”] | | | |
| | | | s.)“-ARCHIE-” | | | |
| | | | t.)“ARCH” | | | |
| | | | u.)“ARCHER-” | | | |
| | | | v.)“ARCHB-” | | | |
| | | | w.)“ARCHP-” | | | |
| | | | x.)“ARCHD-” | | | |
| | | | y.)“ARCHF-” | | | |
| | | | z.)“ARCHIB-” | | | |
| | | | aa.)“ARCHEN-” | | | |
| | | | bb.)“ARCHLY” | | | |
| | | | cc.)“ARCHED” | | | |
| | | | dd.)“MUCH” | | | |
| | | | ee.)“SUCH” | | | |
| | | | ff.)“INDOCHINA” | | | |
| | | | gg.)“LUNCH” | | | |
| | | | hh.)[“-OCHE” AND NOT: | | | |
| | | | “DOCHE”] | | | |
| 13 | C | CK | d.)“-CK<“K” OR “Q” OR “G”>” | K | | Two letters |
| | | CG | e.)“-CG<“K” OR “Q” OR “G”>” | | | with virtually |
| | | CQ | f.)“-CQ<“K” OR “Q” OR “G”>” | | | the same |
| | | | | | | sound next to |
| | | | | | | each other |
| | | | | | | NEW: |
| | | | | | | d.) through |
| | | | | | | f.) |
| 14 | C | | a.)“-<vowel>CEAN-” | X | S | Euphony has |
| | | | b.)[“-ACEA” AND NOT: | | | migrated |
| | | | “PANACEA”] | | | pronounciation |
| | | | c.)“-CINI” | | | to SH or |
| | | | d.)“-ICI” | | | TCH sound |
| | | | e.)“-RCIAL-” | | | except for |
| | | | f.)“-NCIAL-” | | | high class |
| | | | g.)“-RCIAN-” | | | british |
| | | | h.)“-UCIUS-” | | | NEW: |
| | | | i.)“-CELLI-” | | | a.) through |
| | | | j.)“-CERTO-” | | | k.), q.1) |
| | | | k.)“-CELLO” | | | |
| | | | q.)“-<vowel>CIA-” g.1)And | | | |
| | | | NOT: | | | |
| | | | IN RULES: 15.a)-15.m)] | | | |
| 16 | C | | a.)“CONNECTICUT” | (silent) | K | American |
| | | | b.)“INDICT” | | | Indian words, |
| | | | c.)“TUCSON” | | | french in the |
| | | | | | | case of |
| | | | | | | “indict” |
| | | | | | | ALL NEW |
| 17 | C | C | “CZAR-” | (silent - ‘Z’ | | traditional |
| | | | | is then | | spelling |
| | | | | encoded | | NEW |
| | | | | normally) | | |
| 17.a | C | CZ | (else) “CZ-” | X | | Czech and |
| | | | | | | other Slavic |
| | | | | | | languages |
| | | | | | | NEW |
| 18 | C | CK | b.)“-CQ-” | K | | NEW: b.) |
| | | CQ | | | | |
| 21 | D | DG | e.)“-DGEAR-” | TK | | ‘D’ and ‘G’ |
| | | | | | | pronounced |
| | | | | | | as written |
| | | | | | | since two |
| | | | | | | words or |
| | | | | | | roots are |
| | | | | | | concatenated |
| | | | | | | in one word |
| | | | | | | NEW: |
| | | | | | | e.) |
| 23 | D | DJ | “-DJ-” | J | | NEW |
| 24 | D | DT | “-DTH-” | T0 | | NEW |
| 26 | D | | a.)“-<vowel>DUL<vowel>-” | J | T | Euphony has |
| | | | b.)“-LDIER-” | | | migrated |
| | | | c.)“-NDEUR” | | | pronounciation |
| | | | d.)“-EDURE” | | | ALL NEW |
| | | | e.)“-RDURE” | | | |
| | | | f.)“-CORDIAL-” | | | |
| | | | g.)“-NDULA-” | | | |
| | | | h.)“-NDULU-” | | | |
| | | | i.)“-EDUCA-” | | | |
| | | | j.)“-ADUA-” | | | |
| | | | k.)“-IDUA-” | | | |
| | | | l.)“-IDUU-” | | | |
| | | | m.)“-DUOUS-” | | | |
| 27 | D | | a.)“-WEDNESDAY-” | (silent) | T | Too difficult |
| | | | b.)“-HANDKER-” | | | to be |
| | | | c.)“-HANDSOM-” | | | pronounced |
| | | | d.)“-WINDSOR-” | | | in consonant |
| | | | e.)“-PERNOD-” | | | group, else |
| | | | f.)“-ARTAUD-” | | | French |
| | | | g.)“-RIMBAUD-” | | | pronounciation |
| | | | | | | when at |
| | | | | | | end |
| | | | | | | ALL NEW |
| 32 | G | GG | “-SUGGEST-” | KJ | | exception |
| | | | | | | NEW |
| 33 | G | GG | a.)“-XAGGER-” | J | | “softened” by |
| | | | b.)“-AGGIA” | | | front vowel |
| | | | C.)“-OGGIA-” | | | ALL NEW |
| | | | d.)“-AGGIO-” | | | |
| | | | e.)“-EGGIO-” | | | |
| | | | f.)“-EGGIA-” | | | |
| | | | g.)“-AGGI” | | | |
| | | | h.)“-OGGI” | | | |
| 34 | G | GG | a.)[“-GG-” a.1)AND NOT: | K | | NEW: |
| | | | IN RULE GROUP 32 | | | a.1) |
| | | | OR IN RULES 33.a)-33.h)] | | | |
| 38 | G | GH | a.)[“-LAUGHT-” a.1)AND NOT: | F | | Almost all“-gh-” |
| | | | “-SLAUGHT-” | | | spellings |
| | | | “-LAUGHTO”] | | | were |
| | | | | | | originally |
| | | | | | | pronounced |
| | | | | | | ‘KH’ in anglo- |
| | | | | | | saxon and |
| | | | | | | middle |
| | | | | | | English, but |
| | | | | | | this sound |
| | | | | | | has not |
| | | | | | | existed in |
| | | | | | | English since |
| | | | | | | about |
| | | | | | | 1400AD - yet |
| | | | | | | the letters |
| | | | | | | remain. |
| | | | | | | NEW: a.1) |
| 39 | G | GH | a.)[“-UGHT-” a.1)AND NOT: | (silent) | | NEW: a.1) |
| | | | IN RULES 38.a)-38.b)] | | | |
| 40 | G | GH | a.)“-GHOUS-” | K | | Two words or |
| | | | b.)“-GHEAD-” | | | roots |
| | | | c.)“-GHOLE-” | | | concatenated |
| | | | d.)“-GHORN-” | | | in one word, |
| | | | e.)“-GHARN-” | | | or dutch or |
| | | | f.)“-BRIGHAM-” | | | American |
| | | | g.)“-BRUEGHEL-” | | | Indian word |
| | | | h.)“-ALLEGHENY-” | | | ALL NEW |
| 41 | G | GH | d.)“-G<letter>GH-” | (silent) | | See rule 38 |
| | | | e.)“-L<letter>GH-” | | | NEW: |
| | | | i.)“-K<letter><letter>GH-” | | | d.) through |
| | | | j.)“-W-letter><letter>GH-” | | | e.), i.) |
| | | | k.)“-N<letter><letter>GH-” | | | through m.), |
| | | | l.)“-P<letter><letter>GH-” | | | p.), q.) |
| | | | m.)“-V<letter><letter>GH-” | | | |
| | | | p.)“-PL<letter><letter>GH-” | | | |
| | | | q.)“-SL<letter><letter>GH-” | | | |
| | | | AND NOT: | | | |
| | | | IN RULES 40.a)-40.h)] | | | |
| 42 | G | GH | “HICCOUGH-” | P | F | exception |
| | | | | | | NEW |
| 43 | G | GH | a.)“-THOROUGH-” | (silent) | | See rule 38 |
| | | | b.)“-FURLOUGH-” | | | NEW: |
| | | | c.)“-WILLOUGH-” | | | a.) through |
| | | | d.)“-BOROUGH-” | | | g.) |
| | | | e.)“-BUROUGH-” | | | |
| | | | f.)“-DONOUGH-” | | | |
| | | | g.)“MAUGHAM” | | | |
| 44 | G | GH | f.)“-N<letter>UGH-” | F | | See rule 38 |
| | | | g.)“-S<letter>UGH-” AND NOT: | | | NEW: |
| | | | IN RULES 41.a)-41.q) | | | f.), g.) |
| | | | OR IN RULE GROUP 42 | | | |
| | | | OR IN RULES 43.a)-43.f)] | | | |
| 46 | G | G | a.)“-EGM” | (silent) | | Dropped |
| | | | b.)“-IGM” | | | since too |
| | | | c.)“-AGM” | | | difficult to be |
| | | | | | | pronounced |
| | | | | | | in consonant |
| | | | | | | group |
| | | | | | | NEW |
| 47 | G | G | “-GT” | (silent) | | NEW |
| 51 | G | | [“-GN-” AND NOT: | K | | NEW, SINCE |
| | | | IN RULE GROUPS 48-50] | | | EXCEPTIONS |
| | | | | | | NOT |
| | | | | | | DESCRIBED |
| | | | | | | IN DM |
| 52 | G | | a.)“-<vowel>GLIA-” | (silent) | | Italian |
| | | | b.)“-<vowel>GLIO-” | | | pronounciation |
| | | | | | | ?? |
| 53 | G | | a.)“GELD-” | K | J | G is first |
| | | | b.)“GELT-” | | | letter of word |
| | | | c.)“GERT-” | | | and in this |
| | | | d.)[“GERR-” AND NOT: | | | context |
| | | | “GERRY-”] | | | usually |
| | | | e.)“GINZ-” | | | encodes to K |
| | | | f.)“GERH-” | | | NEW SINCE |
| | | | g.)“GITE-” | | | CASES |
| | | | h.)“GERSH-” | | | WHERE ‘G’ -> |
| | | | i.)“GERST-” | | | ‘K’ ARE MUCH |
| | | | j.)“GINSB-” | | | MORE |
| | | | k.)“GELLER-” | | | MINUTELY |
| | | | l.)“GERDIE-” | | | SPECIFIED |
| | | | m.)“GERBER-” | | | |
| | | | n.)“GESUND-” | | | |
| | | | o.)“GESNER-” | | | |
| | | | p.)“GINGKO-” | | | |
| | | | q.)“GINKGO-” | | | |
| | | | r.)“GIPPER-” | | | |
| | | | s.)“GESELL-” | | | |
| | | | t.)“GESTALT-” | | | |
| | | | u.)“GESTAPO-” | | | |
| | | | v.)“GINGHAM-” | | | |
| | | | w.)“GYNAECOL-” | | | |
| | | | x.)“GYNECOLO-” | | | |
| 54 | G | | a.)[“GEL-” | J | K | G is first |
| | | | b.)“GEM-” | | | letter of word |
| | | | c.)“GEN-” | | | and in this |
| | | | d.)“GEO-” | | | context |
| | | | e.)“GER-” | | | usually |
| | | | f.)“GES-” | | | encodes to J |
| | | | g.)“GIA-” | | | NEW, AS |
| | | | h.)“GIN-” | | | ABOVE IN 53 |
| | | | i.)“GIO-” | | | |
| | | | j.)“GIP-” | | | |
| | | | k.)“GIU-” | | | |
| | | | l.)“GYM-” | | | |
| | | | m.)“GYN-” | | | |
| | | | n.)“GYP-” | | | |
| | | | o.)“GYR-” | | | |
| | | | p.)“GIRA-” | | | |
| | | | q.)“GIRO-” AND NOT: | | | |
| | | | IN RULES 53.a)-58.s)] | | | |
| 55 | G | | “GILA-” | H | K | NEW |
| 56 | G | | a.)“GEE” | J | K | “Softened” by |
| | | | b.)“GEEW-” | | | following |
| | | | a.)“GIRA-” | | | front vowel |
| | | | d.)“GIBE-” | | | NEW, AS |
| | | | e.)“GAOL-” | | | ABOVE IN 53 |
| | | | f.)[“GIDE-” AND NOT: | | | |
| | | | “GIDEON-”) | | | |
| | | | g.)“GILES-” | | | |
| | | | h.)“GINGI-” | | | |
| | | | i.)“GINGER-” | | | |
| | | | j.)“GIBBER-” | | | |
| | | | k.)“GIBBET-” | | | |
| | | | l.)“GIBLET-” | | | |
| | | | m.)“GIBRAN-” | | | |
| | | | n.)“GIGOLO-” | | | |
| | | | o.)“GIRARD-” | | | |
| | | | p.)“GIGANT-” | | | |
| | | | q.)“GIRAFFE-” | | | |
| | | | r.)“GEEWHIZ-” | | | |
| | | | s.)“GILLETTE-” | | | |
| | | | t.)“GIBRALTA-” | | | |
| 57 | G | | [“G<vowel>-” AND NOT: | K | | NEW, AS |
| | | | IN RULE GROUPS 54-56] | | | ABOVE IN 53 |
| 58 | G | | d.)“-GINGER-” | J | K | NEW, AS |
| | | | e.)“-LOUNGER-” | | | ABOVE, |
| | | | f.)“-PLUNGER-” | | | EXCEPT FOR |
| | | | g.)“-SPONGER-” | | | a.), b.), c.) |
| | | | h.)“-CHANGER-” | | | |
| | | | i.)“-SALINGER-” | | | |
| | | | j.)“-HARBINGER-” | | | |
| | | | k.)“-MESSENGER-” | | | |
| | | | l.)“-PASSENGER-” | | | |
| | | | m.)“-PHALANGER-” | | | |
| | | | n.)“-SCAVENGER-” | | | |
| | | | o.)“-BOULANGER-” | | | |
| | | | p.)“-CHALLENGER-” | | | |
| | | | q.)“-SCHLESINGER-” | | | |
| 59 | G | | [“-NGER-” AND NOT: | K | J | NEW |
| | | | IN RULES 58.a)-58.q)] | | | |
| 60 | G | | a.)“-JAGER-” | K | | Mostly |
| | | | b.)“-TIGER-” | | | german |
| | | | c.)[“-LIGER” AND NOT: | | | NEW |
| | | | “-BELLIGEREN-”] | | | |
| | | | d.)“-LAGER-” | | | |
| | | | e.)“-LUGER-” | | | |
| | | | f.)“-AUGER-” | | | |
| | | | g.)“-EAGER-” | | | |
| | | | h.)“-SEEGER-” | | | |
| | | | i.)“-JAEGER-” | | | |
| | | | j.)“-GEIGER-” | | | |
| | | | k.)“-KRUGER-” | | | |
| | | | l.)“-SAUGER-” | | | |
| | | | m.)“-BURGER-” | | | |
| | | | n.)“-BERGER-” | | | |
| | | | o.)“-MEAGER-” | | | |
| | | | p.)“-KREIGER-” | | | |
| 61 | G | | [“-<letter>GER-” AND NOT: | J | | NEW |
| | | | IN RULE GROUPS 58-60] | | | |
| 62 | G | | a.)“-ENGEL-” | K | | mostly |
| | | | b.)“-BAGEL-” | | | german |
| | | | c.)“-HEGEL-” | | | NEW |
| | | | d.)“-HUGEL-” | | | |
| | | | e.)“-KUGEL-” | | | |
| | | | f.)“-MANGEL-” | | | |
| | | | g.)“-MANGEL-” | | | |
| | | | h.)“-WEIGEL-” | | | |
| | | | i.)“-FLUGEL-” | | | |
| | | | j.)“-SPEIGEL-” | | | |
| | | | k.)“-STEIGEL-” | | | |
| | | | l.)“-WRANGEL-” | | | |
| | | | m.)“-DANEGELD-” | | | |
| 63 | G | | [“-<letter>GEL-” AND NOT: | J | | NEW |
| | | | IN RULE GROUP 62] | | | |
| 64 | G | | [“-GE-” | K | J | “-ge-”, “-gi-”, |
| | | | OR “-GI-” | | | “-gy-” - |
| | | | OR “-GY-”] | | | exceptions |
| | | | AND IN: | | | where these |
| | | | a.){“-GETH-” | | | encode to K |
| | | | b.)“-GEAR-” | | | instead of |
| | | | c.)“-GEIS-” | | | expected J |
| | | | d.)“-GIRL-” | | | NEW, AS |
| | | | e.)[“-GIVI-” AND NOT: | | | ABOVE IN 53 |
| | | | “-GINGIV-”] | | | |
| | | | f.)“-GIVE-” | | | |
| | | | g.)“-GIFT-” | | | |
| | | | h.)“-GIRD-” | | | |
| | | | i.)“-GIRT-” | | | |
| | | | j.)“-DANG-” | | | |
| | | | k.)“-FANG-” | | | |
| | | | l.)[“-SING-” AND NOT: | | | |
| | | | “-DISINGEN-”] | | | |
| | | | m.)[“-RING-” AND NOT: | | | |
| | | | “-CRING-” | | | |
| | | | “-FRING-” | | | |
| | | | “-SYRING-” | | | |
| | | | “-RINGENC-” | | | |
| | | | “-RINGENT-”] | | | |
| | | | n.)[“-WING-” AND NOT: | | | |
| | | | “-TWING-”] | | | |
| | | | o.)[“-HANG-” AND NOT: | | | |
| | | | “-CHANG-” | | | |
| | | | “-PHANG-”] | | | |
| | | | p.)[“-LONG-” AND NOT: | | | |
| | | | “-LONGITU-” | | | |
| | | | “-LONGEVI-”] | | | |
| | | | q.)“-SERGEY-” | | | |
| | | | r.)“-FORGET-” | | | |
| | | | s.)“-TARGET-” | | | |
| | | | t.)“-TURGEN-” | | | |
| | | | u.)“-BERGEN-” | | | |
| | | | v.)“-MORGEN-” | | | |
| | | | w.)“-MEGID-” | | | |
| | | | x.)“-HAGIO-” | | | |
| | | | y.)“-BEGET-” | | | |
| | | | z.)“-BEGIN-” | | | |
| | | | aa.)[“-LAGEN-” AND NOT: | | | |
| | | | “-COLLAGEN-”] | | | |
| | | | bb.)[“-NAGEN-” AND NOT: | | | |
| | | | “-OSPHAGEN-”] | | | |
| | | | cc.)“-NTGEN-” | | | |
| | | | dd.)“-EIGEN-” | | | |
| | | | ee.)“-MAGED” | | | |
| | | | ff.)“-GEYE-” | | | |
| | | | gg.)[“-NGY-” AND NOT: | | | |
| | | | “-RANGY-” | | | |
| | | | “-PONGY-” | | | |
| | | | “-MANGY-” | | | |
| | | | “-MINGY-”] | | | |
| | | | hh.)“-FOGY-” | | | |
| | | | ii.)“-POGY-” | | | |
| | | | jj.)“-YOGI-” | | | |
| | | | kk.)“-HOAGY-” | | | |
| | G | | ll.)“-STOGY-” | K | j | NEW |
| | | | mm.)“-PORGY-” | | | |
| | | | nn.)“-CARNEGIE-” | | | |
| | | | oo.)“-OGEY” | | | |
| | | | pp.)“-OGIE” | | | |
| | | | qq.)“-GILL-” | | | |
| | | | rr.)“RENEGE-” | | | |
| | | | ss.)“LANGE-” | | | |
| | | | tt.)“SYNGE-”} | | | |
| 65 | G | | a.)[“-GE-” | J | K | NEW |
| | | | b.)OR “-GI-” | | | |
| | | | c.)OR “-GY-” AND NOT: | | | |
| | | | IN RULE GROUP 64] | | | |
| 66 | G | | a.)“-MARGARY-” | J | K | exception |
| | | | b.)“-MARGARI-” | | | NEW |
| | | | c.)“-MARGARIT-” | | | |
| 68 | H | | a.)“-HOUR-” | (silent) | | can |
| | | | b.)“-HERB-” | | | somebody tell |
| | | | c.)“-HEIR-” | | | me why ‘H’ is |
| | | | d.)“-HONOR-” | | | dropped in |
| | | | e.)“-HONOUR-” | | | these words? |
| | | | f.)“-HONEST-” | | | NEW |
| | | | g.)“HERB-” | | | |
| 69 | H | HS | “HS-” | X | | old-fashioned |
| | | | | | | chinese |
| | | | | | | transliteration |
| | | | | | | NEW |
| 70 | H | | a.)“HUA-” | A | | chinese and |
| | | | b.)[“HUE-” AND NOT: | | | spanish |
| | | | “HUEY-”] | | | NEW |
| | | | c.)“HWA-” | | | |
| 71 | H | | a.)“-NIHIL-” | (silent) | | exceptions |
| | | | b.)“-VEHEM-” | | | where H |
| | | | c.)“-LOHEN-” | | | would |
| | | | d.)“-NEHEM-” | | | normally |
| | | | e.)“-MAHON-” | | | separate two |
| | | | f.)“-GRAHAM-” | | | vowel groups |
| | | | g.)“-PROHIB-”??? NOT | | | but is not |
| | | | “PROHIBIT”, ONLY MAYBE | | | pronounced |
| | | | “PROHIBITION” | | | NEW- |
| | | | | | | ENCODED ‘H’ |
| | | | | | | in DM |
| 74 | J | | a.)[“-JUAN-” AND NOT: | H | | both Js |
| | | | “-MARIJUANA-” | | | encode to H |
| | | | “-TIJUANA-”] | | | for jojoba |
| | | | b.)“-JACI-” | | | and jujuy - |
| | | | c.)“-JALI-” | | | Spanish |
| | | | d.)“-JEFE-” | | | words |
| | | | e.)“-JICA-” | | | NEW EXCEPT |
| | | | f.)“-JIME-” | | | FOR i.) |
| | | | g.)“-JOAQ-” | | | |
| | | | h.)“-JUAR-” | | | |
| | | | i.)“-JOSE” | | | |
| | | | j.)“-JOSEL-” | | | |
| | | | k.)“-JEREZ-” | | | |
| | | | l.)“-JUNTA-” | | | |
| | | | m.)[“-JO” AND NOT: | | | |
| | | | “-TOJO” | | | |
| | | | “-BANJO”] | | | |
| | | | o.)“-JOJOBA-” | | | |
| | | | p.)“-JUJUY” | | | |
| 75 | J | | a.)“JAH-” | A | J | since all |
| | | | b.)“JOHANN” | | | vowels |
| | | | c.)“JUNG- | | | encode to A, |
| | | | d.)“JUNGL-” {!! is “jungle” | | | this |
| | | | encoded properly?) | | | represents |
| | | | e.)“JUGO-” | | | the J |
| | | | | | | pronounced |
| | | | | | | as a Y - |
| | | | | | | german |
| | | | | | | words |
| | | | | | | NEW |
| 77 | J | | a.)“BOJA-” | H | | spanish, j not |
| | | | b.)“BAJA-” | | | initial |
| | | | c.)“MOJA-” | | | NEW |
| | | | d.)“MOJI-” | | | |
| | | | e.)“FRIJO-” | | | |
| | | | f.)“BRUJO-” | | | |
| | | | g.)“BRUJA-” | | | |
| | | | h.)“-AJARA” | | | |
| | | | I.)“-AJOS” | | | |
| | | | j.)“-EJOS” | | | |
| | | | k.)“-OJAS” | | | |
| | | | l.)“-UJON” | | | |
| | | | m.)“-AJOZ” | | | |
| | | | n.)“-AJAL” | | | |
| | | | o.)“-OJA” | | | |
| | | | p.)“-EJA” | | | |
| 78 | J | | a.)“JL-” | (silent) | | considered a |
| | | | b.)“-JT-” | | | vowel. |
| | | | c.)“-JK-” | | | traditional |
| | | | d.)“-JS-” | | | spelling or |
| | | | e.)“JN-” | | | from |
| | | | f.)“-JM-” | | | scandinavian |
| | | | g.)“-JB-” | | | language |
| | | | h.)“-JZ-” | | | OLD, EXCEPT |
| | | | i.)“HALLELUJA-” | | | FOR i.) |
| | | | j.)“REKJAVIK” | | | |
| | | | k.)“LJUBLJANA” | | | |
| 80 | K | | “KNESSET-” | K | | Hebrew |
| | | | “KNIEVEL-” | | | words where |
| | | | “KNISH-” | | | original |
| | | | | | | pronounciation |
| | | | | | | is retained |
| | | | | | | NEW |
| 82 | K | | a.)“-KNOW-” | (silent) | | ‘K’ has not |
| | | | b.)“-KNIT-” | | | been |
| | | | c.)[“-KNOT” c.1)AND NOT: | | | pronounced |
| | | | “BANKNOTE”] | | | since about |
| | | | d.)“-KNOB-” | | | 1400AD |
| | | | e.)“-KNOCK-” | | | NEW, SINCE |
| | | | f.)“-KNUCK-” | | | DM RULE |
| | | | g.)“-KNIFE-” | | | DOES NOT |
| | | | h.)“-KNACK-” | | | COVER NON- |
| | | | i.)“-KNIGHT-” | | | INITIAL |
| | | | | | | OCCURANCES |
| 85 | L | | “-LELY” | L | | two Ls - only |
| | | | | | | encode one! |
| | | | | | | NEW |
| 86 | L | | “COLONEL” | R | | first L - |
| | | | | | | special case - |
| | | | | | | who can tell |
| | | | | | | me why this |
| | | | | | | is? |
| | | | | | | NEW |
| 87 | L | | a.)“RENAULT” | (silent) | | both French |
| | | | b.)“FOUCAULT” | | | words known |
| | | | | | | to Americans |
| | | | | | | NEW |
| 88 | L | | “-EUIL” | (silent) | | always |
| | | | | | | French |
| | | | | | | NEW |
| 89 | L | | c.)[“-BALM-” c.1)AND NOT: | (silent) | L | Dropped |
| | | | “-BALMO-”] | | | presumably |
| | | | e.)“-PALM-” e.1)AND NOT: | | | because of |
| | | | “-LMA-”] | | | difficulty |
| | | | s.)[“-TALK-” s.1)AND NOT: | | | pronouncing |
| | | | “TALKAL”] | | | ‘L’ in |
| | | | u.)[“-BALK-” u.1)AND NOT: | | | consonant |
| | | | “BALKAN”] | | | group |
| | | | w.)[“-POLK-” w.1)AND NOT: | | | NOT NEW, |
| | | | “-POLKA-”] | | | EXCEPT FOR |
| | | | x.)[“-HALV-” x.1)AND NOT: | | | c.1), e.1), |
| | | | “-HALVA-”] | | | s.1), u.1), |
| | | | cc.)[“-SALVE-” cc.1)AND NOT: | | | w.1), x.1), |
| | | | -“SALVER-”] | | | cc.1), dd.1), |
| | | | dd.)[“-CALVE-” dd.1)AND NOT: | | | hh.1) |
| | | | “-CALVER-”] | | | |
| | | | hh.)[“-SHOULD-” hh.1)AND | | | |
| | | | NOT: | | | |
| | | | “-SHOULDER-”] | | | |
| 90 | L | LL | a.)“TORTILLA” | (silent) | | spanish and |
| | | | b.)“RATATOUILLE” | | | french, so |
| | | | | | | pronounced |
| | | | | | | Y, therefore |
| | | | | | | vowel, so not |
| | | | | | | encoded |
| | | | | | | NEW, SINCE, |
| | | | | | | DM ENCODES |
| | | | | | | ‘L’ FIRST |
| 93 | M | | “MN-” | (silent) | | initial |
| | | | | | | NEW |
| 94 | M | MP | a.)“-COMPTROL-” | N | | traditional, |
| | | | b.)“-ACCOMPT-” | | | apparantly |
| | | | | | | from old |
| | | | | | | French |
| | | | | | | NEW |
| 95 | M | MM | “-MM-” | M | | ?? DOES DM |
| | | | | | | MISTAKENLY |
| | | | | | | ENCODE TO |
| | | | | | | ‘MM” |
| 97 | N | | a.)“DAMN” | (silent) | | Dropped |
| | | | b.)“LIMN” | | | presumably |
| | | | c.)“SOLEMN” | | | because of |
| | | | d.)“AUTUMN” | | | difficulty of |
| | | | e.)“CONDEMN” | | | pronouncing |
| | | | f.)“COLUMN” | | | ‘N’ after ‘M’ |
| | | | g.)“HYMN” | | | NEW |
| | | | check code for anything | | | |
| | | | missing | | | |
| 98 | N | NC | “-<vowel>NCE” | NTS | | impossible to |
| | | | “-<vowel>NCY” | | | pronounce |
| | | | | | | this without |
| | | | | | | including a T - |
| | | | | | | e.g. |
| | | | | | | ACCOUNTANTS == |
| | | | | | | ACCOUNTENCE |
| | | | | | | NEW SINCE |
| | | | | | | ENCODING IS |
| | | | | | | DIFFERENT |
| 102 | P | | a.)“PF-” | (silent) | | initial ‘P’ |
| | | | d.)“PT-” | | | sound not |
| | | | | | | carried over |
| | | | | | | from greek |
| | | | | | | and german |
| | | | | | | NOT NEW |
| | | | | | | EXCEPT FOR |
| | | | | | | a.) AND d.) |
| 103 | P | PT | a.)“-RECEIPT-” | T | | Dropped |
| | | | b.)“-ASYMPTOT-” | | | presumably |
| | | | | | | because of |
| | | | | | | difficulty of |
| | | | | | | pronouncing |
| | | | | | | ‘P’ before ‘T’ |
| | | | | | | NEW |
| 104 | P | PHTH | a.)“PHTH-” | 0 | | pronounciation |
| | | | b.)“-PHTHALEIN-” | | | not carried |
| | | | c.)“-APOPHTHEGM-” | | | over from |
| | | | | | | greek |
| | | | | | | NEW |
| 105 | P | PH | a.)“-PHEAD-” | P | | combining |
| | | | b.)[“-PHOLE-” AND NOT: | | | forms - H |
| | | | “-NYMPHOLE-”] | | | belongs to |
| | | | c.)“-PHELD-” | | | another word |
| | | | d.)“-PHILL-” | | | NEW |
| | | | e.)“-PHOLD-” | | | |
| | | | f.)“-PHEAP-” | | | |
| | | | g.)“-PHERD-” | | | |
| | | | h.)[“-PHANG-” AND NOT: | | | |
| | | | “-LYMPHANG-”] | | | |
| | | | i.)“-PHORN-” | | | |
| | | | j.)“-PHEAV-” | | | |
| | | | k.)“-PHOUSE-” | | | |
| | | | l.)“-PHAMMER-” | | | |
| | | | m.)“-PHAZARD-” | | | |
| | | | n.)“-PHUGGER-” | | | |
| | | | o.)“-PHOLSTER-” | | | |
| 106 | P | PH | [“-PH-” 106.a)AND NOT: | F | | Usually used |
| | | | IN RULE GROUP 105] | | | in words |
| | | | | | | transliterated |
| | | | | | | from greek |
| | | | | | | NOT NEW |
| | | | | | | EXCEPT |
| | | | | | | 106.a) |
| 107 | P | PS | [“-CORPS-” AND NOT: | (silent) | | commonly |
| | | | “-CORPSE-”] | | | pronounced |
| | | | | | | as in French |
| | | | | | | NEW |
| 108 | P | | [“-COUP” AND NOT: | (silent) | | commonly |
| | | | “RECOUP”] | | | pronounced |
| | | | | | | as in French |
| | | | | | | NEW |
| 114 | R | | k.)“-SURBURB-” | (silent) | R | commonly |
| | | | l.)“-WORSTED-” | | | pronounced |
| | | | m.)“-MONSIEUR-” | | | as in french; |
| | | | | | | some others |
| | | | | | | NOT NEW, |
| | | | | | | EXCEPT k.) |
| | | | | | | THROUGH |
| | | | | | | m.) |
| 117 | S | | a.)“-YVES” | (silent) | S | commonly |
| | | | b.)“-HORS” | | | pronounced |
| | | | c.)“-MESNES” (S at end) | | | as in french. |
| | | | d.)“-DEBRIS” | | | Include S to |
| | | | e.)“-CHABLIS” | | | cover |
| | | | f.)“-APROPOS” | | | mispronounciations. |
| | | | g.)“-JACQUES” | | | NEW, EXCEPT |
| | | | h.)“-ARKANSAS” | | | l.), m.) |
| | | | i.)“-FRANCAIS” | | | |
| | | | j.)“-DESCARTES” (S at end) | | | |
| | | | k.)“-RENDEZVOUS” | | | |
| | | | n.)“-DESCARTES-” (S in | | | |
| | | | middle) | | | |
| | | | o.)“-MESNES-” (S in middle) | | | |
| | | | p.)“-DUQUESNE-” | | | |
| | | | q.)“-FRESNEL-” | | | |
| | | | r.)“-GROSVENOR-” | | | |
| | | | s.)“-LOUISVILLE-” | | | |
| | | | t.)“-ILLINOISAN-” | | | |
| 118 | S | | a.)“-LISL-” | (silent) | | Dropped |
| | | | b.)“-LYSL-” | | | presumably |
| | | | c.)[“-AISL-” AND NOT: | | | because of |
| | | | “-PAISLEY-”] | | | difficulty of |
| | | | d.)“ISLE-” | | | pronouncing |
| | | | e.)“ISLAN-” | | | ‘S’ before ‘L’ |
| | | | | | | NEW, SINCE |
| | | | | | | DM RULE |
| | | | | | | MISCODED |
| | | | | | | MANY ITEMS |
| 119 | S | ST | a.)[“-STLE-” AND NOT: | S | T | silent T - |
| | | | “-STLESS-”] | | | dropped |
| | | | b.)[“-STLI-” AND NOT: | | | presumably |
| | | | “-STLIKE-” | | | because of |
| | | | “-STLINE-” | | | difficulty of |
| | | | “-FIRSTLING-” | | | pronouncing |
| | | | “-NESTLING-” | | | ‘T’ between |
| | | | “-WESTLING-”] | | | ‘S’ and ‘L” |
| | | | c.)“-THISTLY-” | | | put this with |
| | | | d.)“-BRISTLY-” | | | the T rules |
| | | | e.)“-GRISTLY-” | | | NEW |
| | | | f.)“-CHRISTMA-” | | | |
| | | | g.)“-LISTEN-” | | | |
| | | | h.)“-RISTEN-” | | | |
| | | | i.)“-HASTEN-” | | | |
| | | | j.)“-FASTEN-” | | | |
| | | | k.)“-MUSTNT-” | | | |
| | | | l.)“-MOISTEN-” | | | |
| 120 | S | SC | “-USCLE-” | S | | e.g. “muscle” |
| | | | | | | NEW |
| 121 | S | STH | “-STHM-” | S | | e.g.“asthmatic” |
| | | | | | | NEW |
| 123 | S | | a.)“-<letter>SHAP” | S | | combining |
| | | | b.)“-<letter>SHEAR” | | | forms - H |
| | | | g.)“-SHOOD-” | | | belongs to |
| | | | h.)“-SHEAD-” | | | another word |
| | | | i.)“-SHEID-” | | | NEW, EXCEPT |
| | | | j.)“-SHOUS-” | | | c.), d.), e.), |
| | | | k.)“-SHORS-” | | | f.) |
| | | | l.)“-SHOLE-” | | | |
| | | | m.)“-SHUND-” | | | |
| | | | n.)“-SHELM-” | | | |
| | | | o.)“-SHAWK-” | | | |
| | | | p.)“-SHEART-” | | | |
| | | | q.)“-SHATCH-” | | | |
| | | | r.)“-SHOUSE-” | | | |
| | | | s.)“-SHOUND-” | | | |
| | | | t.)[“-SHORN-” AND NOT: | | | |
| | | | “-UNSHORN-”] | | | |
| | | | u.)“-SHARMON-” | | | |
| | | | v.)“-SHONEST-” | | | |
| | | | w.)“-SHALLOW-” | | | |
| | | | x.)“-SHOLDER-” | | | |
| | | | y.)“-SHOPPER-” | | | |
| | | | z.)“-SHEIMER-” | | | |
| | | | aa.)“-SHANDLE-” | | | |
| | | | bb.)“-SHABILLE-” | | | |
| | | | cc.)“-SHUMANCE-” | | | |
| | | | dd.)“-SHABITUA-” | | | |
| 125 | S | | a.)“-<letter>SCHIEF-” | S | | combining |
| | | | b.)“-<letter>SCHEAT-” | | | forms - ‘CH’ |
| | | | c.)“-<letter>SCHANCE-” | | | belongs to |
| | | | | | | another word |
| | | | | | | NEW |
| 126 | S | SCH | c.)“-SCHIS” | X | | german |
| | | | d.)“-SCHENK-” | | | NEW, EXCEPT |
| | | | e.)“-SCHENB-” | | | a.), b.) |
| | | | f.)“-SCHIST-” | | | |
| 127 | S | SCH | b.)“-SCHER-” | SK | X | dutch, |
| | | | c.)“-SCHEN-” | | | scandanavian, |
| | | | g.)“-SCHIA-” | | | or greek |
| | | | h.)“-SCHIZ-” | | | NEW, EXCEPT |
| | | | i.)“-SCHIS-” | | | a.), d.), e.), |
| | | | j.)“-SCHOL-” | | | f.) |
| | | | k.)“-ESCHAT-” | | | |
| | | | l.)“-ASCHIN-” | | | |
| | | | m.)“-ASCHAL-” | | | |
| | | | n.)“-ISCHAE-” | | | |
| | | | o.)“-ISCHIA-” | | | |
| | | | p.)“-SCHY-” AND NOT: | | | |
| | | | IN RULE GROUP 125 | | | |
| | | | OR IN RULE GROUP 126] | | | |
| 128 | S | SCH | [“-SCH-” AND NOT: | X | | |
| | | | IN RULE GROUP 125 | | | |
| | | | OR IN RULE GROUP 126 | | | |
| | | | OR IN RULE GROUP 127] | | | |
| 129 | S | | a.)“SURE-” | X | | e.g., “ensure” |
| | | | b.)“-NSURE-” | | | NEW |
| | | | c.)“-NSURA-” | | | |
| | | | d.)“-NSURY-” | | | |
| | | | e.)“-KSURE-” | | | |
| | | | f.)“-KSURA-” | | | |
| | | | g.)“-KSURY-” | | | |
| 130 | S | | a.)[“-SURE-” | J | S | e.g., |
| | | | b.)“-SURA-” | | | “treasure” |
| | | | c.)“-SURY-” AND NOT: | | | NEW |
| | | | IN RULE GROUP 129] | | | |
| 131 | S | | “-RSUA-” | S | | e.g., |
| | | | | | | “persuade” |
| | | | | | | NEW, SINCE |
| | | | | | | EXCLUDES |
| | | | | | | CASE W/OUT |
| | | | | | | VOWEL |
| 132 | S | | a.)“-<vowel>SUO-” | J | S | e.g, “casual” |
| | | | b.)“-<vowel>SUA-” | | | NEW, SINCE |
| | | | | | | ENCODING |
| | | | | | | DIFFERENT |
| 133 | S | | a.)[“-SUO-” | X | S | e.g., |
| | | | b.)“-SUA-” a.1, b.1)AND NOT: | | | “consensual” |
| | | | IN RULE GROUP 131 | | | NOT NEW, |
| | | | OR IN RULE GROUP 132] | | | EXCEPT a.1), |
| | | | | | | b.1) |
| 136 | S | SS | b.)“-ESSUR-” | X | S | e.g., |
| | | | e.)“-ESSIAN-” | | | “Russia”, |
| | | | f.)“-ASSURE-” | | | “pressure” |
| | | | g.)“-ASSURA-” | | | NOT NEW, |
| | | | | | | EXCEPT FOR |
| | | | | | | a.), b.), e.) |
| | | | | | | f.), g.) |
| | | | | | | a) in kucera |
| 137 | S | | a.)“-JAMESIAN” | S | | S already part |
| | | | b.)“-NICOSIAN” | | | of combining |
| | | | c.)“-PEGASIAN” | | | form so |
| | | | d.)“-PEPYSIAN” | | | pronounced |
| | | | e.)“-HOBBESIAN” | | | as in that |
| | | | f.)“-HOLMESIAN” | | | word |
| | | | g.)“-JAQUESIAN” | | | NEW |
| | | | h.)“-KEYNESIAN” | | | |
| | | | i.)“-MALTHUSIAN” | | | |
| | | | j.)“-HOMOOUSIAN” | | | |
| | | | k.)“-MAGLEMOSIAN” | | | |
| | | | l.)“-HOMOIOUSIAN” | | | |
| | | | m.)“-LEVALLOISIAN” | | | |
| | | | n.)“-TARDENOISIAN” | | | |
| | | | o.)“-ALGESIA” | | | |
| 138 | S | | “-CHSIA-” | X | | NEW more |
| | | | | | | specific than |
| | | | | | | kucera |
| 139 | S | | c.)“-RSIA” | J | S | e.g., “asia”, |
| | | | d.)“-RSIAN” AND NOT: | | | “Persia” |
| | | | IN RULE GROUP 137 | | | a.), b.) NOT |
| | | | OR IN RULE GROUP 138] | | | NEW, |
| | | | | | | c.), d.) NEW |
| 140 | S | | “-RSIAL-” | X | S | NEW more |
| | | | | | | specific than |
| | | | | | | kucera |
| 141 | S | | a.)“-<vowel>SION-” | J | S | NEW, EXCEPT |
| | | | b.)“-ERSION-” | | | FOR a.) |
| | | | c.)“-URSION-” | | | kucera maps |
| | | | | | | to ‘sh’ |
| 142 | S | | [“-SION-” AND NOT: | X | S | NEW |
| | | | RULE 141] | | | kucera does |
| | | | | | | not account |
| | | | | | | for |
| | | | | | | exceptions |
| 143 | S | SC | a.)“-SCIOUS-” | X | S | NEW |
| | | | b.)“-SCIU-” | | | |
| | | | c.)“-OMNISCIEN-” | | | |
| | | | d.)“-CONSCIEN-” | | | |
| | | | e.)“-CRESCEND-” | | | |
| | | | f.)“-FASCIS-” | | | |
| 144 | S | SC | a.)“-SCEPTIC-” | SK | S | NEW |
| | | | b.)“-SCEPSIS-” | | | |
| | | | c.)“-SCIVV-” | | | |
| | | | d.)“-SCIRO-” | | | |
| 145 | S | SC | a.)[“-SCE-” | S | | NOT NEW, |
| | | | b.)“-SCI-” a.1), b.1)AND | | | EXCEPT FOR |
| | | | NOT: | | | a.1), b.1) |
| | | | IN RULE GROUP 143] | | | |
| | | | OR IN RULE GROUP 144] | | | |
| | | | c.)“-SCY-” | | | |
| 146 | S | SC | [“-SC-” AND NOT: | SK | | NEW EXCEPT |
| | | | a.)IN RULE GROUP 143] | | | FOR c.) |
| | | | b.)OR IN RULE GROUP 144] | | | |
| 147 | S | | a.)“-NAUSEA” | J | S | NEW |
| | | | b.)“-CASUI-” | | | |
| | | | c.)“-HOOSIER-” | | | |
| 148 | S | | a.)“SEAN” | X | S | NEW |
| | | | b.)[“-NAUSEA-” AND NOT: | | | |
| | | | “-NAUSEAT-”] | | | |
| | | | c.)“-NAUSEO-” | | | |
| 151 | T | | a.)“TS-” | (silent) | T | initial |
| | | | b.)“TZ-” | | | NEW?? |
| | | | | | | (CHECK DM |
| | | | | | | LISTING) |
| 152 | T | TH | a.)“-THAI-” | T | O | mostly greek |
| | | | b.)“-THYME-” | | | and French |
| | | | c.)“-THYMY-” | | | words where |
| | | | d.)“-THERES-” | | | ‘TH’ |
| | | | e.)“-THEQUE-” | | | pronounced |
| | | | f.)“-ESTHER-” | | | as ‘T’ |
| | | | g.)“-GOETHE-” | | | NEW, EXCEPT |
| | | | h.)“-NATHALIE-” | | | FOR i.) |
| | | | m.)“-THAMES-” | | | THROUGH |
| | | | n.)“-THOVEN-” | | | m.) |
| | | | o.)“-THOFEN-” | | | |
| 153 | T | | a.)[“-<letter>THATCH-” AND | T | | combining |
| | | | NOT: | | | forms - H |
| | | | “-UNTHATCH-”] | | | belongs to |
| | | | b.)“-WARTHOG-” | | | second word |
| | | | f.)“-THAND-” | | | in compound |
| | | | g.)“-THILL-” | | | NEW, EXCEPT |
| | | | h.)“-THOLD-” | | | c.) THROUGH |
| | | | i.)“-THAWK-” | | | e.) |
| | | | j.)“-THEAP-” | | | |
| | | | k.)“-THERD-” | | | |
| | | | l.)“-THOLE-” | | | |
| | | | m.)“-THOOK-” | | | |
| | | | n.)“-THUNT-” | | | |
| | | | o.)“-THOUSE-” | | | |
| | | | p.)“-THEART-” | | | |
| | | | q.)“-THASTE-” | | | |
| | | | r.)“-THYPNO-” | | | |
| 154 | T | TH | “-POSTHUM-” | X | T | NEW |
| 155 | T | TH | “-CLOTHES-” | (silent) | | exception |
| | | | | | | NEW |
| 158 | T | | a.)[“-MONET” | (silent) | T | commonly |
| | | | b.)“-GENET” | | | pronounced |
| | | | c.)“-POTPOURRI-” | | | as in french. |
| | | | d.)“-MORTGAGE-” | | | include T for |
| | | | e.)“-BERET-” | | | mispronounciations. |
| | | | f.)“-BIDET-” | | | NEW |
| | | | g.)“-FILET-” | | | |
| | | | h.)“-DEBUT-” | | | |
| | | | i.)“-DEPOT-” | | | |
| | | | j.)“-PINOT-” | | | |
| | | | k.)“-TAROT-” | | | |
| | | | l.)“-BALLET-” | | | |
| | | | m.)“-BUFFET-” | | | |
| | | | n.)“-CACHET-” | | | |
| | | | o.)“-CHALET-” | | | |
| | | | p.)“-ESPRIT-” | | | |
| | | | q.)“-RAGOUT-” | | | |
| | | | r.)“-GOULET-” | | | |
| | | | s.)“-GOURMET-” | | | |
| | | | t.)“-BOUQUET-” | | | |
| | | | u.)“-CROCHET-” | | | |
| | | | v.)“-CROQUET-” | | | |
| | | | w.)“-PARFAIT-” | | | |
| | | | x.)“-PINCHOT-” | | | |
| | | | y.)“-CABARET-” | | | |
| | | | z.)“-PARQUET-” | | | |
| | | | aa.)“-RAPPORT-” | | | |
| | | | bb.)“-ENTREPOT-” | | | |
| | | | cc.)“-CABERNET-” | | | |
| | | | dd.)“-DUBONNET-” | | | |
| | | | ee.)“-MASSENET-” | | | |
| | | | ff.)“-MUSCADET-” | | | |
| | | | gg.)“-RICOCHET-” | | | |
| | | | hh.)“-ESCARGOT-” | | | |
| | | | ii.)“-SOBRIQUET-” | | | |
| | | | jj.)“-CABRIOLET-” | | | |
| | | | kk.)“-CASSOULET-” | | | |
| | | | ll.)“-OUBRIQUET-” | | | |
| | | | mm.)“-CAMEMBERT-” AND NOT: | | | |
| | | | “-TAN-” | | | |
| | | | “-TRY-” | | | |
| | | | “-TIC-” | | | |
| | | | “-TOM-” | | | |
| | | | “-TIN-”] | | | |
| 159 | T | | a.)“-FORTUN-” | X | T | NEW, EXCEPT |
| | | | b.)“-<vowel>TUL<vowel>-” | | | c.), e.), r.) |
| | | | d.)“-BITUE-” | | | THROUGH |
| | | | f.)“-<letter>TUO-” | | | w.) |
| | | | g.)“-UENT-” | | | NEW: |
| | | | h.)“-RIGHTEOUS-” | | | g.), h.), |
| | | | i.)“-STATUTE-” | | | i.), j.), o.), p.), q.) |
| | | | j.)“-AMATEUR-” | | | however, |
| | | | k.)“-NTULE-” | | | more specific |
| | | | l.)“-NTULA-” | | | than kucera: |
| | | | m.)“-STULE-” | | | <><>tun<v> |
| | | | n.)“-STULA-” | | | <><>tur<v> |
| | | | o.)“-STEUR-” | | | <><>tul<v> |
| | | | p.)“-TUE” | | | <>tua<> |
| | | | q.)“-TIENCE” | | | <>tuo<> |
| | | | x.)“-<letter>TIUS-” | | | <>tue<> |
| | | | | | | <>tia<> |
| | | | | | | <>tio<> |
| | | | | | | <>tiu<> |
| 160 | T | | a.)[“-<letter>TURA” AND NOT: | T | | NEW |
| | | | IN RULE 159.t] | | | |
| | | | b.)“-<letter>TURO” | | | |
| 162 | T | | a.)“-FAUSTIAN-” | T | | NEW |
| | | | b.)“-PROUSTIAN-” | | | |
| | | | c.)“-KANTIAN-” | | | |
| | | | d.)“-GENTIAN-” | | | |
| | | | e.)“-ROOSEVELTIAN-” | | | |
| | | | f.)“-HESTIA-” | | | |
| | | | g.)“-MASTIA-” | | | |
| | | | h.)“-OSTIA-” | | | |
| | | | i.)“-IZVESTIA-” | | | |
| | | | j.)“ANTI-” | | | |
| | | | k.)“PITIA-” | | | |
| | | | l.)“DUTIA-” | | | |
| | | | m.)“PATIO-” | | | |
| | | | n.)“-ETIOL-” | | | |
| 163 | T | | a.){[“-TIO-” a.1)AND NOT: | X | T | NOT NEW, |
| | | | IN RULE 162.m | | | EXCEPT |
| | | | OE IN RULE 162.n | | | a.1), c.), d.), |
| | | | OR IN RULE GROUP 161] | | | e.1), f.1), |
| | | | e.)[“-TIAN-” e.1)AND NOT: | | | l.1), m.) |
| | | | IN RULES 162.a-162.e] | | | c.), d.) in |
| | | | f.)[“-TIA” f.1)AND NOT: | | | kucera |
| | | | IN RULES 162.f-162.i] | | | |
| | | | l.)“-CHRISTIAN-” l.1)AND | | | |
| | | | NOT: | | | |
| | | | IN RULES 162.j-162.l} | | | |
| | | | m.)“-TIENT-” | | | |
| 164 | T | | “-OFTEN-” | (silent) | | NEW |
| 166 | T | TSCH | [“-TSCH-” AND NOT: | X | | NEW |
| | | | “-WELT-” | | | |
| | | | “-KLAT-” | | | |
| | | | “-FEST-”] | | | |
| 167 | T | TZSCH | “-TZSCH-” | X | | NEW |
| 174 | W | WH | h.)[“WH-” h.1)AND NOT IN | A | | treat as |
| | | | RULE GROUP 175] | OR | | vowel |
| | | | | (silent) | | NOT NEW |
| | | | | | | EXCEPT h.1) |
| 175 | W | WH | a.)[“-WHO-” AND NOT: | H | | for rule b.) |
| | | | IN RULES 174.a-174.g] | | | through m.), |
| | | | b.)“-WHIDE-” | | | W is is of |
| | | | c.)“-WHARD-” | | | course part of |
| | | | d.)“-WHEAD-” | | | first word of |
| | | | e.)“-WHAWK-” | | | combining |
| | | | f.)“-WHERD-” | | | form |
| | | | g.)“-WHOOK-” | | | NEW |
| | | | h.)“-WHAND-” | | | |
| | | | i.)“-WHOLE-” | | | |
| | | | j.)“-WHEART-” | | | |
| | | | k.)“-WHOUSE-” | | | |
| | | | l.)“-WHOUND-” | | | |
| | | | m.)“-WHAMMER-” | | | |
| 176 | X | | a.)“-XYLO-” | S | | greek root - |
| | | | b.)“-XYLE-” | | | represents |
| | | | c.)“-XENO-” | | | ‘KS’ sound in |
| | | | d.)“-XANTH-” | | | greek but ‘K’ |
| | | | | | | dropped in |
| | | | | | | English |
| | | | | | | NOT NEW, |
| | | | | | | EXCEPT |
| | | | | | | INCLUDES |
| | | | | | | NON INITIAL, |
| | | | | | | AND |
| | | | | | | EXCLUDES |
| | | | | | | OTHER |
| | | | | | | CONTEXTS |
| 177 | X | | “-LUXUR-” | J | KS | exception |
| | | | | | | although |
| | | | | | | sometimes |
| | | | | | | pronounced |
| | | | | | | ‘KS’ in Britain |
| | | | | | | NEW |
| 178 | X | | “-OAXACA-” | H | | mexican |
| | | | | | | indian word |
| | | | | | | NEW |
| 179 | X | | a.)“-XUAL-” | KX | KS | remember |
| | | | b.)“-XION-” | | | that X stands |
| | | | c.)“-XIOU-” | | | for ‘SH’ sound - |
| | | | | | | british |
| | | | | | | spelling |
| | | | | | | NEW |
| 180 | X | | g.)“-OIX” | (silent) | | pronounced |
| | | | h.)“-EUX” | | | as in french |
| | | | | | | NOT NEW |
| | | | | | | EXCEPT FOR |
| | | | | | | g.) and h.) |
| 181 | X | XX | a.)“-XX-” | KS | | ??NEW?? - |
| | | XC | b.)“-XCI-” | | | ARE THESE |
| | | | c.)“-XCE-” | | | CONTEXTS |
| | | | | | | ENCODED |
| | | | | | | CORRECTLY |
| | | | | | | IN DM? |
| 183 | Z | ZS | “-ZSA-” | J | | NEW |
| 184 | Z | | a.)“-AZUR-” | J | S | French |
| | | | b.)“-GLAZIER-” | | | NEW |
| 185 | Z | ZZ | a.)“-ZZA” | TS | S | Italian |
| | | | c.)“-ZZO” | | | NEW EXCEPT |
| | | | d.)“-MOZZARELL-” | | | b.), e.) |
| | | | f.)“-PUZZONLAN-” | | | |
| 186 | Z | | a.)“-SCHIZO-” | TS | S | german, |
| | | | b.)“-SCHERZ-” | | | greek, Italian |
| | | | c.)“-NAZI” | | | NEW |
| | | | d.)“-NAZIFY-” | | | |
| | | | e.)“-MOZART-” | | | |
| | | | f.)“-SCHMERZ-” | | | |
| | | | g.)“-WEIZ-” | | | |
| 187 | Z | | a.)“-CHEZ-” | (silent) | | pronounced |
| | | | b.)“-RENDEZ-” | | | as in french |
| | | | | | | NEW |

TABLE 2
COMPLETE TABLE OF METAPHONE 3 ENCODING RULES

| Rule | | | METAPHONE 3: | | | |
|---|---|---|---|---|---|---|
| Group | Letter | Digraph | Rule | Encoding | Alternate | Remarks |
| 0 | A, E, | | IF VOWEL FIRST LETTER IN WORD, | A | | VOWEL |
| | I O, | | ALWAYS ENCODED AS ‘A’. | | | ENCODING RULES |
| | U, | | (FOR ‘W’, ONLY IF | | | NOT NEW |
| | W, Y | | “W<vowel>-”) | | | |
| | | | OTHERWISE NOT ENCODED UNLESS VOWEL | | | |
| | | | ENCODING MODE TURNED ON. IN THAT | | | |
| | | | CASE, ALL LETTER SEQUENCES PURELY | | | |
| | | | OF VOWELS ENCODED AS SINGLE ‘A’, | | | |
| | | | UNLESS SILENT VOWEL SEQUENCE | | | |
| | | | ACCORDING TO RULE GROUP 00 AS | | | |
| | | | FOLLOWS. | | | |
| 00 | E or | | a.) [“-GUE” AND NOT: | (silent) | | VOWEL |
| | UE | | “-ARGUE” (vowel pron in ‘ague’??) | | | ENCODING RULES - |
| | | | “-SEGUE” | | | ‘E’ mostly |
| | | | “-PIROGUE”] | | | French, Spanish, |
| | | | b.)[“-QUE” AND NOT: | | | and transliterated |
| | | | “-BARBEQUE” | | | greek words |
| | | | “-PALENQUE” | | | where vowel |
| | | | “-APPLIQUE” | | | pronounced in |
| | | | “-RISQUE” | | | contexts where it |
| | | | “-COMMUNIQUE”] | | | ordinarily would |
| | | | c.) [“-<consonant>E” AND NOT: (ADD | | | not be. |
| | | | THESE RULES TO CODE!!!) | | | ALL NEW |
| | | | “-PERSEPHONE-” | | | |
| | | | “-ANDROMACHE-” | | | |
| | | | “-NIETSCHE-” | | | |
| | | | “-RILKE-” & etc.] | | | |
| | | | d.) [“-<consonant>ES” OR “- | | | |
| | | | <consonant>ED” AND NOT: | | | |
| | | | “-TED” | | | |
| | | | “-SES” | | | |
| | | | “-ACLES” | | | |
| | | | “-OCLES” | | | |
| | | | “-AKLES”] | | | |
| | | | (ADD RULE TO CODE: “HERCULES”) | | | |
| | | | e.)“-<consonant>ELESS” | | | |
| | | | f.)“-<consonant>ENESS” | | | |
| | | | g.)“-<consonant>ELY” | | | |
| | | | h.)“-LES” | | | |
| | | | i.)“-LED” | | | |
| | | | j.)“-RLEST-” | | | |
| | | | k.)[“- | | | |
| | | | <letter><vowel>LE<consonant>“ AND | | | |
| | | | NOT: | | | |
| | | | “-LER” | | | |
| | | | “-LET” | | | |
| | | | OR IN RULE 000] | | | |
| | | | 1.)[“-<letter><vowel>LE” AND NOT | | | |
| | | | IN RULE 000] | | | |
| 000 | E | LE | a.)[“-<consonant>LE-” AND NOT: | AL | | SPECIAL VOWEL |
| | | | “-LLE-” | | | ENCODING (WHEN |
| | | | “-RLE-” | | | TURNED ON) |
| | | | “-HLE-” | | | RULES |
| | | | “-WLE-” | | | GOVERNING |
| | | | “-ECCLESI-” | | | TRANSPOSITION |
| | | | “-COMPLEC-” | | | OF ‘E’ AND ‘L’ AS |
| | | | “-EMBLEM-” | | | IN, E.G., “TABLE” |
| | | | “-LE<vowel>-” | | | => TAPAL AND |
| | | | “-LET” | | | NOT => TAPL |
| | | | “-LETTING-” | | | ALL NEW |
| | | | “-LETELY-” | | | |
| | | | “-LETTER-” | | | |
| | | | “-LETION-” | | | |
| | | | “-LETIAN-” | | | |
| | | | “-LETING-” | | | |
| | | | “-LETORY-” | | | |
| | | | “-LETUS-” | | | |
| | | | “-LETIV-” | | | |
| | | | “-LESS-” | | | |
| | | | “-LESQ-” | | | |
| | | | “-LECT-” | | | |
| | | | “-LEDG-” | | | |
| | | | “-LETE-” | | | |
| | | | “-LETH-” | | | |
| | | | “-LETS-” | | | |
| | | | “-LEG-” | | | |
| | | | “-LER-” | | | |
| | | | “-LEX-” | | | |
| | | | [“-LEMENT” UNLESS: | | | |
| | | | “-BATTLE-” | | | |
| | | | “-TANGLE-” | | | |
| | | | “-PUZZLE-” | | | |
| | | | “-RABBLE-” | | | |
| | | | “-BABBLE-” | | | |
| | | | “-TABLE-”] | | | |
| | | | “-ACLES” | | | |
| | | | “-OCLES” | | | |
| | | | “-AKLES” | | | |
| | | | “-LISLE-” | | | |
| | | | “-AISLE-” | | | |
| | | | “-PROBLEM-” | | | |
| | | | “-RESPLEN-” | | | |
| | | | “-REPLEN-” | | | |
| | | | “-SPLE-” | | | |
| 1 | B | | a.)“-DEBT-” | (silent) | P | ‘B’ dropped |
| | | | b.)“-SUBTL-” | | | because of |
| | | | c.)“-SUBTIL-” | | | difficulty of |
| | | | d.)“-DOUBT-” | | | pronouncing |
| | | | e.){“-THUMB-” | | | consonant group |
| | | | f.)“-DUMB-” | | | NEW: |
| | | | g.)“-BOMB-” | | | a.), b.), c.), |
| | | | h.)[“-LAMB-” h.1)AND NOT: | | | d.), h.1), i.1), j.1), j.1.a), |
| | | | “-LAMBEN-” | | | |
| | | | “-LAMBER-” | | | |
| | | | “-LAMBET-” | | | |
| | | | “-LAMBRE-”] | | | |
| | | | i.)[“-NUMB-” i.1)AND NOT: | | | |
| | | | “-NUMBER-”] | | | |
| | | | j.)[“-TOMB-” j.1)AND NOT: | | | |
| | | | “-TOMBIG-”] | | | |
| | | | j.1.a)AND NOT: | | | |
| | | | “-MBO-” | | | |
| | | | [“-MBA-” j.1.a.1)AND NOT: | | | |
| | | | “-DUMBASS-”]} | | | |
| | | | k.)“-BUNCOMB-” | | | |
| | | | l.)“-CLIMB-” | | | |
| | | | m.)“-PLUMB-” | | | |
| 2 | B | BB | a.)“-BB-” | P | | 2.a NOT NEW |
| | | BP | b.)“-BP-” | | | 2.b NEW |
| 3 | B | | (else) | P | | NOT NEW |
| 4 | C | | a.)“CT-” | (silent) | | At start of word. |
| | | | b.)“CN-” | | | Possibly retention |
| | | | | | | representing |
| | | | | | | sound in original |
| | | | | | | language that was |
| | | | | | | never pronounced |
| | | | | | | by English |
| | | | | | | speakers. E.g, |
| | | | | | | “Ctesiphon” |
| | | | | | | NEW |
| 5 | C | | a.)“CAES-” | S | K | Greek roots, |
| | | | b.)“CAEC-” | | | words normally |
| | | | c.)“CAEM-” | | | spelled with a |
| | | | d.)“COEL-” | | | cedilla to indicate |
| | | | e.)“COENA-” | | | C as S (french and |
| | | | f.)“COENO-” | | | portugese), |
| | | | g.)“-FLACCID-” | | | other exceptions |
| | | | h.)“FRANCAIS” | | | ALL NEW EXCEPT |
| | | | i.)“FRANCAIX” | | | FOR a.) |
| | | | j.)“FRANCOIS” | | | |
| | | | k.)“LINGUICA” | | | |
| | | | l.)“FACADE-” | | | |
| | | | m.)“GARCON” | | | |
| 6 | C | CC | a.){[“-CCI-” a.1)AND NOT: | KS | | E.g., “accident”, |
| | | | 8.a)-8.e) | | | “accede” |
| | | | OR “-FLACCID-”] | | | NEW: |
| | | | b.)[“-CCE-” b.1)AND NOT: | | | a.), c.) |
| | | | “-SOCCER-”] | | | |
| | | | c.)“-CCY-” | | | |
| | | | 6.a)-6.c) c.1)AND NOT: | | | |
| | | | 7.c} | | | |
| 7 | C | CC | a.)“SOCCER” | K | | NOT NEW |
| | | | b.)“-CCH-” | | | |
| | | | c.)“MCC-” | | | |
| 8 | C | CC | a.)“-CCIA-” | X | | Italian familiar to |
| | | | b.)“-CCI” | | | Americans, e.g., |
| | | | c.)“-CCIO-” | | | “focaccia” |
| | | | d.)“-CCINO” | | | a.) NEW SINCE |
| | | | e.)“-CCINI” | | | RESTRICTS TO |
| | | | | | | DOUBLE ‘C’ |
| 9 | C | CH | a.)“-CHAE-” | K | X | Michael |
| | | | b.)[“ACH-” b.1)AND NOT: | | | German names |
| | | | “ACHES-” | | | words with Greek |
| | | | “ACHEU-” | | | roots |
| | | | “ACHIE-” | | | b.1) NEW SINCE |
| | | | b.1.a)UNLESS: | | | RESTRICTS MORE |
| | | | “EARACH-” | | | NEW: |
| | | | “HEADACH-”, | | | b.1.a), c.), d.), |
| | | | “BACKACH-” | | | f.1), i.) through j.), |
| | | | “HEARTACH-”, | | | m.) through r.), |
| | | | “BELLYACH-”, | | | w.) through mm.) |
| | | | “TOOTHACH-”] | | | |
| | | | c.)“ECHO-” | | | |
| | | | d.)[“<not vowel>ACH<not I or E>” | | | |
| | | | e.)“-BACHER-” | | | |
| | | | f.)“-MACHER-” f.1)AND NOT: | | | |
| | | | IN RULES: 12.g)-12.m)] | | | |
| | | | g.)“-BACH”, | | | |
| | | | h.)“-MACHE-” | | | |
| | | | i.)[“-ARCH-” i.1)AND NOT: | | | |
| | | | IN RULES: 12.n)-12.cc)] | | | |
| | | | j.)“-CHAMOM-” | | | |
| | | | k.)“-CHARAC-” | | | |
| | | | l.)“-CHARIS-” | | | |
| | | | m.)“-CHARTO-” | | | |
| | | | n.)“-CHARTU-” | | | |
| | | | o.)“-CHARYB-” | | | |
| | | | p.)“-CHRIST-” | | | |
| | | | q.)“-CHEMIC-” | | | |
| | | | r.)“-CHILIA-” | | | |
| | | | s.)[“-CHEMI-” AND NOT: | | | |
| | | | “CHEMISE”] | | | |
| | | | t.)“-CHEMO-” | | | |
| | | | u.)“-CHEMU-” | | | |
| | | | v.)“-CHEMY-” | | | |
| | | | w.)“-CHOND-” | | | |
| | | | x.)“-CHONA-” | | | |
| | | | y.)“-CHONI-” | | | |
| | | | z.)“-CHOIR-” | | | |
| | | | aa.)“-CHASM-” | | | |
| | | | bb.)“-CHARO-” | | | |
| | | | cc.)“-CHROM-” | | | |
| | | | dd.)“-CHROI-” | | | |
| | | | ee.)“-CHAMA-” | | | |
| | | | ff.)“-CHALC-” | | | |
| | | | gg.)“-CHALD-” | | | |
| | | | hh.)“-CHAET-” | | | |
| | | | ii.)“-CHIRO-” | | | |
| | | | jj.)“-CHILO-” | | | |
| | | | kk.)“-CHELA-” | | | |
| | | | ll.)“-CHOUS-” | | | |
| | | | mm.)“-CHEIL-” | | | |
| | C | CH | nn.)“-CHEIR-” | | X | Greek roots |
| | | | oo.)“-CHEIM-” | | | NEW: |
| | | | pp.)“-CHITI-” | | | nn.) through rr.) |
| | | | qq.)[“-CHISM-” qq.1)AND NOT: | | | ss.1.b) |
| | | | “MACHISMO” | | | tt.), vv.), xx.), |
| | | | “REVANCHISM”] | | | yy.), zz.), |
| | | | rr.)[“-CHELI-” rr.1)AND NOT: | | | aaa.1),bbb.) |
| | | | “RICHELIEU”] | | | through kkk.), |
| | | | ss.)[“-CHOR-” ss.1)AND NOT: | | | mmm.) through |
| | | | ss.1.a)“CHORE-” | | | uuuuu.), |
| | | | ss.1.b)“CHORT-”] | | | wwwww.) through |
| | | | tt.)[“-CHOL-” tt.1)AND NOT: | | | aaaaaa.), |
| | | | “CHOLO-”] | | | cccccc.1), |
| | | | uu.)“-CHYM-” | | | gggggg.1) |
| | | | vv.)“-CHYL-” | | | |
| | | | ww.)“-CHLO-” | | | |
| | | | xx.)“-CHAO-” | | | |
| | | | yy.)[“-CHOS-” yy.1)AND NOT: | | | |
| | | | “-CHOSE-”] | | | |
| | | | zz.)“-CHUS-” | | | |
| | | | aaa.)[“-CHIA-” aaa.1)AND NOT: | | | |
| | | | “APPALACHIA”] | | | |
| | | | bbb.)“-CHIMERA-” | | | |
| | | | ccc.)“-CHIMAER-” | | | |
| | | | ddd.)“-CHIMERI-” | | | |
| | | | eee.)“CHAME-” | | | |
| | | | fff.)“CHELO-” | | | |
| | | | ggg.)“CHITO-” | | | |
| | | | hhh.)“-OCHETE” | | | |
| | | | iii.)“-OCHETES” | | | |
| | | | jjj.)“CHY-” [DM - “-CHYM-”] | | | |
| | | | kkk.)“SCHR-” | | | |
| | | | lll.)“-ORCHID-” [DM] | | | |
| | | | mmm.)“-NICHOL-” | | | |
| | | | nnn.)“-MECHAN-” | | | |
| | | | ooo.)“-LICHEN-” | | | |
| | | | ppp.)“-MACHIC-” | | | |
| | | | qqq.)“-PACHEL-” | | | |
| | | | rrr.)“-RACHIF-” | | | |
| | | | sss.)“-RACHID-” | | | |
| | | | ttt.)“-RACHIS-” | | | |
| | | | uuu.)“-RACHIC-” | | | |
| | | | vvv.)“-MELCH-” | | | |
| | | | www.)“-GLOCH-” | | | |
| | | | xxx.)“-JOACH-” | | | |
| | | | yyy.)“-TRACH-” | | | |
| | | | zzz.)“-TROCH-” | | | |
| | | | aaaa.)“-BRACH-” | | | |
| | | | bbbb.)“-SYNCH-” | | | |
| | | | cccc.)“-PSYCH-” | | | |
| | C | CH | dddd.)“-STICH-” | | X | |
| | | | eeee.)“-ERICH-” | | | |
| | | | ffff.)“-DRICH-” | | | |
| | | | gggg.)“-NRICH-” | | | |
| | | | hhhh.)“-PULCH-” | | | |
| | | | iiii.)“-EPOCH-” | | | |
| | | | jjjj.)“-JOACH-” | | | |
| | | | kkkk.)“-ERICH-” | | | |
| | | | llll.)[“-TRICH-” AND NOT: | | | |
| | | | “OSTRICH”] | | | |
| | | | mmmm.)“-TYCH-” | | | |
| | | | oooo.)“-TOCH-” | | | |
| | | | pppp.)“-BUCH-” | | | |
| | | | qqqq.)“-DACH-” | | | |
| | | | rrrr.)“-MOCH-” | | | |
| | | | ssss.)“-CICH-” | | | |
| | | | tttt.)“-DICH-” | | | |
| | | | uuuu.)“-NUCH-” | | | |
| | | | vvvv.)“-EICH-” | | | |
| | | | wwww.)“-LOCH-” | | | |
| | | | xxxx.)[“-DOCH-” AND NOT: | | | |
| | | | IN RULES: 12.dd)-12.hh)] | | | |
| | | | yyyy.)“-ZECH-” | | | |
| | | | zzzz.)“-LYCHN-” | | | |
| | | | aaaaa.)“-TACHO-” | | | |
| | | | bbbbb.)“-ORCHO-” | | | |
| | | | ccccc.)“-ORCHI-” | | | |
| | | | ddddd.)“-LICHO-” | | | |
| | | | eeeee.)“-OCHER-” | | | |
| | | | fffff.)“ECHIN-” | | | |
| | | | ggggg.)“<letter>OCHER-” | | | |
| | | | hhhhh.)“<letter>ECHIN-” | | | |
| | | | iiiii.)“-BRONCH-” | | | |
| | | | jjjjj.)“-STOICH-” | | | |
| | | | kkkkk.)“-STRYCH-” | | | |
| | | | lllll.)“-TELECH-” | | | |
| | | | mmmmm.)“-PLANCH-” | | | |
| | | | nnnnn.)“-CATECH-” | | | |
| | | | ooooo.)“-MANICH-” | | | |
| | | | ppppp.)“-MALACH-” | | | |
| | | | qqqqq.)“-ZURICH-” | | | |
| | | | rrrrr.)“ICHA-” | | | |
| | | | sssss.)“ICHN-” | | | |
| | | | ttttt.)“-LEPRECH-” | | | |
| | | | uuuuu.)“-WEYRICH-” | | | |
| | | | vvvvv.)“-ORCHESTR-” [DM] | | | |
| | | | wwwww.)“-BRANCHIO-” | | | |
| | | | xxxxx.)“-BRANCHIF-” | | | |
| | | | yyyyy.)“INCHOA-” | | | |
| | | | zzzzz.)“ISCH-” | | | |
| | | | aaaaaa.)“-NICH” | | | |
| | | | bbbbbb.)[“-CHT-” [DM] | | | |
| | | | cccccc.)“-CHS-” [DM] cccccc.1)AND | | | |
| | | | NOT: “WHICHSOEVER”] | | | |
| | C | CH | dddddd.)[“-ACH” | | X | |
| | | | eeeeee.)“-OCH” | | | |
| | | | ffffff.)“-UCH” | | | |
| | | | gggggg.)“-ECH” gggggg.1)AND NOT: | | | |
| | | | “DEBAUCH” | | | |
| | | | OR IN RULES: 12.dd)-12.hh)] | | | |
| | | | hhhhhh.)<“A” OR “O” OR “U” OR | | | |
| | | | “E”>“CH”<“L” OR “R” OR “N” OR “M” | | | |
| | | | OR “B” OR “H” OR “F” OR “V” OR “W” | | | |
| | | | OR “ ”> | | | |
| | | | iiiiii.)“MCH-” | | | |
| 10 | C | CH | a.)“CHAIM” | H | | Hebrew, therefore |
| | | | b.)“CHETH” | | | encode KH sound |
| | | | c.)“CHELM” | | | as H since this is |
| | | | d.)“CHASID” | | | conventional in |
| | | | e.)“CHAZAN” | | | English |
| | | | f.)“CHUPPAH” | | | ALL NEW |
| | | | g.)“CHUTZPA” | | | |
| | | | h.)“CHALLAH” | | | |
| | | | i.)“CHALUTZ” | | | |
| | | | j.)“CHAMETZ” | | | |
| | | | k.)“CHESHVAN” | | | |
| | | | l.)“CHADARIM” | | | |
| | | | m.)“CHANUKAH” | | | |
| | | | n.)“CHALLLOTH” | | | |
| | | | o.)“CHANNUKAH” | | | |
| | | | p.)“CHAROSETH” | | | |
| 11 | C | CH | a.)“FUCHSIA” | (silent) | | ‘KH’ sound in |
| | | | b.)“YACHT” | | | dutch and german |
| | | | | | | not pronounced by |
| | | | | | | English speakers |
| | | | | | | NEW |
| 12 | C | CH | a.)“-OACH-” [DM] | X | | Normal English |
| | | | b.)“-EACH-” [DM] | | | pronounciation |
| | | | c.)“-EECH-” [DM] | | | NEW: |
| | | | d.)“-OUCH-” | | | d.) through hh.) |
| | | | e.)“-OOCH-” | | | |
| | | | f.)“-SEARCH-” | | | |
| | | | g.)“-ATTACH-” | | | |
| | | | h.)“-DETACH-” | | | |
| | | | i.)“SPINACH” | | | |
| | | | j.)“PARACHUT-” | | | |
| | | | k.)“MASSACHU-” | | | |
| | | | l.)“-THACH-” | | | |
| | | | m.)“-CH<last letter, not A or O>” | | | |
| | | | n.)“-ARCH-” [IF NOT ALREADY | | | |
| | | | COVERED UNDER 9.i) ABOVE] | | | |
| | | | o.)[“-MARCH-” AND NOT: | | | |
| | | | “-NOMARCH-” | | | |
| | | | “-MARCHESE-” | | | |
| | | | “-MARCHESA-”] | | | |
| | | | p.)[“-LARCH-” AND NOT: | | | |
| | | | “-EXILARCH-” | | | |
| | | | “-SCHOLARCH-”] | | | |
| | | | q.)[“-PARCH-” AND NOT: | | | |
| | | | “-EPARCH-” | | | |
| | | | “-HIPPARCH-”] | | | |
| | | | r.)[“-STARCH-” AND NOT: | | | |
| | | | “-ARISTARCH-”] | | | |
| | | | s.)“-ARCHIE-” | | | |
| | | | t.)“ARCH” | | | |
| | | | u.)“ARCHER-” | | | |
| | | | v.)“ARCHB-” | | | |
| | | | w.)“ARCHP-” | | | |
| | | | x.)“ARCHD-” | | | |
| | | | y.)“ARCHF-” | | | |
| | | | z.)“ARCHIB-” | | | |
| | | | aa.)“ARCHEN-” | | | |
| | | | bb.)“ARCHLY” | | | |
| | | | cc.)“ARCHED” | | | |
| | | | dd.)“MUCH” | | | |
| | | | ee.)“SUCH” | | | |
| | | | ff.)“INDOCHINA” | | | |
| | | | gg.)“LUNCH” | | | |
| | | | hh.)[“-OCHE” AND NOT: | | | |
| | | | “DOCHE”] | | | |
| 13 | C | CK | a.)“-CK-” | K | | Two letters with |
| | | CG | b.)“-CG-” | | | virtually the same |
| | | CQ | c.)“-CQ-” | | | sound next to |
| | | | d.)“-CK<“K” OR “Q” OR “G”>” | | | each other |
| | | | e.)“-CG<“K” OR “Q” OR “G”>” | | | NEW: |
| | | | f.)“-CQ<“K” OR “Q” OR “G”>” | | | d.) through f.) |
| 14 | C | | a.)“-<vowel>CEAN-” | X | S | Euphony has |
| | | | b.)[“-ACEA” AND NOT: | | | migrated |
| | | | “PANACEA”] | | | pronounciation to |
| | | | c.)“-CINI” | | | SH or TCH sound |
| | | | d.)“-ICI” | | | except for high |
| | | | e.)“-RCIAL-” | | | class british |
| | | | f.)“-NCIAL-” | | | NEW: |
| | | | g.)“-RCIAN-” | | | a.) through k.), |
| | | | h.)“-UCIUS-” | | | g.1) |
| | | | i.)“-CELLI-” | | | |
| | | | j.)“-CERTO-” | | | |
| | | | k.)“-CELLO” | | | |
| | | | l.)“ANCIENT-” | | | |
| | | | m.)“CIAO” | | | |
| | | | n.)“-CEOUS-”, n.1)“-CIOUS-” | | | |
| | | | o.)[“-<vowel>CIO-” | | | |
| | | | p.)“-<vowel>CIE-” | | | |
| | | | q.)“-<vowel>CIA-” g.1)AND NOT: | | | |
| | | | IN RULES: 15.a)-15.m)] | | | |
| 15 | C | | a.)“-ASSOCIAT-” | S | X | Normal S sound |
| | | | b.)“-SOCIO-” | | | for ‘C’ except that |
| | | | c.)“-SOCIE-” | | | “associate” and |
| | | | d.)“-YCIA” | | | “scociological” can |
| | | | e.)“-UCIA” | | | also be ‘SH’ |
| | | | f.)“-OCIA” | | | NOT NEW |
| | | | g.)“-ICIE” | | | |
| | | | h.)“-YCIAS” | | | |
| | | | i.)“-UCIAS” | | | |
| | | | j.)“-OCIAS” | | | |
| | | | k.)“-ICIES” | | | |
| | | | l.)“HACIENDA-” | | | |
| | | | m.)“GRACIA-” | | | |
| 16 | C | | a.)“CONNECTICUT” | (silent) | K | American Indian |
| | | | b.)“INDICT” | | | words, french in |
| | | | c.)“TUCSON” | | | the case of “indict” |
| | | | | | | ALL NEW |
| 17 | C | C | “CZAR-” | (silent - | | traditional spelling |
| | | | | ‘Z’ is | | NEW |
| | | | | then | | |
| | | | | encoded | | |
| | | | | normally) | | |
| 17.a | C | CZ | (else) “CZ-” | X | | Czech and other |
| | | | | | | Slavic languages |
| | | | | | | NEW |
| 18 | C | CK | a.)“-CK-” | K | | NEW: b.) |
| | | CQ | b.)“-CQ-” | | | |
| 19 | C | | (else) | K | | NOT NEW |
| 20 | ç | | “-ç-” | S | | “Cedilla” indicates |
| | | | | | | C pronounced as |
| | | | | | | ‘S’ in French and |
| | | | | | | portuguese |
| | | | | | | NOT NEW |
| 21 | D | DG | a.)“-DGA-” | TK | | ‘D’ and ‘G’ |
| | | | b.)“-DGO-” | | | pronounced as |
| | | | c.)“-DGUN-” | | | written since two |
| | | | d.)“-DGUT-” | | | words or roots are |
| | | | e.)“-DGEAR-” | | | concatenated in |
| | | | f.)“-DGLAS-” | | | one word |
| | | | g.)“-DGRIP-” | | | NEW: |
| | | | h.)“-DGUARD-” | | | e.) |
| | | | i.)“-DGUILT-” | | | |
| | | | j.)“-DGRAVE-” | | | |
| | | | k.)“-DGROUSE-” | | | |
| 22 | D | DG | “-DG-” AND NOT: | J | | Traditional English |
| | | | IN RULE GROUP 21] | | | spelling to indicate |
| | | | | | | “soft” G |
| | | | | | | NOT NEW |
| 23 | D | DJ | “-DJ-” | J | | NEW |
| 24 | D | DT | “-DTH-” | T0 | | NEW |
| 25 | D | DT | a.)“-DT-” AND NOT: | T | | NOT NEW |
| | | DD | IN RULE GROUP 24] | | | |
| | | | b.)“-DD-” | | | |
| 26 | D | | a.)“-<vowel>DUL<vowel>-” | J | T | Euphony has |
| | | | b.)“-LDIER-” | | | migrated |
| | | | c.)“-NDEUR” | | | pronounciation |
| | | | d.)“-EDURE” | | | ALL NEW |
| | | | e.)“-RDURE” | | | |
| | | | f.)“-CORDIAL-” | | | |
| | | | g.)“-NDULA-” | | | |
| | | | h.)“-NDULU-” | | | |
| | | | i.)“-EDUCA-” | | | |
| | | | j.)“-ADUA-” | | | |
| | | | k.)“-IDUA-” | | | |
| | | | l.)“-IDUU-” | | | |
| | | | m.)“-DUOUS-” | | | |
| 27 | D | | a.)“-WEDNESDAY-” | (silent) | T | Too difficult to be |
| | | | b.)“-HANDKER-” | | | pronounced in |
| | | | c.)“-HANDSOM-” | | | consonant group, |
| | | | d.)“-WINDSOR-” | | | else French |
| | | | e.)“-PERNOD-” | | | pronounciation |
| | | | f.)“-ARTAUD-” | | | when at end |
| | | | g.)“-RIMBAUD-” | | | ALL NEW |
| 28 | D | | (else) | T | | NOT NEW |
| 29 | F | FF | “-FF-” | F | | NOT NEW |
| 30 | F | | (else) | F | | NOT NEW |
| 31 | G | | “GN-” | (silent) | | At start of word. |
| | | | | | | Mostly greek or |
| | | | | | | Scandinavian |
| | | | | | | words, initial |
| | | | | | | consonant not |
| | | | | | | pronounced in |
| | | | | | | English |
| | | | | | | NOT NEW |
| 32 | G | GG | “-SUGGEST-” | KJ | | exception |
| | | | | | | NEW |
| 33 | G | GG | a.)“-XAGGER-” | J | | “softened” by front |
| | | | b.)“-AGGIA” | | | vowel |
| | | | c.)“-OGGIA-” | | | ALL NEW |
| | | | d.)“-AGGIO-” | | | |
| | | | e.)“-EGGIO-” | | | |
| | | | f.)“-EGGIA-” | | | |
| | | | g.)“-AGGI” | | | |
| | | | h.)“-OGGI” | | | |
| 34 | G | GG | a.)[“-GG-” a.1)AND NOT: | K | | NEW: |
| | | | IN RULE GROUP 32 | | | a.1) |
| | | | OR IN RULES 33.a)-33.h)] | | | |
| 35 | G | GH | “-<consonant>GH-” | K | | NOT NEW |
| 36 | G | GH | “GHI-” | J | | Italian |
| | | | | | | NOT NEW |
| 37 | G | GH | “GH-” AND NOT: | K | | NOT NEW |
| | | | IN RULE GROUP 36] | | | |
| 38 | G | GH | a.)[“-LAUGHT-” a.1)AND NOT: | F | | Almost all “-gh-” |
| | | | “-SLAUGHT-” | | | spellings were |
| | | | “-LAUGHTO”] | | | originally |
| | | | b.)“-DRAUGHT-” | | | pronounced ‘KH’ in |
| | | | | | | anglo-saxon and |
| | | | | | | middle English, but |
| | | | | | | this sound has not |
| | | | | | | existed in English |
| | | | | | | since about |
| | | | | | | 1400AD - yet the |
| | | | | | | letters remain. |
| | | | | | | NEW: a.1) |
| 39 | G | GH | a.)[“-UGHT-” a.1)AND NOT: | (silent) | | NEW: a.1) |
| | | | IN RULES 38.a)-38.b)] | | | |
| 40 | G | GH | a.)“-GHOUS-” | K | | Two words or |
| | | | b.)“-GHEAD-” | | | roots |
| | | | c.)“-GHOLE-” | | | concatenated in |
| | | | d.)“-GHORN-” | | | one word, or dutch |
| | | | e.)“-GHARN-” | | | or American Indian |
| | | | f.)“-BRIGHAM-” | | | word |
| | | | g.)“-BRUEGHEL-” | | | ALL NEW |
| | | | h.)“-ALLEGHENY-” | | | |
| 41 | G | GH | a.)[“-B<letter>GH-” | (silent) | | See rule 38 |
| | | | b.)“-H<letter>GH-” | | | NEW: |
| | | | c.)“-D<letter>GH-” | | | d.) through e.), i.) |
| | | | d.)“-G<letter>GH-” | | | through m.), p.), |
| | | | e.)“-L<letter>GH-” | | | q.) |
| | | | f.)“-B<letter><letter>GH-” | | | |
| | | | g.)“-H<letter><letter>GH-” | | | |
| | | | h.)“-D<letter><letter>GH-” | | | |
| | | | i.)“-K<letter><letter>GH-” | | | |
| | | | j.)“-W<letter><letter>GH-” | | | |
| | | | k.)“-N<letter><letter>GH-” | | | |
| | | | l.)“-P<letter><letter>GH-” | | | |
| | | | m.)“-V<letter><letter>GH-” | | | |
| | | | n.)“-B<letter><letter><letter>GH-” | | | |
| | | | o.)“-H<letter><letter><letter>GH-” | | | |
| | | | p.)“-PL<letter><letter>GH-” | | | |
| | | | q.)“-SL<letter><letter>GH-” AND | | | |
| | | | NOT: | | | |
| | | | IN RULES 40.a)-40.h)] | | | |
| 42 | G | GH | “HICCOUGH-” | P | F | exception |
| | | | | | | NEW |
| 43 | G | GH | a.)“-THOROUGH-” | (silent) | | See rule 38 |
| | | | b.)“-FURLOUGH-” | | | NEW: |
| | | | c.)“-WILLOUGH-” | | | a.) through g.) |
| | | | d.)“-BOROUGH-” | | | |
| | | | e.)“-BUROUGH-” | | | |
| | | | f.)“-DONOUGH-” | | | |
| | | | g.)“-MAUGHAN” | | | |
| | | | h.)“-IGH-” | | | |
| 44 | G | GH | a.)[“-C<letter>UGH-” | F | | See rule 38 |
| | | | b.)“-G<letter>UGH-” | | | NEW: |
| | | | c.)“-L<letter>UGH-” | | | f.), g.) |
| | | | d.)“-R<letter>UGH-” | | | |
| | | | e.)“-T<letter>UGH-” | | | |
| | | | f.)“-N<letter>UGH-” | | | |
| | | | g.)“-S<letter>UGH-” AND NOT: | | | |
| | | | IN RULES 41.a)-41.q) | | | |
| | | | OR IN RULE GROUP 42 | | | |
| | | | OR IN RULES 43.a)-43.f)] | | | |
| 45 | G | GH | [“-GH-” AND NOT: | K | | NOT NEW |
| | | | IN RULE GROUP 35-44] | | | |
| 46 | G | G | a.)“-EGM” | (silent) | | Dropped since too |
| | | | b.)“-IGM” | | | difficult to be |
| | | | c.)“-AGM” | | | pronounced in |
| | | | | | | consonant group |
| | | | | | | NEW |
| 47 | G | G | “-GT” | (silent) | | NEW |
| 48 | G | | a.)“-GNATION-” | K | | NOT NEW |
| | | | b.)“-GNATOR-” | | | |
| | | | c.)“-GNATE-” | | | |
| | | | d.)“-GNITY-” | | | |
| | | | e.)[“-GNAN-” AND NOT: | | | |
| | | | “POIGNANT”] | | | |
| | | | f.)“-GNAC-” | | | |
| | | | g.)“-GNIA-” | | | |
| | | | h.)“-GNUM-” | | | |
| | | | i.)“-LIGNI-” | | | |
| | | | j.)“-LIGNO-” | | | |
| | | | k.)“-REGNA-” | | | |
| | | | l.)“-MAGNA-” | | | |
| | | | m.)“-DIGNI-” | | | |
| | | | n.)“-SIGNAL-” | | | |
| | | | o.)“-SIGNIF-” | | | |
| | | | p.)“-SIGNAT-” | | | |
| | | | q.)“-IGNIT-” | | | |
| | | | r.)“-SIGNET-” | | | |
| | | | s.)“-LIGNEO-” | | | |
| | | | t.)“MAGNA” | | | |
| 49 | G | | a.)[“-IGN-” | (silent) | | as in rule 46 or |
| | | | b.)“-UGN-” | | | according to |
| | | | c.)“-EGN-” AND NOT: | | | French and Italian |
| | | | IN RULES 48.a)-48.s)] | | | pronounciation |
| | | | d.)“LORGNETTE” | | | NOT NEW |
| | | | e.)“LAGNIAPPE” | | | |
| | | | f.)“BOLOGN-” | | | |
| 50 | G | | a.)[“-GNE” | (silent) | | NOT NEW |
| | | | b.)“-GNA” AND NOT: | | | |
| | | | IN RULE GROUP 48 | | | |
| | | | OR IN RULE GROUP 49 | | | |
| | | | OR “MAGNA”] | | | |
| 51 | G | | [“-GN-” AND NOT: | K | | NEW, SINCE |
| | | | IN RULE GROUPS 48-50] | | | EXCEPTIONS NOT |
| | | | | | | DESCRIBED IN DM |
| 52 | G | | a.)“-<vowel>GLIA-” | (silent) | | Italian |
| | | | b.)“-<vowel>GLIO-” | | | pronounciation |
| | | | | | | ?? |
| 53 | G | | a.)“GELD-” | K | J | G is first letter of |
| | | | b.)“GELT-” | | | word and in this |
| | | | c.)“GERT-” | | | context usually |
| | | | d.)[“GERR-” AND NOT: | | | encodes to K |
| | | | “GERRY-”] | | | NEW SINCE CASES |
| | | | e.)“GINZ-” | | | WHERE ‘G’ -> ‘K’ |
| | | | f.)“GERH-” | | | ARE MUCH MORE |
| | | | g.)“GITE-” | | | MINUTELY |
| | | | h.)“GERSH-” | | | SPECIFIED |
| | | | i.)“GERST-” | | | |
| | | | j.)“GINSB-” | | | |
| | | | k.)“GELLER-” | | | |
| | | | l.)“GERDIE-” | | | |
| | | | m.)“GERBER-” | | | |
| | | | n.)“GESUND-” | | | |
| | | | o.)“GESNER-” | | | |
| | | | p.)“GINGKO-” | | | |
| | | | q.)“GINKGO-” | | | |
| | | | r.)“GIPPER-” | | | |
| | | | s.)“GESELL-” | | | |
| | | | t.)“GESTALT-” | | | |
| | | | u.)“GESTAPO-” | | | |
| | | | v.)“GINGHAM-” | | | |
| | | | w.)“GYNAECOL-” | | | |
| | | | x.)“GYNECOLO-” | | | |
| 54 | G | | a.)[“GEL-” | J | K | G is first letter of |
| | | | b.)“GEM-” | | | word and in this |
| | | | c.)“GEN-” | | | context usually |
| | | | d.)“GEO-” | | | encodes to J |
| | | | e.)“GER-” | | | NEW, AS ABOVE |
| | | | f.)“GES-” | | | IN 53 |
| | | | g.)“GIA-” | | | |
| | | | h.)“GIN-” | | | |
| | | | i.)“GIO-” | | | |
| | | | j.)“GIP-” | | | |
| | | | k.)“GIU-” | | | |
| | | | l.)“GYM-” | | | |
| | | | m.)“GYN-” | | | |
| | | | n.)“GYP-” | | | |
| | | | o.)“GYR-” | | | |
| | | | p.)“GIRA-” | | | |
| | | | q.)“GIRO-” AND NOT: | | | |
| | | | IN RULES 53.a)-58.s)] | | | |
| 55 | G | | “GILA-” | H | K | NEW |
| 56 | G | | a.)“GEE” | J | K | “Softened” by |
| | | | b.)“GEEW-” | | | following front |
| | | | c.)“GIRA-” | | | vowel |
| | | | d.)“GIBE-” | | | NEW, AS ABOVE |
| | | | e.)“GAOL-” | | | IN 53 |
| | | | f.)[“GIDE-” AND NOT: | | | |
| | | | “GIDEON-”] | | | |
| | | | g.)“GILES-” | | | |
| | | | h.)“GINGI-” | | | |
| | | | i.)“GINGER-” | | | |
| | | | j.)“GIBBER-” | | | |
| | | | k.)“GIBBET-” | | | |
| | | | l.)“GIBLET-” | | | |
| | | | m.)“GIBRAN-” | | | |
| | | | n.)“GIGOLO-” | | | |
| | | | o.)“GIRARD-” | | | |
| | | | p.)“GIGANT-” | | | |
| | | | q.)“GIRAFFE-” | | | |
| | | | r.)“GEEWHIZ-” | | | |
| | | | s.)“GILLETTE-” | | | |
| | | | t.)“GIBRALTA-” | | | |
| 57 | G | | [“G<vowel>-” AND NOT: | K | | NEW, AS ABOVE |
| | | | IN RULE GROUPS 54-56] | | | IN 53 |
| 58 | G | | a.)“-DANGER-” | J | K | NEW, AS ABOVE, |
| | | | b.)“-RANGER-” | | | EXCEPT FOR a.), |
| | | | c.)“-MANGER-” | | | b.), c.) |
| | | | d.)“-GINGER-” | | | |
| | | | e.)“-LOUNGER-” | | | |
| | | | f.)“-PLUNGER-” | | | |
| | | | g.)“-SPONGER-” | | | |
| | | | h.)“-CHANGER-” | | | |
| | | | i.)“-SALINGER-” | | | |
| | | | j.)“-HARBINGER-” | | | |
| | | | k.)“-MESSENGER-” | | | |
| | | | l.)“-PASSENGER-” | | | |
| | | | m.)“-PHALANGER-” | | | |
| | | | n.)“-SCAVENGER-” | | | |
| | | | o.)“-BOULANGER-” | | | |
| | | | p.)“-CHALLENGER-” | | | |
| | | | q.)“-SCHLESINGER-” | | | |
| 59 | G | | [“-NGER-” AND NOT: | K | J | NEW |
| | | | IN RULES 58.a)-58.q)] | | | |
| 60 | G | | a.)“-JAGER-” | K | | Mostly german |
| | | | b.)“-TIGER-” | | | NEW |
| | | | c.)[“-LIGER” AND NOT: | | | |
| | | | “-BELLIGEREN-”] | | | |
| | | | d.)“-LAGER-” | | | |
| | | | e.)“-LUGER-” | | | |
| | | | f.)“-AUGER-” | | | |
| | | | g.)“-EAGER-” | | | |
| | | | h.)“-SEEGER-” | | | |
| | | | i.)“-JAEGER-” | | | |
| | | | j.)“-GEIGER-” | | | |
| | | | k.)“-KRUGER-” | | | |
| | | | l.)“-SAUGER-” | | | |
| | | | m.)“-BURGER-” | | | |
| | | | n.)“-BERGER-” | | | |
| | | | o.)“-MEAGER-” | | | |
| | | | p.)“-KREIGER-” | | | |
| 61 | G | | [“-<letter>GER-” AND NOT: | J | | NEW |
| | | | IN RULE GROUPS 58-60] | | | |
| 62 | G | | a.)“-ENGEL-” | K | | mostly german |
| | | | b.)“-BAGEL-” | | | NEW |
| | | | c.)“-HEGEL-” | | | |
| | | | d.)“-HUGEL-” | | | |
| | | | e.)“-KUGEL-” | | | |
| | | | f.)“-MANGEL-” | | | |
| | | | g.)“-MANGEL-” | | | |
| | | | h.)“-WEIGEL-” | | | |
| | | | i.)“-FLUGEL-” | | | |
| | | | j)“-SPEIGEL-” | | | |
| | | | k.)“-STEIGEL-” | | | |
| | | | l.)“-WRANGEL-” | | | |
| | | | m.)“-DANEGELD-” | | | |
| 63 | G | | [“-<letter>GEL-” AND NOT: | J | | NEW |
| | | | IN RULE GROUP 62] | | | |
| 64 | G | | [“-GE-” | K | J | “-ge-”, “-gi-”, “-gy-” - |
| | | | OR “-GI-” | | | exceptions |
| | | | OR “-GY-”] | | | where these |
| | | | AND IN: | | | encode to K |
| | | | a.){“-GETH-” | | | instead of |
| | | | b.)“-GEAR-” | | | expected J |
| | | | c.)“-GEIS-” | | | NEW, AS ABOVE |
| | | | d.)“-GIRL-” | | | IN 53 |
| | | | e.)[“-GIVI-” AND NOT: | | | |
| | | | “-GINGIV-”] | | | |
| | | | f.)“-GIVE-” | | | |
| | | | g.)“-GIFT-” | | | |
| | | | h.)“-GIRD-” | | | |
| | | | i.)“-GIRT-” | | | |
| | | | j.)“-DANG-” | | | |
| | | | k.)“-FANG-” | | | |
| | | | l.)[“-SING-” AND NOT: | | | |
| | | | “-DISINGEN-”] | | | |
| | | | m.)[“-RING-” AND NOT: | | | |
| | | | “-CRING-” | | | |
| | | | “-FRING-” | | | |
| | | | “-SYRING-” | | | |
| | | | “-RINGENC-” | | | |
| | | | “-RINGENT-”] | | | |
| | | | n.)[“-WING-” AND NOT: | | | |
| | | | “-TWING-”] | | | |
| | | | o.)[“-HANG-” AND NOT: | | | |
| | | | “-CHANG-” | | | |
| | | | “-PHANG-”] | | | |
| | | | p.)[“-LONG-” AND NOT: | | | |
| | | | “-LONGITU-” | | | |
| | | | “-LONGEVI-”] | | | |
| | | | q.)“-SERGEY-” | | | |
| | | | r.)“-FORGET-” | | | |
| | | | s.)“-TARGET-” | | | |
| | | | t.)“-TURGEN-” | | | |
| | | | u.)“-BERGEN-” | | | |
| | | | v.)“-MORGEN-” | | | |
| | | | w.)“-MEGID-” | | | |
| | | | x.)“-HAGIO-” | | | |
| | | | y.)“-BEGET-” | | | |
| | | | z.)“-BEGIN-” | | | |
| | | | aa.)[“-LAGEN-” AND NOT: | | | |
| | | | “-COLLAGEN-”] | | | |
| | | | bb.)[“-HAGEN-” AND NOT: | | | |
| | | | “-OSPHAGEN-”] | | | |
| | | | cc.)“-NTGEN-” | | | |
| | | | dd.)“-EIGEN-” | | | |
| | | | ee.)“-MAGED” | | | |
| | | | ff.)“-GEYE-” | | | |
| | | | gg.)[“-NGY-” AND NOT: | | | |
| | | | “-RANGY-” | | | |
| | | | “-PONGY-” | | | |
| | | | “-MANGY-” | | | |
| | | | “-MINGY-”] | | | |
| | | | hh.)“-FOGY-” | | | |
| | | | ii.)“-POGY-” | | | |
| | | | jj.)“-YOGI-” | | | |
| | | | kk.)“-HOAGY-” | | | |
| | G | | ll.)“-STOGY-” | K | J | NEW |
| | | | mm.)“-PORGY-” | | | |
| | | | nn.)“-CARNEGIE-” | | | |
| | | | oo.)“-OGEY” | | | |
| | | | pp.)“-OGIE” | | | |
| | | | qq.)“-GILL-” | | | |
| | | | rr.)“RENEGE-” | | | |
| | | | ss.)“LANGE-” | | | |
| | | | tt.)“SYNGE-”} | | | |
| 65 | G | | a.)[“-GE-” | J | K | NEW |
| | | | b.)OR “-GI-” | | | |
| | | | c.)OR “-GY-” AND NOT: | | | |
| | | | IN RULE GROUP 64] | | | |
| 66 | G | | a.)“-MARGARY-” | J | K | exception |
| | | | b.)“-MARGARI-” | | | NEW |
| | | | c.)“-MARGARIT-” | | | |
| 67 | G | | (else) | K | | NOT NEW, |
| | | | | | | EXCEPT THAT |
| | | | | | | ABOVE |
| | | | | | | EXCEPTIONS ARE |
| | | | | | | MUCH MORE |
| | | | | | | DETAILED |
| 68 | H | | a.)“-HOUR-” | (silent) | | can somebody tell |
| | | | b.)“-HERB-” | | | me why ‘H’ is |
| | | | c.)“-HEIR-” | | | dropped in these |
| | | | d.)“-HONOR-” | | | words? |
| | | | e.)“-HONOUR-” | | | NEW |
| | | | f.)“-HONEST-” | | | |
| | | | g.)“HERB-” | | | |
| 69 | H | HS | “HS-” | X | | old-fashioned |
| | | | | | | chinese |
| | | | | | | transliteration |
| | | | | | | NEW |
| 70 | H | | a.)“HUA-” | A | | chinese and |
| | | | b.)[“HUE-” AND NOT: | | | spanish |
| | | | “HUEY-”] | | | NEW |
| | | | c.)“HWA-” | | | |
| 71 | H | | a.)“-NIHIL-” | (silent) | | exceptions where |
| | | | b.)“-VEHEM-” | | | H would normally |
| | | | c.)“-LOHEN-” | | | separate two |
| | | | d.)“-NEHEM-” | | | vowel groups but |
| | | | e.)“-MAHON-” | | | is not pronounced |
| | | | f.)“-GRAHAM-” | | | NEW - ENCODED |
| | | | g.)“-PROHIB-”??? NOT “PROHIBIT”, | | | ‘H’ in DM |
| | | | ONLY MAYBE “PROHIBITION” | | | |
| 72 | H | | a.)“H<vowel>-” | H | | NOT NEW |
| | | | b.)[“-<vowel>H<vowel>-” AND NOT: | | | |
| | | | IN RULE GROUP 71] | | | |
| 73 | H | | (else) | (do not | | regard H after |
| | | | | encode) | | consonant and |
| | | | | | | before vowel as |
| | | | | | | too close to just |
| | | | | | | vowel - don't |
| | | | | | | encode. |
| | | | | | | NOT NEW |
| 74 | J | | a.)[“-JUAN-” AND NOT: | H | | both Js encode to |
| | | | “-MARIJUANA-” | | | H for jojoba and |
| | | | “-TIJUANA-”] | | | jujuy - Spanish |
| | | | b.)“-JACI-” | | | words |
| | | | c.)“-JALI-” | | | NEW EXCEPT FOR |
| | | | d.)“-JEFE-” | | | i.) |
| | | | e.)“-JICA-” | | | |
| | | | f.)“-JIME-” | | | |
| | | | g.)“-JOAQ-” | | | |
| | | | h.)“-JUAR-” | | | |
| | | | i.)“-JOSE” | | | |
| | | | j.)“-JOSEL-” | | | |
| | | | k.)“-JEREZ-” | | | |
| | | | l.)“-JUNTA-” | | | |
| | | | m.)[“-JO” AND NOT: | | | |
| | | | “-TOJO” | | | |
| | | | “-BANJO”] | | | |
| | | | o.)“-JOJOBA-” | | | |
| | | | p.)“-JUJUY” | | | |
| 75 | J | | a.)“JAH-” | A | J | since all vowels |
| | | | b.)“JOHANN” | | | encode to A, this |
| | | | c.)“JUNG-” | | | represents the J |
| | | | d.)“JUNGL-” | | | pronounced as a Y - |
| | | | e.)“JUGO-” | | | german words |
| | | | | | | NEW |
| 76 | J | | [“J<vowel>-” AND NOT: | J | | NOT NEW, |
| | | | IN RULE GOUP 75] | | | EXCEPT THAT |
| | | | | | | ABOVE |
| | | | | | | EXCEPTION ARE |
| | | | | | | MORE DETAILED |
| 77 | J | | a.)“BOJA-” | H | | spanish, J not |
| | | | b.)“BAJA-” | | | initial |
| | | | c.)“MOJA-” | | | NEW |
| | | | d.)“MOJI-” | | | |
| | | | e.)“FRIJO-” | | | |
| | | | f.)“BRUJO-” | | | |
| | | | g.)“BRUJA-” | | | |
| | | | h.)“-AJARA” | | | |
| | | | i.)“-AJOS” | | | |
| | | | j.)“-EJOS” | | | |
| | | | k.)“-OJAS” | | | |
| | | | l.)“-UJON” | | | |
| | | | m.)“-AJOZ” | | | |
| | | | n.)“-AJAL” | | | |
| | | | o.)“-OJA” | | | |
| | | | p.)“-EJA” | | | |
| 78 | J | | a.)“-JL-” | (silent) | | considered a |
| | | | b.)“-JT-” | | | vowel. traditional |
| | | | c.)“-JK-” | | | spelling or from |
| | | | d.)“-JS-” | | | scandinavian |
| | | | e.)“-JN-” | | | language |
| | | | f.)“-JM-” | | | OLD, EXCEPT FOR |
| | | | g.)“-JB-” | | | i.) |
| | | | h.)“-JZ-” | | | |
| | | | i.)“HALLELUJA-” | | | |
| | | | j.)“REKJAVIK” | | | |
| | | | k.)“LJUBLJANA” | | | |
| 79 | J | J, JJ | (else) | J | | NOT NEW |
| 80 | K | | “KNESSET-” | K | | Hebrew words |
| | | | “KNIEVEL-” | | | where original |
| | | | “KNISH-” | | | pronounciation is |
| | | | | | | retained |
| | | | | | | NEW |
| 81 | K | | [“KN-” AND NOT: | (silent) | | NOT NEW |
| | | | IN RULE GROUP 80] | | | |
| 82 | K | | a.)“-KNOW-” | (silent) | | ‘K’ has not been |
| | | | b.)“-KNIT-” | | | pronounced since |
| | | | c.)[“-KNOT” c.1)AND NOT: | | | about 1400AD |
| | | | “BANKNOTE”] | | | NEW, SINCE DM |
| | | | d.)“-KNOB-” | | | RULE DOES NOT |
| | | | e.)“-KNOCK-” | | | COVER NON- |
| | | | f.)“-KNUCK-” | | | INITIAL |
| | | | g.)“-KNIFE-” | | | OCCURANCES |
| | | | h.)“-KNACK-” | | | |
| | | | i.)“-KNIGHT-” | | | |
| 83 | K | KK | “-KK-” | K | | NOT NEW |
| 84 | K | | (else) | K | | NOT NEW, |
| | | | | | | EXCEPT FOR NEW |
| | | | | | | EXCEPTIONS, |
| | | | | | | ABOVE |
| 85 | L | | “-LELY” | L | | two Ls - only |
| | | | | | | encode one! |
| | | | | | | NEW |
| 86 | L | | “COLONEL” | R | | first L - special |
| | | | | | | case - who can tell |
| | | | | | | me why this is? |
| | | | | | | NEW |
| 87 | L | | a.)“RENAULT” | (silent) | | both French words |
| | | | b.)“FOUCAULT” | | | known to |
| | | | | | | Americans |
| | | | | | | NEW |
| 88 | L | | “-EUIL” | (silent) | | always French |
| | | | | | | NEW |
| 89 | L | | a.)[“-COLN-” | (silent) | L | Dropped |
| | | | b.)“-CALM-” | | | presumably |
| | | | c.)[“-BALM-” c.1)AND NOT: | | | because of |
| | | | “-BALMO-”] | | | difficulty |
| | | | d.)“-MALM-” | | | pronouncing ‘L’ in |
| | | | e.)“-PALM-” e.1)AND NOT: | | | consonant group |
| | | | “-LMA-”] | | | NOT NEW, |
| | | | f.)“-HOLM” | | | EXCEPT FOR c.1), |
| | | | g.)“-HALM” | | | e.1), s.1), u.1), |
| | | | h.)“-COLM” | | | w.1), x.1), cc.1), |
| | | | i.)“-PSALM-” | | | dd.1), hh.1) |
| | | | j.)“-QUALM-” | | | |
| | | | k.)“-SALMON-” | | | |
| | | | l.)“-HOLMES-” | | | |
| | | | m.)“-ALMOND-” | | | |
| | | | n.)“ALMS-” | | | |
| | | | o.)“-WALK-” | | | |
| | | | p.)“-YOLK-” | | | |
| | | | q.)“-FOLK-” | | | |
| | | | r.)“-HALF-” | | | |
| | | | s.)[“-TALK-” s.1)AND NOT: | | | |
| | | | “TALKAL”] | | | |
| | | | t.)“-CALF-” | | | |
| | | | u.)[“-BALK-” u.1)AND NOT: | | | |
| | | | “BALKAN”] | | | |
| | | | v.)“-CALK-” | | | |
| | | | w.)[“-POLK-” w.1)AND NOT: | | | |
| | | | “-POLKA-”] | | | |
| | | | x.)[“-HALV-” x.1)AND NOT: | | | |
| | | | “-HALVA-”] | | | |
| | | | y.)“-CAULK-” | | | |
| | | | z.)“-CHALK-” | | | |
| | | | aa.)“-BAULK-” | | | |
| | | | bb.)“-FAULK-” | | | |
| | | | cc.)[“-SALVE-” cc.1)AND NOT: | | | |
| | | | “-SALVER-”] | | | |
| | | | dd.)[“-CALVE-” dd.1)AND NOT: | | | |
| | | | “-CALVER-”] | | | |
| | | | ee.)“-SOLDER-” | | | |
| | | | ff.)“-WOULD-” | | | |
| | | | gg.)“-COULD-” | | | |
| | | | hh.)[“-SHOULD-” hh.1)AND NOT: | | | |
| | | | “-SHOULDER-”] | | | |
| 90 | L | LL | a.)“TORTILLA” | (silent) | | spanish and |
| | | | b.)“RATATOUILLE” | | | french, so |
| | | | | | | pronounced Y, |
| | | | | | | therefore vowel, |
| | | | | | | so not encoded |
| | | | | | | NEW, SINCE, DM |
| | | | | | | ENCODES ‘L’ |
| | | | | | | FIRST |
| 91 | L | LL | a.)“-ILLO” | L | (silent) | too many english |
| | | | b.)“-ILLA” | | | words, like |
| | | | c.)“-ALLE” | | | ballerina and |
| | | | d.)“-LLAS” | | | gorilla, and also |
| | | | e.)“-LLOS” | | | american |
| | | | f.)“-LLA” | | | pronounciations of |
| | | | g.)“-LLO” | | | e.g. cabrillo where |
| | | | h.)“-ALLE-” | | | LL is pronounced |
| | | | | | | L; however, |
| | | | | | | metaph2 is |
| | | | | | | included with LL as |
| | | | | | | Y therefore “silent” |
| | | | | | | NOT NEW |
| 92 | L | | (else) | L | | NOT NEW |
| 93 | M | | “MN-” | (silent) | | initial |
| | | | | | | NEW |
| 94 | M | MP | a.)“-COMPTROL-” | N | | traditional, |
| | | | b.)“-ACCOMPT-” | | | apparantly from |
| | | | | | | old French |
| | | | | | | NEW |
| 95 | M | MM | “-MM-” | M | | ?? DOES DM |
| | | | | | | MISTAKENLY |
| | | | | | | ENCODE TO ‘MM” |
| 96 | M | | (else) | M | | NOT NEW |
| 97 | N | | a.)“DAMN” | (silent) | | Dropped |
| | | | b.)“LIMN” | | | presumably |
| | | | c.)“SOLEMN” | | | because of |
| | | | d.)“AUTUMN” | | | difficulty of |
| | | | e.)“CONDEMN” | | | pronouncing ‘N’ |
| | | | f.)“COLUMN” | | | after ‘M’ |
| | | | g.)“HYMN” | | | NEW |
| | | | check code for anything missing | | | |
| 98 | N | NC | “-<vowel>NCE” | NTS | | impossible to |
| | | | “-<vowel>NCY” | | | pronounce this |
| | | | | | | without including a |
| | | | | | | T - e.g. |
| | | | | | | ACCOUNTANTS |
| | | | | | | == |
| | | | | | | ACCOUNTENCE |
| | | | | | | NEW SINCE |
| | | | | | | ENCODING IS |
| | | | | | | DIFFERENT |
| 99 | NN | | “-NN-” | N | | NOT NEW |
| 100 | N | | (else IF NOT “MONSIEUR”) | N | | NOT NEW |
| 101 | Ñ | | “-Ñ-” | N | | Spanish letter, |
| | | | | | | pronounced ‘NY’ |
| | | | | | | NOT NEW |
| 102 | P | | a.)“PF-” | (silent) | | initial ‘P’ sound not |
| | | | b.)“PN-” | | | carried over from |
| | | | c.)“PS-” | | | greek and german |
| | | | d.)“PT-” | | | NOT NEW EXCEPT |
| | | | | | | FOR a.) AND d.) |
| 103 | P | PT | a.)“-RECEIPT-” | T | | Dropped |
| | | | b.)“-ASYMPTOT-” | | | presumably |
| | | | | | | because of |
| | | | | | | difficulty of |
| | | | | | | pronouncing ‘P’ |
| | | | | | | before ‘T’ |
| | | | | | | NEW |
| 104 | P | PHTH | a.)“PHTH-” | 0 | | pronounciation not |
| | | | b.)“-PHTHALEIN-” | | | carried over from |
| | | | c.)“-APOPHTHEGM-” | | | greek |
| | | | | | | NEW |
| 105 | P | PH | a.)“-PHEAD-” | P | | combining forms - |
| | | | b.)[“-PHOLE-” AND NOT: | | | H belongs to |
| | | | “-NYMPHOLE-”] | | | another word |
| | | | c.)“-PHELD-” | | | NEW |
| | | | d.)“-PHILL-” | | | |
| | | | e.)“-PHOLD-” | | | |
| | | | f.)“-PHEAP-” | | | |
| | | | g.)“-PHERD-” | | | |
| | | | h.)[“-PHANG-” AND NOT: | | | |
| | | | “-LYMPHANG-”] | | | |
| | | | i.)“-PHORN-” | | | |
| | | | j.)“-PHEAV-” | | | |
| | | | k.)“-PHOUSE-” | | | |
| | | | l.)“-PHAMMER-” | | | |
| | | | m.)“-PHAZARD-” | | | |
| | | | n.)“-PHUGGER-” | | | |
| | | | o.)“-PHOLSTER-” | | | |
| 106 | P | PH | [“-PH-” 106.a)AND NOT: | F | | Usually used in |
| | | | IN RULE GROUP 105] | | | words |
| | | | | | | transliterated from |
| | | | | | | greek |
| | | | | | | NOT NEW EXCEPT |
| | | | | | | 106.a) |
| 107 | P | PS | [“-CORPS-” AND NOT: | (silent) | | commonly |
| | | | “-CORPSE-”] | | | pronounced as in |
| | | | | | | French |
| | | | | | | NEW |
| 108 | P | | [“-COUP” AND NOT: | (silent) | | commonly |
| | | | “RECOUP”] | | | pronounced as in |
| | | | | | | French |
| | | | | | | NEW |
| 109 | P | | a.)“-PSYCH-” | (silent) | | pronounciation not |
| | | | b.)“-PSALM-” | | | carried over from |
| | | | c.)“-PNEUM-” | | | greek |
| | | | | | | NOT NEW |
| 110 | P | PB | a.)“-PB-” | P | | NOT NEW |
| | | PP | b.)“-PP-” | | | |
| 111 | P | | (else) | P | | NOT NEW, |
| | | | | | | EXCEPT FOR NEW |
| | | | | | | EXCEPTIONS, |
| | | | | | | ABOVE |
| 112 | Q | QQ | “-QQ-” | K | | NOT NEW |
| 113 | Q | | (else) | K | | NOT NEW |
| 114 | R | | a.)“-METIER” | (silent) | R | commonly |
| | | | b.)“-CARTIER” | | | pronounced as in |
| | | | c.)“-DOSSIER” | | | french; some |
| | | | d.)“-FOURIER” | | | others |
| | | | e.)“-OLIVIER” | | | NOT NEW, |
| | | | f.)“-CROUPIER” | | | EXCEPT k.) |
| | | | g.)“-CHEVALIER” | | | THROUGH m.) |
| | | | h.)“-LAVOISIER” | | | |
| | | | i.)“-PELLETIER” | | | |
| | | | j.)“-SOMMELIER” | | | |
| | | | k.)“-SURBURB-” | | | |
| | | | l.)“-WORSTED-” | | | |
| | | | m.)“-MONSIEUR-” | | | |
| | | | n.)“-POITIERS-” | | | |
| 115 | R | RR | “-RR-” | R | | NOT NEW |
| 116 | R | | (else) | R | | NOT NEW, |
| | | | | | | EXCEPT FOR NEW |
| | | | | | | EXCEPTIONS, |
| | | | | | | ABOVE |
| 117 | S | | a.)“-YVES” | (silent) | S | commonly |
| | | | b.)“-HORS” | | | pronounced as in |
| | | | c.)“-MESNES” (S at end) | | | french. Include S |
| | | | d.)“-DEBRIS” | | | to cover |
| | | | e.)“-CHABLIS” | | | mispronounciation |
| | | | f.)“-APROPOS” | | | s. |
| | | | g.)“-JACQUES” | | | NEW, EXCEPT I.), |
| | | | h.)“-ARKANSAS” | | | m.) |
| | | | i.)“-FRANCAIS” | | | |
| | | | j.)“-DESCARTES” (S at end) | | | |
| | | | k.)“-RENDEZVOUS” | | | |
| | | | l.)“-AIS” | | | |
| | | | m.)“-OIS” | | | |
| | | | n.)“-DESCARTES-” (S in middle) | | | |
| | | | o.)“-MESNES-” (S in middle) | | | |
| | | | p.)“-DUQUESNE-” | | | |
| | | | q.)“-FRESNEL-” | | | |
| | | | r.)“-GROSVENOR-” | | | |
| | | | s.)“-LOUISVILLE-” | | | |
| | | | t.)“-ILLINOISAN-” | | | |
| 118 | S | | a.)“-LISL-” | (silent) | | Dropped |
| | | | b.)“-LYSL-” | | | presumably |
| | | | c.) [“-AISL-” AND NOT: | | | because of |
| | | | “-PAISLEY-”] | | | difficulty of |
| | | | d.)“ISLE-” | | | pronouncing ‘S’ |
| | | | e.)“ISLAN-” | | | before ‘L’ |
| | | | | | | NEW, SINCE DM |
| | | | | | | RULE MISCODED |
| | | | | | | MANY ITEMS |
| 119 | S | ST | a.) [“-STLE-” AND NOT: | S | T | silent T - |
| | | | “-STLESS-”] | | | dropped |
| | | | b.)[“-STLI-” AND NOT: | | | presumably |
| | | | “-STLIKE-” | | | because of |
| | | | “-STLINE-” | | | difficulty of |
| | | | “-FIRSTLING-” | | | pronouncing ‘T’ |
| | | | “-NESTLING-” | | | between ‘S’ and |
| | | | “-WESTLING-”] | | | ‘L” |
| | | | c.)“-THISTLY-” | | | put this with the T |
| | | | d.)“-BRISTLY-” | | | rules |
| | | | e.)“-GRISTLY-” | | | NEW |
| | | | f.)“-CHRISTMA-” | | | |
| | | | g.)“-LISTEN-” | | | |
| | | | h.)“-RISTEN-” | | | |
| | | | i.)“-HASTEN-” | | | |
| | | | j.)“-FASTEN-” | | | |
| | | | k.)“-MUSTNT-” | | | |
| | | | l.)“-MOISTEN-” | | | |
| 120 | A | SC | “-USCLE-” | S | | e.g. “muscle” |
| | | | | | | NEW |
| 121 | S | STH | “-STHM-” | S | | e.g. “asthmatic” |
| | | | | | | NEW |
| 122 | S | | “-SUGAR-” | X | | exception |
| | | | | | | NOT NEW |
| 123 | S | | a.)“-<letter>SHAP” | S | | combining forms - |
| | | | b.)“-<letter>SHEAR” | | | H belongs to |
| | | | c.)“-SHEIM-” | | | another word |
| | | | d.)“-SHOEK-” | | | NEW, EXCEPT c.), |
| | | | e.)“-SHOLM-” | | | d.), e.), f.) |
| | | | f.)“-SHOLZ-” | | | |
| | | | g.)“-SHOOD-” | | | |
| | | | h.)“-SHEAD-” | | | |
| | | | i)“-SHEID-” | | | |
| | | | j.)“-SHOUS-” | | | |
| | | | k.)“-SHORS-” | | | |
| | | | l.)“-SHOLE-” | | | |
| | | | m.)“-SHUND-” | | | |
| | | | n.)“-SHELM-” | | | |
| | | | o.)“-SHAWK-” | | | |
| | | | p.)“-SHEART-” | | | |
| | | | q.)“-SHATCH-” | | | |
| | | | r.)“-SHOUSE-” | | | |
| | | | s.)“-SHOUND-” | | | |
| | | | t.)[“-SHORN-” AND NOT: | | | |
| | | | “-UNSHORN-”] | | | |
| | | | u.)“-SHARMON-” | | | |
| | | | v.)“-SHONEST-” | | | |
| | | | w.)“-SHALLOW-” | | | |
| | | | x.)“-SHOLDER-” | | | |
| | | | y.)“-SHOPPER-” | | | |
| | | | z.)“-SHEIMER-” | | | |
| | | | aa.)“-SHANDLE-” | | | |
| | | | bb.)“-SHABILLE-” | | | |
| | | | cc.)“-SHUMANCE-” | | | |
| | | | dd.)“-SHABITUA-” | | | |
| 124 | S | SH | [“-SH-” AND NOT: | X | | NOT NEW, |
| | | | IN RULE GROUP 123] | | | EXCEPT FOR NEW |
| | | | | | | ITEMS IN RULE |
| | | | | | | GROUP 123 |
| 125 | S | | a.)“-<letter>SCHIEF-” | S | | combining forms - |
| | | | b.)“-<tetter>SCHEAT-” | | | ‘CH’ belongs to |
| | | | c.)“-<letter>SCHANCE-” | | | another word |
| | | | | | | NEW |
| 126 | S | SCH | a.)“-SCHER” | X | | german |
| | | | b.)“-SCHEN” | | | NEW, EXCEPT a.), |
| | | | c.)“-SCHIS” | | | b.) |
| | | | d.)“-SCHENK-” | | | |
| | | | e.)“-SCHENB-” | | | |
| | | | f.)“-SCHIST-” | | | |
| 127 | S | SCH | a.)[“-SCHOO-” | SK | X | dutch, |
| | | | b.)“-SCHER-” | | | scandanavian, or |
| | | | c.)“-SCHEN-” | | | greek |
| | | | d.)“-SCHUY-” | | | NEW, EXCEPT a.), |
| | | | e.)“-SCHED-” | | | d.), e.), f.) |
| | | | f.)“-SCHEM-” | | | |
| | | | g.)“-SCHIA-” | | | |
| | | | h.)“-SCHIZ-” | | | |
| | | | i.)“-SCHIS-” | | | |
| | | | j.)“-SCHOL-” | | | |
| | | | k.)“-ESCHAT-” | | | |
| | | | l.)“-ASCHIN-” | | | |
| | | | m.)“-ASCHAL-” | | | |
| | | | n.)“-ISCHAE-” | | | |
| | | | o.)“-ISCHIA-” | | | |
| | | | p.)“-SCHY-” AND NOT: | | | |
| | | | IN RULE GROUP 125 | | | |
| | | | OR IN RULE GROUP 126] | | | |
| 128 | S | SCH | [“-SCH-” AND NOT: | X | | |
| | | | IN RULE GROUP 125 | | | |
| | | | OR IN RULE GROUP 126 | | | |
| | | | OR IN RULE GROUP 127] | | | |
| 129 | S | | a.)“SURE-” | X | | e.g., “ensure” |
| | | | b.)“-NSURE-” | | | NEW |
| | | | c.)“-NSURA-” | | | |
| | | | d.)“-NSURY-” | | | |
| | | | e.)“-KSURE-” | | | |
| | | | f.)“-KSURA-” | | | |
| | | | g.)“-KSURY-” | | | |
| 130 | S | | a.)[“-SURE-” | J | S | e.g., “treasure” |
| | | | b.)“-SURA-” | | | NEW |
| | | | c.)“-SURY-” AND NOT: | | | |
| | | | IN RULE GROUP 129] | | | |
| 131 | S | | “-RSUA-” | S | | e.g., “persuade” |
| | | | | | | NEW, SINCE |
| | | | | | | EXCLUDES CASE |
| | | | | | | W/OUT VOWEL |
| 132 | S | | a.)“-<vowel>SUO-” | J | S | e.g, “casual” |
| | | | b.)“-<vowel>SUA-” | | | NEW, SINCE |
| | | | | | | ENCODING |
| | | | | | | DIFFERENT |
| 133 | S | | a.)[“-SUO-” | X | S | e.g., “consensual” |
| | | | b.)“-SUA-” a.1, b.1)AND NOT: | | | NOT NEW, |
| | | | IN RULE GROUP 131 | | | EXCEPT a.1), b.1) |
| | | | OR IN RULE GROUP 132] | | | |
| 134 | S | SS | “-CISSIO-” | J | S | e.g., “abscission” |
| | | | | | | NOT NEW |
| 135 | S | SS | [“-<vowel>SSIO-” AND NOT: | X | S | e.g., “passion” |
| | | | IN RULE GROUP 134] | | | NOT NEW |
| 136 | S | SS | a.)“-USSIA-” | X | S | e.g., “Russia”, |
| | | | b.)“-ESSUR-” | | | “pressure” |
| | | | c.)“-ISSUR-” | | | NOT NEW, |
| | | | d.)“-ISSUE-” | | | EXCEPT FOR a.), |
| | | | e.)“-ESSIAN-” | | | b.), e.) f.), g.) |
| | | | f.)“-ASSURE-” | | | a) in kucera |
| | | | g.)“-ASSURA” | | | |
| | | | h.)“-ISSUAB-” | | | |
| | | | i.)“-ISSUAN-” | | | |
| 137 | S | | a.)“-JAMESIAN” | S | | S already part of |
| | | | b.)“-NICOSIAN” | | | combining form so |
| | | | c.)“-PEGASIAN” | | | pronounced as in |
| | | | d.)“-PEPYSIAN” | | | that word |
| | | | e.)“-HOBBESIAN” | | | NEW |
| | | | f.)“-HOLMESIAN” | | | |
| | | | g.)“-JAQUESIAN” | | | |
| | | | h.)“-KEYNESIAN” | | | |
| | | | i.)“-MALTHUSIAN” | | | |
| | | | j.)“-HOMOOUSIAN” | | | |
| | | | k.)“-MAGLEMOSIAN” | | | |
| | | | l.)“-HOMOIOUSIAN” | | | |
| | | | m.)“-LEVALLOISIAN” | | | |
| | | | n.)“-TARDENOISIAN” | | | |
| | | | o.)“-ALGESIA” | | | |
| 138 | S | | “-CHSIA-” | X | | NEW more specific |
| | | | | | | than kucera |
| 139 | S | | a.)[“-<vowel>SIA” | J | S | e.g., “asia”, |
| | | | b.)“-<vowel>SIAN” | | | “Persia” |
| | | | c.)“-RSIA” | | | a.), b.) NOT NEW, |
| | | | d.)“-RSIAN” AND NOT: | | | c.), d.) NEW |
| | | | IN RULE GROUP 137 | | | |
| | | | OR IN RULE GROUP 138] | | | |
| 140 | S | | “-RSIAL-” | X | S | NEW more specific |
| | | | | | | than kucera |
| 141 | S | | a.)“-<vowel>.SION-” | J | S | NEW, EXCEPT FOR |
| | | | b.)“-ERSION-” | | | a.) |
| | | | c.)“-URSION-” | | | kucera maps to |
| | | | | | | ‘sh’ |
| 142 | S | | [“-SION-” AND NOT: | X | S | NEW |
| | | | RULE 141] | | | kucera does not |
| | | | | | | account for |
| | | | | | | exceptions |
| 142.a | S | | a.)“SM-” | S | X | NOT NEW |
| | | | b.)“SN-” | | | |
| | | | c.)“SW-” | | | |
| | | | d.)“SL-” | | | |
| | | | e.)“-SZ-” | | | |
| 143 | S | SC | a.)“-SCIOUS-” | X | S | NEW |
| | | | b.)“-SCIU-” | | | |
| | | | c.)“-OMNISCIEN-” | | | |
| | | | d.)“-CONSCIEN-” | | | |
| | | | e.)“-CRESCEND-” | | | |
| | | | f.)“-FASCIS-” | | | |
| 144 | S | SC | a.)“-SCEPTIC-” | SK | S | NEW |
| | | | b.)“-SCEPSIS-” | | | |
| | | | c.)“-SCIVV-” | | | |
| | | | d.)“-SCIRO-” | | | |
| 145 | S | SC | a.)[“-SCE-” | S | | NOT NEW, |
| | | | b.)“-SCI-” a.1), b.1)AND NOT: | | | EXCEPT FOR a.1), |
| | | | IN RULE GROUP 143] | | | b.1) |
| | | | OR IN RULE GROUP 144] | | | |
| | | | c.)“-SCY-” | | | |
| 146 | S | SC | [“-SC-” AND NOT: | SK | | NEW EXCEPT FOR |
| | | | a.)IN RULE GROUP 143] | | | c.) |
| | | | b.)OR IN RULE GROUP 144] | | | |
| | | | c.)OR IN RULE GROUP 145] | | | |
| 147 | S | | a.)“-NAUSEA” | J | S | NEW |
| | | | b.)“-CASUI-” | | | |
| | | | c.)“-HOOSIER-” | | | |
| 148 | S | | a.)“SEAN” | X | S | NEW |
| | | | b.)[“-NAUSEA-” AND NOT: | | | |
| | | | “-NAUSEAT-”] | | | |
| | | | c.)“-NAUSEO-” | | | |
| 149 | S | SS | a.)[“-SS-” AND NOT: | S | | NOT NEW |
| | | SZ | IN RULE GROUP 134] | | | |
| | | | OR IN RULE GROUP 135] | | | |
| | | | OR IN RULE GROUP 136] | | | |
| | | | b.)“-SZ-” | | | |
| 150 | S | | (else) | S | | NOT NEW, |
| | | | | | | EXCEPT FOR NEW |
| | | | | | | EXCEPTIONS, |
| | | | | | | ABOVE |
| 151 | T | | a.)“TS-” | (silent) | T | initial |
| | | | b.)“TZ-” | | | NEW?? (CHECK |
| | | | | | | DM LISTING) |
| 152 | T | TH | a.)“-THAI-” | T | O | mostly greek and |
| | | | b.)“-THYME-” | | | French words |
| | | | c.)“-THYMY-” | | | where ‘TH’ |
| | | | d.)“-THERES-” | | | pronounced as ‘T’ |
| | | | e.)“-THEQUE-” | | | NEW, EXCEPT FOR |
| | | | f.)“-ESTHER-” | | | i.) THROUGH m.) |
| | | | g.)“-GOETHE-” | | | |
| | | | h.)“-NATHALIE-” | | | |
| | | | i.)“-THOMAS-” | | | |
| | | | j.)“-THOMPS-” | | | |
| | | | k.)“-THOMSO-” | | | |
| | | | l.)“-THOMSE-” | | | |
| | | | m.)“-THAMES-” | | | |
| | | | n.)“-THOVEN-” | | | |
| | | | o.)“-THOFEN-” | | | |
| 153 | T | | a.)[“-<letter>THATCH-” AND NOT: | T | | combining forms - |
| | | | “-UNTHATCH-”] | | | H belongs to |
| | | | b.)“-WARTHOG-” | | | second word in |
| | | | c.)“-THOOD-” | | | compound |
| | | | d.)“-THEAD-” | | | NEW, EXCEPT c.) |
| | | | e.)“-THEID-” | | | THROUGH e.) |
| | | | f.)“-THAND-” | | | |
| | | | g.)“-THILL-” | | | |
| | | | h.)“-THOLD-” | | | |
| | | | i.)“-THAWK-” | | | |
| | | | j.)“-THEAP-” | | | |
| | | | k.)“-THERD-” | | | |
| | | | l.)“-THOLE-” | | | |
| | | | m.)“-THOOK-” | | | |
| | | | n.)“-THUNT-” | | | |
| | | | o.)“-THOUSE-” | | | |
| | | | p.)“-THEART-” | | | |
| | | | q.)“-THASTE-” | | | |
| | | | r.)“-THYPNO-” | | | |
| 154 | T | TH | “-POSTHUM-” | X | T | NEW |
| 155 | T | TH | “-CLOTHES-” | (silent) | | exception |
| | | | | | | NEW |
| 156 | T | TH | [“-TH-” a.)AND NOT: | 0 | | NOT NEW, |
| | | | IN RULE GROUPS 152-155] | | | EXCEPT FOR NEW |
| | | | | | | RULES UNDER a.) |
| 157 | T | TCH | “-TCH-” | X | | NOT NEW |
| 158 | T | | a.)[“-MONET” | (silent) | T | commonly |
| | | | b.)“-GENET” | | | pronounced as in |
| | | | c.)“-POTPOURRI-” | | | french. include T |
| | | | d.)“-MORTGAGE-” | | | for |
| | | | e.)“-BERET-” | | | mispronounciations. |
| | | | f.)“-BIDET-” | | | NEW |
| | | | g.)“-FILET-” | | | |
| | | | h.)“-DEBUT-” | | | |
| | | | i.)“-DEPOT-” | | | |
| | | | j.)“-PINOT-” | | | |
| | | | k.)“-TAROT-” | | | |
| | | | l.)“-BALLET-” | | | |
| | | | m.)“-BUFFET-” | | | |
| | | | n.)“-CACHET-” | | | |
| | | | o.)“-CHALET-” | | | |
| | | | p.)“-ESPRIT-” | | | |
| | | | q.)“-RAGOUT-” | | | |
| | | | r.)“-GOULET-” | | | |
| | | | s.)“-GOURMET-” | | | |
| | | | t.)“-BOUQUET-” | | | |
| | | | u.)“-CROCHET-” | | | |
| | | | v.)“-CROQUET-” | | | |
| | | | w.)“-PARFAIT-” | | | |
| | | | x.)“-PINCHOT-” | | | |
| | | | y.)“-CABARET-” | | | |
| | | | z.)“-PARQUET-” | | | |
| | | | aa.)“-RAPPORT-” | | | |
| | | | bb.)“-ENTREPOT-” | | | |
| | | | cc.)“-CABERNET-” | | | |
| | | | dd.)“-DUBONNET-” | | | |
| | | | ee.)“-MASSENET-” | | | |
| | | | ff.)“-MUSCADET-” | | | |
| | | | gg.)“-RICOCHET-” | | | |
| | | | hh.)“-ESCARGOT-” | | | |
| | | | ii.)“-SOBRIQUET-” | | | |
| | | | jj.)“-CABRIOLET-” | | | |
| | | | kk.)“-CASSOULET-” | | | |
| | | | ll.)“-OUBRIQUET-” | | | |
| | | | mm.)“-CAMEMBERT-” AND NOT: | | | |
| | | | “-TAN-” | | | |
| | | | “-TRY-” | | | |
| | | | “-TIC-” | | | |
| | | | “-TOM-” | | | |
| | | | “-TIN-”] | | | |
| 159 | T | | a.)“-FORTUN-” | X | T | NEW, EXCEPT c.), |
| | | | b.)“-<vowel>TUL<vowel>-” | | | e.), r.) THROUGH |
| | | | c.)“-BITUA-” | | | w.) |
| | | | d.)“-BITUE-” | | | NEW: |
| | | | e.)“-<letter>TUA-” | | | g.), h.), |
| | | | f.)“-<letter>TUO-” | | | i.), j.), o.), p.), q.) |
| | | | g.)“-UENT-” | | | however, more |
| | | | h.)“-RIGHTEOUS-” | | | specific than |
| | | | i.)“-STATUTE-” | | | kucera: |
| | | | j.)“-AMATEUR-” | | | <><>tun<v> |
| | | | k.)“-NTULE-” | | | <><>tur<v> |
| | | | l.)“-NTULA-” | | | <><>tul<v> |
| | | | m.)“-STULE-” | | | <>tua<> |
| | | | n.)“-STULA-” | | | <>tuo<> |
| | | | o.)“-STEUR-” | | | <>tue<> |
| | | | p.)“-TUE” | | | <>tia<> |
| | | | q.)“-TIENCE” | | | <>tio<> |
| | | | r.)“-<letter>TURE-” | | | <>tiu<> |
| | | | s.)“-<letter>TURA<letter>-” | | | |
| | | | t.)“-VENTURA” | | | |
| | | | u.)“-<letter>TURI-” | | | |
| | | | v.)“-<letter>TURY-” | | | |
| | | | w.)“-<letter>TURO<letter>-” | | | |
| | | | x.)“-<letter>TIUS-” | | | |
| 160 | T | | a.)[“-<letter>TURA” AND NOT: | T | | NEW |
| | | | IN RULE 159.t] | | | |
| | | | b.)“-<letter>TURO” | | | |
| 161 | T | | “-EQUATION-” | J | | NOT NEW - kucera |
| 162 | T | | a.)“-FAUSTIAN-” | T | | NEW |
| | | | b.)“-PROUSTIAN-” | | | |
| | | | c.)“-KANTIAN-” | | | |
| | | | d.)“-GENTIAN-” | | | |
| | | | e.)“-ROOSEVELTIAN-” | | | |
| | | | f.)“-HESTIA-” | | | |
| | | | g.)“-MASTIA-” | | | |
| | | | h.)“-OSTIA-” | | | |
| | | | i.)“-IZVESTIA-” | | | |
| | | | j.)“ANTI-” | | | |
| | | | k.)“PITIA-” | | | |
| | | | l.)“DUTIA-” | | | |
| | | | m.)“PATIO-” | | | |
| | | | n.)“-ETIOL-” | | | |
| 163 | T | | a.){[“-TIO-” a.1)AND NOT: | X | T | NOT NEW, |
| | | | IN RULE 162.m | | | EXCEPT a.1), c.), |
| | | | OE IN RULE 162.n | | | d.), e.1), f.1), |
| | | | OR IN RULE GROUP 161] | | | l.1), m.) |
| | | | b.)“-TIAL-” | | | c.), d.) in kucera |
| | | | c.)“-RTIUM-” | | | |
| | | | d.)“-ATIUM-” | | | |
| | | | e.)[“-TIAN-” e.1)AND NOT: | | | |
| | | | IN RULES 162.a-162.e] | | | |
| | | | f.)[“-TIA” f.1)AND NOT: | | | |
| | | | IN RULES 162.f-162.i] | | | |
| | | | g.)“-TIATE-” | | | |
| | | | h.)“-TIATI-” | | | |
| | | | i.)“-TIABL-” | | | |
| | | | j.)“-TIATO-” | | | |
| | | | k.)“-TIARY-” | | | |
| | | | l.)“-CHRISTIAN-” l.1)AND NOT: | | | |
| | | | IN RULES 162.j-162.l} | | | |
| | | | m.)“-TIENT-” | | | |
| 164 | T | | “-OFTEN-” | (silent) | | NEW |
| 165 | T | TTH | “-MATTH-” | 0 | | NOT NEW |
| 166 | T | TSCH | [“-TSCH-” AND NOT: | X | | NEW |
| | | | “-WELT-” | | | |
| | | | “-KLAT-” | | | |
| | | | “-FEST-”] | | | |
| 167 | T | TZSCH | “-TZSCH-” | X | | NEW |
| 168 | T | TT | “-TT-” | T | | NOT NEW, |
| | | TD | “-TD-” | | | EXCEPT FOR NEW |
| | | | | | | EXCEPTIONS |
| | | | | | | ABOVE |
| 169 | T | | (else) | T | | NOT NEW, |
| | | | | | | EXCEPT FOR NEW |
| | | | | | | EXCEPTIONS |
| | | | | | | ABOVE |
| 170 | V | W | “-VV-” | F | | NOT NEW |
| 171 | V | | (else) | F | | NOT NEW |
| 172 | W | | a.)“-WR-” | (silent) | | b.) and c.) treat as |
| | | | b.)“-<vowel>W-” | | | vowel |
| | | | c.)“-<letter>W<vowel>-” | | | NOT NEW |
| 173 | W | | “W<vowel>-” | A | F | treat as an initial |
| | | | | | | vowel |
| | | | | | | NOT NEW |
| 174 | W | WH | a.)“-WHOOSH-” | A | | treat as vowel |
| | | | b.)“-WHOOP-” | OR | | NOT NEW EXCEPT |
| | | | c.)“-WHOMP-” | (silent) | | h.1) |
| | | | d.)“-WHORL-” | | | |
| | | | e.)“-WHORT-” | | | |
| | | | f.)“-WHOA-” | | | |
| | | | g.)“-WHOP-” | | | |
| | | | h.)[“WH-” h.1)AND NOT IN RULE | | | |
| | | | GROUP 175] | | | |
| 175 | W | WH | a.)[“-WHO-” AND NOT: | H | | for rule b.) |
| | | | IN RULES 174.a-174.g] | | | through in.), W is |
| | | | b.)“-WHIDE-” | | | is of course part of |
| | | | c.)“-WHARD-” | | | first word of |
| | | | d.)“-WHEAD-” | | | combining form |
| | | | e.)“-WHAWK-” | | | NEW |
| | | | f.)“-WHERD-” | | | |
| | | | g.)“-WHOOK-” | | | |
| | | | h.)“-WHAND-” | | | |
| | | | i.)“-WHOLE-” | | | |
| | | | j.)“-WHEART-” | | | |
| | | | k.)“-WHOUSE-” | | | |
| | | | l.)“-WHOUND-” | | | |
| | | | m.)“-WHAMMER-” | | | |
| 175.a | W | | a.)“-EWSKI-” | (treat | F | match germanic |
| | | | b.)“-EWSKY” | as non- | | words |
| | | | c.)“-OWSKI-” | initial | | NOT NEW |
| | | | d.)“-OWSKY-” | vowel | | |
| | | | e.)“-<vowel>W” | and | | |
| | | | f.)“SCH-W-” | don't | | |
| | | | | encode) | | |
| 175.b | W | WICZ, | a.)“-WICZ-” | TS | FX | code to match |
| | | WITZ | b.)“-WITZ-” | | | english and polish |
| | | | | | | NOT NEW |
| 176 | X | | a.)“-XYLO-” | S | | greek root - |
| | | | b.)“-XYLE-” | | | represents ‘KS’ |
| | | | c.)“-XENO-” | | | sound in greek but |
| | | | d.)“-XANTH-” | | | ‘K’ dropped in |
| | | | | | | English |
| | | | | | | NOT NEW, |
| | | | | | | EXCEPT INCLUDES |
| | | | | | | NON INITIAL, AND |
| | | | | | | EXCLUDES OTHER |
| | | | | | | CONTEXTS |
| 177 | X | | “-LUXUR-” | J | KS | exception although |
| | | | | | | sometimes |
| | | | | | | pronounced ‘KS’ in |
| | | | | | | Britain |
| | | | | | | NEW |
| 178 | X | | “-OAXACA-” | H | | mexican indian |
| | | | | | | word |
| | | | | | | NEW |
| 179 | X | | a.)“-XUAL-” | KX | KS | remember that X |
| | | | b.)“-XION-” | | | stands for ‘SH’ |
| | | | c.)“-XIOU-” | | | sound - british |
| | | | | | | spelling |
| | | | | | | NEW |
| 180 | X | | a.)“-IAUX” | (silent) | | pronounced as in |
| | | | b.)“-EAUX” | | | french |
| | | | c.)“-IEUX” | | | NOT NEW EXCEPT |
| | | | d.)“-AIX” | | | FOR g.) and h.) |
| | | | e.)“-AUX” | | | |
| | | | f.)“-OUX” | | | |
| | | | g.)“-OIX” | | | |
| | | | h.)“-EUX” | | | |
| 181 | X | XX | a.)“-XX-” | KS | | ??NEW?? - ARE |
| | | XC | b.)“-XCI-” | | | THESE CONTEXTS |
| | | | c.)“-XCE-” | | | ENCODED |
| | | | | | | CORRECTLY IN |
| | | | | | | DM? |
| 182 | X | | (else) | KS | | NOT NEW, |
| | | | | | | EXCEPT FOR NEW |
| | | | | | | EXCEPTIONS, |
| | | | | | | ABOVE |
| 183 | Z | ZS | “-ZSA-” | J | | NEW |
| 184 | Z | | a.)“-AZUR-” | J | S | French |
| | | | b.)“-GLAZIER-” | | | NEW |
| 185 | Z | ZZ | a.)“-ZZA” | TS | S | Italian |
| | | | b.)“-ZZI” | | | NEW EXCEPT b.), |
| | | | c.)“-ZZO” | | | e.) |
| | | | d.)“-MOZZARELL-” | | | |
| | | | e.)“-PIZZICATO-” | | | |
| | | | f.)“-PUZZONLAN-” | | | |
| 186 | Z | | a.)“-SCHIZO-” | TS | S | german, greek, |
| | | | b.)“-SCHERZ-” | | | Italian |
| | | | C.)“-NAZI” | | | NEW |
| | | | d.)“-NAZIFY-” | | | |
| | | | e.)“-MOZART-” | | | |
| | | | f.)“-SCHMERZ-” | | | |
| | | | g.)“-WEIZ-” | | | |
| 187 | Z | | a.)“-CHEZ-” | (silent) | | pronounced as in |
| | | | b.)“-RENDEZ-” | | | french |
| | | | | | | NEW |
| 188 | Z | ZH | “-ZN-” | J | | NOT NEW |
| 189 | Z | ZZ | [“-ZZ-” AND NOT: | S | | NOT NEW, |
| | | | IN RULE GROUP 185] | | | EXCEPT FOR NEW |
| | | | | | | EXCEPTIONS, |
| | | | | | | ABOVE |
| 190 | Z | | (else) | S | | NOT NEW, |
| | | | | | | EXCEPT FOR NEW |
| | | | | | | EXCEPTIONS, |
| | | | | | | ABOVE |

TABLE 3
TABLE OF ENCODING RULES NOT UNIQUE TO METAPHONE 3

| Rule | | | METAPHONE 3: | | | |
|---|---|---|---|---|---|---|
| Group | Letter | Digraph | Rule | Encoding | Alternate | Remarks |
| 0 | A, E, I | | IF VOWEL FIRST LETTER IN WORD, | A | | VOWEL |
| | O, U, | | ALWAYS ENCODED AS ‘A’. | | | ENCODING RULES |
| | W, Y | | (FOR ‘W’, ONLY IF | | | NOT NEW |
| | | | “W<vowel>-”) | | | |
| | | | OTHERWISE NOT ENCODED UNLESS VOWEL | | | |
| | | | ENCODING MODE TURNED ON. IN THAT | | | |
| | | | CASE, ALL LETTER SEQUENCES PURELY | | | |
| | | | OF VOWELS ENCODED AS SINGLE ‘A’, | | | |
| | | | UNLESS SILENT VOWEL SEQUENCE | | | |
| | | | ACCORDING TO RULE GROUP 00 AS | | | |
| | | | FOLLOWS. | | | |
| 1 | B | | e.){“-THUMB-” | (silent) | P | ‘B’ dropped |
| | | | f.)“-DUMB-” | | | because of |
| | | | g.)“-BOMB-” | | | difficulty of |
| | | | h.)[“-LAMB-” h.1)AND NOT: | | | pronouncing |
| | | | “-LAMBEN-” | | | consonant group |
| | | | “-LAMBER-” | | | NEW: |
| | | | “-LAMBET-” | | | a.), b.), c.), |
| | | | “-LAMBRE-”] | | | d.), h.1), i.1), j.1), j.1.a), |
| | | | i.)[“-NUMB-” | | | |
| | | | j.)[“-TOMB-” | | | |
| | | | k.)“-BUNCOMB-” | | | |
| | | | l.)“-CLIMB-” | | | |
| | | | m.)“-PLUMB-” | | | |
| 2 | B | BB | a.)“-BB-” | P | | 2.a NOT NEW |
| | | BP | | | | 2.b NEW |
| 3 | B | | (else) | P | | NOT NEW |
| 5 | C | | a.)“CAES-” | S | K | Greek roots, |
| | | | | | | words normally |
| | | | | | | spelled with a |
| | | | | | | cedilla to indicate |
| | | | | | | C as S (french and |
| | | | | | | portugese), |
| | | | | | | other exceptions |
| | | | | | | ALL NEW EXCEPT |
| | | | | | | FOR a.) |
| 6 | C | CC | b.)[“-CCE-” b.1)AND NOT: | KS | | E.g., “accident”, |
| | | | “-SOCCER-”] | | | “accede” |
| | | | 6.a)-6.c) c.1)AND NOT: | | | NEW: |
| | | | 7.c} | | | a.), c.) |
| 7 | C | CC | a.)“SOCCER” | K | | NOT NEW |
| | | | b.)“-CCH-” | | | |
| | | | c.)“MCC-” | | | |
| 9 | C | CH | a.)“-CHAE-” | K | X | Michael |
| | | | b.)[“ACH-” | | | German names |
| | | | e.)“-BACHER-” | | | words with Greek |
| | | | f.)“-MACHER-” f.1)AND NOT: | | | roots |
| | | | IN RULES: 12.g)-12.m)] | | | b.1) NEW SINCE |
| | | | g.)“-BACH”, | | | RESTRICTS MORE |
| | | | h.)“-MACHE-” | | | NEW: |
| | | | i.)[“-ARCH-” i.1)AND NOT: | | | b.1.a), c.), d.), |
| | | | IN RULES: 12.n)-12.cc)] | | | f.1), i.) through j.), |
| | | | j.)“-CHAMOM-” | | | m.) through r.), |
| | | | k.)“-CHARAC-” | | | w.) through mm.) |
| | | | l.)“-CHARIS-” | | | |
| | | | m.)“-CHARTO-” | | | |
| | | | n.)“-CHARTU-” | | | |
| | | | o.)“-CHARYB-” | | | |
| | | | p.)“-CHRIST-” | | | |
| | | | q.)“-CHEMIC-” | | | |
| | | | r.)“-CHILIA-” | | | |
| | | | s.)[“-CHEMI-” AND NOT: | | | |
| | | | “CHEMISE”] | | | |
| | | | t.)“-CHEMO-” | | | |
| | | | u.)“-CHEMU-” | | | |
| | | | v.)“-CHEMY-” | | | |
| | | | w.)“-CHOND-” | | | |
| | | | x.)“-CHONA-” | | | |
| | | | y.)“-CHONI-” | | | |
| | | | z.)“-CHOIR-” | | | |
| | | | aa.)“-CHASM-” | | | |
| | | | bb.)“-CHARO-” | | | |
| | | | cc.)“-CHROM-” | | | |
| | | | dd.)“-CHROI-” | | | |
| | | | ee.)“-CHAMA-” | | | |
| | | | ff.)“-CHALC-” | | | |
| | | | gg.)“-CHALD-” | | | |
| | | | hh.)“-CHAET-” | | | |
| | | | ii.)“-CHIRO-” | | | |
| | | | jj.)“-CHILO-” | | | |
| | | | kk.)“-CHELA-” | | | |
| | | | ll.)“-CHOUS-” | | | |
| | | | mm.)“-CHEIL-” | | | |
| | C | CH | ss.)[“-CHOR-” ss.1)AND NOT: | | X | Greek roots |
| | | | ss.1.a)“CHORE-” | | | NEW: |
| | | | uu.)“-CHYM-” | | | nn.) through rr.) |
| | | | ww.)“-CHLO-” | | | ss.1.b) |
| | | | xx.)“-CHAO-” | | | tt.), vv.), xx.), |
| | | | yy.)[“-CHOS-” yy.1)AND NOT: | | | yy.), zz.), |
| | | | “-CHOSE-”] | | | aaa.1), bbb.) |
| | | | aaa.)[“-CHIA-” aaa.1)AND NOT: | | | through kkk.), |
| | | | “APPALACHIA”] | | | mmm.) through |
| | | | lll.)“-ORCHID-” [DM] | | | uuuuu.), |
| | | | vvv.)“-MELCH-” | | | wwwww.) through |
| | | | bbbb.)“-SYNCH-” | | | aaaaaa.), |
| | | | cccc.)“-PSYCH-” | | | cccccc.1), |
| | C | CH | hhhh.)“-PULCH-” | | X | gggggg.1) |
| | | | iiii.)“-EPOCH-” | | | |
| | | | jjjj.)“-JOACH-” | | | |
| | | | kkkk.)“-ERICH-” | | | |
| | | | llll.)[“-TRICH-” AND NOT: | | | |
| | | | “OSTRICH”] | | | |
| | | | mmmm.)“-TYCH-” | | | |
| | | | oooo.)“-TOCH-” | | | |
| | | | pppp.)“-BUCH-” | | | |
| | | | qqqq.)“-DACH-” | | | |
| | | | rrrr.)“-MOCH-” | | | |
| | | | ssss.)“-CICH-” | | | |
| | | | tttt.)“-DICH-” | | | |
| | | | uuuu.)“-NUCH-” | | | |
| | | | vvvv.)“-EICH-” | | | |
| | | | wwww.)“-LOCH-” | | | |
| | | | xxxx.)[“-DOCH-” AND NOT: | | | |
| | | | IN RULES: 12.dd)-12.hh)] | | | |
| | | | yyyy.)“-ZECH-” | | | |
| | | | zzzz.)“-LYCHN-” | | | |
| | | | aaaaa.)“-TACHO-” | | | |
| | | | bbbbb.)“-ORCHO-” | | | |
| | | | ccccc.)“-ORCHI-” | | | |
| | | | ddddd.)“-LICHO-” | | | |
| | | | eeeee.)“OCHER-” | | | |
| | | | fffff.)“ECHIN-” | | | |
| | | | ggggg.)“<letter>OCHER-” | | | |
| | | | hhhhh.)“<letter>ECHIN-” | | | |
| | | | iiiii.)“-BRONCH-” | | | |
| | | | jjjjj.)“-STOICH-” | | | |
| | | | kkkkk.)“-STRYCH-” | | | |
| | | | lllll.)“-TELECH-” | | | |
| | | | mmmmm.)“-PLANCH-” | | | |
| | | | nnnnn.)“-CATECH-” | | | |
| | | | ooooo.)“-MANICH-” | | | |
| | | | ppppp.)“-MALACH-” | | | |
| | | | qqqqq.)“-ZURICH-” | | | |
| | | | rrrrr.)“ICHA-” | | | |
| | | | sssss.)“ICHN-” | | | |
| | | | ttttt.)“-LEPRECH-” | | | |
| | | | uuuuu.)“-WEYRICH-” | | | |
| | | | vvvvv.)“-ORCHESTR-” [DM] | | | |
| | | | wwwww.)“-BRANCHIO-” | | | |
| | | | xxxxx.)“-BRANCHIF-” | | | |
| | | | yyyyy.)“INCHOA-” | | | |
| | | | zzzzz.)“ISCH-” | | | |
| | | | aaaaaa.)“-NICH” | | | |
| | | | bbbbbb.)[“-CHT-” [DM] | | | |
| | | | cccccc.)“-CHS-” [DM] cccccc.1)AND | | | |
| | | | NOT: “WHICHSOEVER”] | | | |
| | C | CH | dddddd.)[“-ACH” | | X | |
| | | | eeeeee.)“-OCH” | | | |
| | | | ffffff.)“-UCH” | | | |
| | | | gggggg.)“-ECH” gggggg.1)AND NOT: | | | |
| | | | “DEBAUCH” | | | |
| | | | OR IN RULES: 12.dd)-12.hh)] | | | |
| | | | hhhhhh.)<“A” OR “O” OR “U” OR | | | |
| | | | “E”>“CH”<“L” OR “R” OR “N” OR “M” | | | |
| | | | OR “B” OR “H” OR “F” OR “V” OR “W” | | | |
| | | | OR “ ”> | | | |
| | | | iiiiii.)“MCH-” | | | |
| 12 | C | CH | a.)“-OACH-” [DM] | X | | Normal English |
| | | | b.)“-EACH-” [DM] | | | pronounciation |
| | | | c.)“-EECH-” [DM] | | | NEW: |
| | | | | | | d.) through hh.) |
| 13 | C | CK | a.)“-CK-” | K | | Two letters with |
| | | CG | b.)“-CG-” | | | virtually the same |
| | | CQ | c.)“-CQ-” | | | sound next to |
| | | | | | | each other |
| | | | | | | NEW: |
| | | | | | | d.) through f.) |
| 14 | C | | k.)“-CELLO” | X | S | Euphony has |
| | | | l.)“ANCIENT-” | | | migrated |
| | | | m.)“CIAO” | | | pronounciation to |
| | | | n.)“-CEOUS-”, n.1)“-CIOUS-” | | | SH or TCH sound |
| | | | o.)[“-<vowel>CIO-” | | | except for high |
| | | | p.)“-<vowel>CIE-” | | | class british |
| | | | q.)“-<vowel>CIA-” | | | NEW: |
| | | | | | | a.) through k.), |
| | | | | | | g.1) |
| 15 | C | | a.)“-ASSOCIAT-” | S | X | Normal S sound |
| | | | b.)“-SOCIO-” | | | for ‘C’ except that |
| | | | c.)“-SOCIE-” | | | “associate” and |
| | | | d.)“-YCIA” | | | “scociological” can |
| | | | e.)“-UCIA” | | | also be ‘SH’ |
| | | | f.)“-OCIA” | | | NOT NEW |
| | | | g.)“-ICIE” | | | |
| | | | h.)“-YCIAS” | | | |
| | | | i.)“-UCIAS” | | | |
| | | | j.)“-OCIAS” | | | |
| | | | k.)“-ICIES” | | | |
| | | | l.)“HACIENDA-” | | | |
| | | | m.)“GRACIA-” | | | |
| 18 | C | CK | a.)“-CK-” | K | | NEW: b.) |
| | | CQ | | | | |
| 19 | C | | (else) | K | | NOT NEW |
| 20 | ç | | “-ç-” | S | | “Cedilla” indicates |
| | | | | | | C pronounced as |
| | | | | | | ‘S’ in French and |
| | | | | | | portuguese |
| | | | | | | NOT NEW |
| 21 | D | DG | a.)“-DGA-” | TK | | ‘D’ and ‘G’ |
| | | | b.)“-DGO-” | | | pronounced as |
| | | | c.)“-DGUN-” | | | written since two |
| | | | d.)“-DGUT-” | | | words or roots are |
| | | | f.)“-DGLAS-” | | | concatenated in |
| | | | g.)“-DGRIP-” | | | one word |
| | | | h.)“-DGUARD-” | | | NEW: |
| | | | i.)“-DGUILT-” | | | e.) |
| | | | j.)“-DGRAVE-” | | | |
| | | | k.)“-DGROUSE-” | | | |
| 22 | D | DG | “-DG-” AND NOT: | J | | Traditional English |
| | | | IN RULE GROUP 21] | | | spelling to indicate |
| | | | | | | “soft” G |
| | | | | | | NOT NEW |
| 25 | D | DT | a.)“-DT-” AND NOT: | T | | NOT NEW |
| | | DD | IN RULE GROUP 24] | | | |
| | | | b.)“-DD-” | | | |
| 28 | D | | (else) | T | | NOT NEW |
| 29 | F | FF | “-FF-” | F | | NOT NEW |
| 30 | F | | (else) | F | | NOT NEW |
| 31 | G | | “GN-” | (silent) | | At start of word. |
| | | | | | | Mostly greek or |
| | | | | | | Scandinavian |
| | | | | | | words, initial |
| | | | | | | consonant not |
| | | | | | | pronounced in |
| | | | | | | English |
| | | | | | | NOT NEW |
| 34 | G | GG | a.)[“-GG-” a.1)AND NOT: | K | | NEW: |
| | | | IN RULE GROUP 32 | | | a.1) |
| | | | OR IN RULES 33.a)-33.h)] | | | |
| 35 | G | GH | “-<consonant>GH-” | K | | NOT NEW |
| 36 | G | GH | “GHI-” | J | | Italian |
| | | | | | | NOT NEW |
| 37 | G | GH | “GH-” AND NOT: | K | | NOT NEW |
| | | | IN RULE GROUP 36] | | | |
| 38 | G | GH | a.)[“-LAUGHT-” | F | | Almost all “-gh-” |
| | | | “-LAUGHTO”] | | | spellings were |
| | | | b.)“-DRAUGHT-” | | | originally |
| | | | | | | pronounced ‘KH’ in |
| | | | | | | anglo-saxon and |
| | | | | | | middle English, but |
| | | | | | | this sound has not |
| | | | | | | existed in English |
| | | | | | | since about |
| | | | | | | 1400AD - yet the |
| | | | | | | letters remain. |
| | | | | | | NEW: a.1) |
| 39 | G | GH | a.)[“-UGHT-” | (silent) | | NEW: a.1) |
| 41 | G | GH | a.)[“-B<letter>GH-” | (silent) | | See rule 38 |
| | | | b.)“-H<letter>GH-” | | | NEW: |
| | | | c.)“-D<letter>GH-” | | | d.)through e.), i.) |
| | | | f.)“-B<letter><letter>GH-” | | | through m.), p.), |
| | | | g.)“-H<letter><letter>GH-” | | | q.) |
| | | | h.)“-D<letter><letter>GH-” | | | |
| | | | n.)“-B<letter><letter><letter>GH-” | | | |
| | | | o.)“-H<letter><letter><letter>GH-” | | | |
| 43 | G | GH | h.)“-IGH-” | (silent) | | See rule 38 |
| | | | | | | NEW: |
| | | | | | | a.) through g.) |
| 44 | G | GH | a.)[“-C<letter>UGH-” | F | | See rule 38 |
| | | | b.)“-G<letter>UGH-” | | | NEW: |
| | | | c.)“-L<letter>UGH-” | | | f.), g.) |
| | | | d.)“-R<letter>UGH-” | | | |
| | | | e.)“-T<letter>UGH-” | | | |
| 45 | G | GH | [“-GH-” AND NOT: | K | | NOT NEW |
| | | | IN RULE GROUP 35-44] | | | |
| 48 | G | | a.)“-GNATION-” | K | | NOT NEW |
| | | | b.)“-GNATOR-” | | | |
| | | | c.)“-GNATE-” | | | |
| | | | d.)“-GNITY-” | | | |
| | | | e.)[“-GNAN-” AND NOT: | | | |
| | | | “POIGNANT”] | | | |
| | | | f.)“-GNAC-” | | | |
| | | | g.)“-GNIA-” | | | |
| | | | h.)“-GNUM-” | | | |
| | | | i.)“-LIGNI-” | | | |
| | | | j.)“-LIGNO-” | | | |
| | | | k.)“-REGNA-” | | | |
| | | | l.)“-MAGNA-” | | | |
| | | | m.)“-DIGNI-” | | | |
| | | | n.)“-SIGNAL-” | | | |
| | | | o.)“-SIGNIF-” | | | |
| | | | p.)“-SIGNAT-” | | | |
| | | | q.)“-IGNIT-” | | | |
| | | | r.)“-SIGNET-” | | | |
| | | | s.)“-LIGNEO-” | | | |
| | | | t.)“MAGNA” | | | |
| 49 | G | | a.)[“-IGN-” | (silent) | | as in rule 46 or |
| | | | b.)“-UGN”- | | | according to |
| | | | c.)“-EGN-” AND NOT: | | | French and Italian |
| | | | IN RULES 48.a)-48.s)] | | | pronounciation |
| | | | d.)“LORGNETTE” | | | NOT NEW |
| | | | e.)“LAGNIAPPE” | | | |
| | | | f.)“BOLOGN-” | | | |
| 50 | G | | a.)[“-GNE” | (silent) | | NOT NEW |
| | | | b.)“-GNA” AND NOT: | | | |
| | | | IN RULE GROUP 48 | | | |
| | | | OR IN RULE GROUP 49 | | | |
| | | | OR “MAGNA”] | | | |
| 52 | G | | a.)“-<vowel>GLIA-” | (silent) | | Italian |
| | | | b.)“-<vowel>GLIO-” | | | pronounciation |
| | | | | | | ?? |
| 58 | G | | a.)“-DANGER-” | J | K | NEW, AS ABOVE, |
| | | | b.)“-RANGER-” | | | EXCEPT FOR a.), |
| | | | c.)“-MANGER-” | | | b.), c.) |
| 67 | G | | (else) | K | | NOT NEW, |
| | | | | | | EXCEPT THAT |
| | | | | | | ABOVE |
| | | | | | | EXCEPTIONS ARE |
| | | | | | | MUCH MORE |
| | | | | | | DETAILED |
| 72 | H | | a.)“H<vowel>-” | H | | NOT NEW |
| | | | b.)[“-<vowel>H<vowel>-” AND NOT: | | | |
| | | | IN RULE GROUP 71] | | | |
| 73 | H | | (else) | (do | | regard H after |
| | | | | not | | consonant and |
| | | | | encode) | | before vowel as |
| | | | | | | too close to just |
| | | | | | | vowel - don't |
| | | | | | | encode. |
| | | | | | | NOT NEW |
| 74 | J | | i.)“-JOSE” | H | | both Js encode to |
| | | | | | | H for jojoba and |
| | | | | | | jujuy - Spanish |
| | | | | | | words |
| | | | | | | NEW EXCEPT FOR |
| | | | | | | i.) |
| 76 | J | | [“J<vowel>-” AND NOT: | J | | NOT NEW, |
| | | | IN RULE GOUP 75] | | | EXCEPT THAT |
| | | | | | | ABOVE |
| | | | | | | EXCEPTION ARE |
| | | | | | | MORE DETAILED |
| 78 | J | | a.)“-JL-” | (silent) | | considered a |
| | | | b.)“-JT-” | | | vowel. traditional |
| | | | c.)“-JK-” | | | spelling or from |
| | | | d.)“-JS-” | | | scandinavian |
| | | | e.)“-JN-” | | | language |
| | | | f.)“-JM-” | | | OLD, EXCEPT FOR |
| | | | g.)“-JB-” | | | i.) |
| | | | h.)“-JZ-” | | | |
| | | | i.)“HALLELUJA-” | | | |
| | | | j.)“REKJAVIK” | | | |
| | | | k.)“LJUBLJANA” | | | |
| 79 | J | J, JJ | (else) | J | | NOT NEW |
| 81 | K | | [“KN-” AND NOT: | (silent) | | NOT NEW |
| | | | IN RULE GROUP 80] | | | |
| 82 | K | | a.)“-KNOW-” | (silent) | | ‘K’ has not been |
| | | | b.)“-KNIT-” | | | pronounced since |
| | | | c.)[“-KNOT” c.1)AND NOT: | | | about 1400AD |
| | | | “BANKNOTE”] | | | NEW, SINCE DM |
| | | | d.)“-KNOB-” | | | RULE DOES NOT |
| | | | e.)“-KNOCK-” | | | COVER NON- |
| | | | f.)“-KNUCK-” | | | INITIAL |
| | | | g.)“-KNIFE-” | | | OCCURANCES |
| | | | h.)“-KNACK-” | | | |
| | | | i.)“-KNIGHT-” | | | |
| 83 | K | KK | “-KK-” | K | | NOT NEW |
| 84 | K | | (else) | K | | NOT NEW, |
| | | | | | | EXCEPT FOR NEW |
| | | | | | | EXCEPTIONS, |
| | | | | | | ABOVE |
| 89 | L | | a.)[“-COLN-” | (silent) | L | Dropped |
| | | | b.)“-CALM-” | | | presumably |
| | | | c.)[“-BALM | | | because of |
| | | | d.)“-MALM-” | | | difficulty |
| | | | e.)“-PALM-” | | | pronouncing ‘L’ in |
| | | | f.)“-HOLM” | | | consonant group |
| | | | g.)“-HALM” | | | NOT NEW, |
| | | | h.)“-COLM” | | | EXCEPT FOR c.1), |
| | | | i.)“-PSALM-” | | | e.1), s.1), u.1), |
| | | | j.)“-QUALM-” | | | w.1), x.1), cc.1), |
| | | | k.)“-SALMON-” | | | dd.1), hh.1) |
| | | | l.)“-HOLMES-” | | | |
| | | | m.)“-ALMOND-” | | | |
| | | | n.)“ALMS-” | | | |
| | | | o.)“-WALK-” | | | |
| | | | p.)“-YOLK-” | | | |
| | | | q.)“-FOLK-” | | | |
| | | | r.)“-HALF-” | | | |
| | | | s.)[“-TALK-” | | | |
| | | | t.)“-CALF-” | | | |
| | | | u.)[“-BALK-” | | | |
| | | | v.)“-CALK-” | | | |
| | | | w.)[“-POLK-” | | | |
| | | | x.)[“-HALV-” | | | |
| | | | y.)“-CAULK-” | | | |
| | | | z.)“-CHALK-” | | | |
| | | | aa.)“-BAULK-” | | | |
| | | | bb.)“-FAULK-” | | | |
| | | | cc.)[“-SALVE-” | | | |
| | | | dd.)[“-CALVE-” | | | |
| | | | ee.)“-SOLDER-” | | | |
| | | | ff.)“-WOULD-” | | | |
| | | | gg.)“-COULD-” | | | |
| | | | hh.)[“-SHOULD | | | |
| 91 | L | LL | a.)“-ILLO” | L | (silent) | too many english |
| | | | b.)“-ILLA” | | | words, like |
| | | | c.)“-ALLE” | | | ballerina and |
| | | | d.)“-LLAS” | | | gorilla, and also |
| | | | e.)“-LLOS” | | | american |
| | | | f.)“-LLA” | | | pronounciations of |
| | | | g.)“-LLO” | | | e.g. cabrillo where |
| | | | h.)“-ALLE-” | | | LL is pronounced |
| | | | | | | L; however, |
| | | | | | | metaph2 is |
| | | | | | | included with LL as |
| | | | | | | Y therefore “silent” |
| | | | | | | NOT NEW |
| 92 | L | | (else) | L | | NOT NEW |
| 95 | M | MM | “-MM-” | M | | ?? DOES DM |
| | | | | | | MISTAKENLY |
| | | | | | | ENCODE TO ‘MM” |
| 96 | M | | (else) | M | | NOT NEW |
| 99 | NN | | “-NN-” | N | | NOT NEW |
| 100 | N | | (else IF NOT “MONSIEUR”) | N | | NOT NEW |
| 101 | Ñ | | “-Ñ-” | N | | Spanish letter, |
| | | | | | | pronounced ‘NY’ |
| | | | | | | NOT NEW |
| 102 | P | | b.)“PN-” | (silent) | | initial ‘P’ sound not |
| | | | c.)“PS-” | | | carried over from |
| | | | | | | greek and german |
| | | | | | | NOT NEW EXCEPT |
| | | | | | | FOR a.) AND d.) |
| 106 | P | PH | [“-PH-”] | F | | Usually used in |
| | | | | | | words |
| | | | | | | transliterated from |
| | | | | | | greek |
| | | | | | | NOT NEW EXCEPT |
| | | | | | | 106.a) |
| 109 | P | | a.)“-PSYCH-” | (silent) | | pronounciation not |
| | | | b.)“-PSALM-” | | | carried over from |
| | | | c.)“-PNEUM-” | | | greek |
| | | | | | | NOT NEW |
| 110 | P | PB | a.)“-PB-” | P | | NOT NEW |
| | | PP | b.)“-PP-” | | | |
| 111 | P | | (else) | P | | NOT NEW, |
| | | | | | | EXCEPT FOR NEW |
| | | | | | | EXCEPTIONS, |
| | | | | | | ABOVE |
| 112 | Q | QQ | “-QQ-” | K | | NOT NEW |
| 113 | Q | | (else) | K | | NOT NEW |
| 114 | R | | a.)“-METIER” | (silent) | R | commonly |
| | | | b.)“-CARTIER” | | | pronounced as in |
| | | | c.)“-DOSSIER” | | | french; some |
| | | | d.)“-FOURIER” | | | others |
| | | | e.)“-OLIVIER” | | | NOT NEW, |
| | | | f.)“-CROUPIER” | | | EXCEPT k.) |
| | | | g.)“-CHEVALIER” | | | THROUGH m.) |
| | | | h.)“-LAVOISIER” | | | |
| | | | i.)“-PELLETIER” | | | |
| | | | j.)“-SOMMELIER” | | | |
| 115 | R | RR | “-RR-” | R | | NOT NEW |
| 116 | R | | (else) | R | | NOT NEW, |
| | | | | | | EXCEPT FOR NEW |
| | | | | | | EXCEPTIONS, |
| | | | | | | ABOVE |
| 117 | S | | i.)“-FRANCAIS” | (silent) | S | commonly |
| | | | m.)“-OIS” | | | pronounced as in |
| | | | | | | french. Include S |
| | | | | | | to cover |
| | | | | | | mispronounciations. |
| | | | | | | NEW, EXCEPT I.), |
| | | | | | | m.) |
| 122 | S | | “-SUGAR-” | X | | exception |
| | | | | | | NOT NEW |
| 123 | S | | c.)“-SHEIM-” | S | | combining forms - |
| | | | d.)“-SHOEK-” | | | H belongs to |
| | | | e.)“-SHOLM-” | | | another word |
| | | | f.)“-SHOLZ-” | | | NEW, EXCEPT c.), |
| | | | | | | d.), e.), f.) |
| 124 | S | SH | [“-SH-” AND NOT: | X | | NOT NEW, |
| | | | IN RULE GROUP 123] | | | EXCEPT FOR NEW |
| | | | | | | ITEMS IN RULE |
| | | | | | | GROUP 123 |
| 126 | S | SCH | a.)“-SCHER” | X | | german |
| | | | b.)“-SCHEN” | | | NEW, EXCEPT a.), |
| | | | | | | b.) |
| 127 | S | SCH | a.)[“-SCHOO-” | SK | X | dutch, |
| | | | d.)“-SCHUY-” | | | scandanavian, or |
| | | | e.)“-SCHED-” | | | greek |
| | | | f.)“-SCHEM-” | | | NEW, EXCEPT a.), |
| | | | AND NOT: | | | d.), e.), f.) |
| | | | IN RULE GROUP 125 | | | |
| | | | OR IN RULE GROUP 126] | | | |
| 128 | S | SCH | [“-SCH-” AND NOT: | X | | |
| | | | IN RULE GROUP 125 | | | |
| | | | OR IN RULE GROUP 126 | | | |
| | | | OR IN RULE GROUP 127] | | | |
| 133 | S | | a.)[“-SUO-” | X | S | e.g., “consensual” |
| | | | b.)“-SUA-” | | | NOT NEW, |
| | | | | | | EXCEPT a.1), b.1) |
| 134 | S | SS | “-CISSIO-” | J | S | e.g., “abscission” |
| | | | | | | NOT NEW |
| 135 | S | SS | [“-<vowel>SSIO-” AND NOT: | X | S | e.g., “passion” |
| | | | IN RULE GROUP 134] | | | NOT NEW |
| 136 | S | SS | c.)“-ISSUR-” | X | S | e.g., “Russia”, |
| | | | d.)“-ISSUE-” | | | “pressure” |
| | | | h.)“-ISSUAB-” | | | NOT NEW, |
| | | | i.)“-ISSUAN-” | | | EXCEPT FOR a.), |
| | | | | | | b.), e.) f.), g.) |
| | | | | | | a) in kucera |
| 139 | S | | a.)[“-<vowel>SIA” | J | S | e.g., “asia”, |
| | | | b.)“-<vowel>SIAN” | | | “Persia” |
| | | | AND NOT: | | | a.), b.) NOT NEW, |
| | | | IN RULE GROUP 137 | | | c.), d.) NEW |
| | | | OR IN RULE GROUP 138] | | | |
| 141 | S | | a.)“-<vowel>SION-” | J | S | NEW, EXCEPT FOR |
| | | | | | | a.) |
| | | | | | | kucera maps to |
| | | | | | | ‘sh’ |
| 142.a | S | | a.)“SM-” | S | X | NOT NEW |
| | | | b.)“SN-” | | | |
| | | | c.)“SW-” | | | |
| | | | d.)“SL-” | | | |
| | | | e.)“-SZ-” | | | |
| 145 | S | SC | a.)[“-SCE-” | S | | NOT NEW, |
| | | | b.)“-SCI-” a.1), b.1)AND NOT: | | | EXCEPT FOR a.1), |
| | | | IN RULE GROUP 143] | | | b.1) |
| | | | OR IN RULE GROUP 144] | | | |
| | | | c.)“-SCY-” | | | |
| 146 | S | SC | [“-SC-” AND NOT: | SK | | NEW EXCEPT FOR |
| | | | a.)IN RULE GROUP 143] | | | c.) |
| | | | b.)OR IN RULE GROUP 144] | | | |
| 149 | S | SS | a.)[“-SS-” AND NOT: | S | | NOT NEW |
| | | SZ | IN RULE GROUP 134] | | | |
| | | | OR IN RULE GROUP 135] | | | |
| | | | OR IN RULE GROUP 136] | | | |
| | | | b.)“-SZ-” | | | |
| 150 | S | | (else) | S | | NOT NEW, |
| | | | | | | EXCEPT FOR NEW |
| | | | | | | EXCEPTIONS, |
| | | | | | | ABOVE |
| 152 | T | TH | i.)“-THOMAS-” | T | O | mostly greek and |
| | | | j.)“-THOMPS-” | | | French words |
| | | | k.)“-THOMSO-” | | | where ‘TH’ |
| | | | l.)“-THOMSE-” | | | pronounced as ‘T’ |
| | | | m.)“-THAMES-” | | | NEW, EXCEPT FOR |
| | | | | | | i.) THROUGH m.) |
| 153 | T | | c.)“-THOOD-” | T | | combining forms - |
| | | | d.)“-THEAD-” | | | H belongs to |
| | | | e.)“-THEID-” | | | second word in |
| | | | | | | compound |
| | | | | | | NEW, EXCEPT c.) |
| | | | | | | THROUGH e.) |
| 156 | T | TH | [“-TH-” a.)AND NOT: | 0 | | NOT NEW, |
| | | | IN RULE GROUPS 152-155] | | | EXCEPT FOR NEW |
| | | | | | | RULES UNDER a.) |
| 157 | T | TCH | “-TCH-” | X | | NOT NEW |
| 159 | T | | a.)“-FORTUN-” | X | T | NEW, EXCEPT c.), |
| | | | b.)“-<vowel>TUL<vowel>-” | | | e.), r.) THROUGH |
| | | | c.)“-BITUA-” | | | w.) |
| | | | d.)“-BITUE-” | | | NEW: |
| | | | e.)“-<letter>TUA-” | | | g.), h.), |
| | | | f.)“-<letter>TUO-” | | | i.), i.), o.), p.), q.) |
| | | | k.)“-NTULE-” | | | however, more |
| | | | l.)“-NTULA-” | | | specific than |
| | | | m.)“-STULE-” | | | kucera: |
| | | | n.)“-STULA-” | | | <><>tun<v> |
| | | | r.)“-<letter>TURE-” | | | <><>tur<v> |
| | | | s.)“-<letter>TURA<letter>-” | | | <><>tul<v> |
| | | | t.)“-VENTURA” | | | <>tua<> |
| | | | u.)“-<letter>TURI-” | | | <>tuo<> |
| | | | v.)“-<letter>TURY-” | | | <>tue<> |
| | | | w.)“-<letter>TURO<letter>-” | | | <>tia<> |
| | | | x.)“-<letter>TIUS-” | | | <>tio<> |
| | | | | | | <>tiu<> |
| 161 | T | | “-EQUATION-” | J | | NOT NEW - kucera |
| 163 | T | | a.){[“-TIO-” a.1)AND NOT: | X | T | NOT NEW, |
| | | | IN RULE 162.m | | | EXCEPT a.1), c.), |
| | | | OE IN RULE 162.n | | | d.), e.1), f.1), |
| | | | OR IN RULE GROUP 161] | | | l.1), m.) |
| | | | b.)“-TIAL-” | | | c.), d.) in kucera |
| | | | c.)“-RTIUM-” | | | |
| | | | d.)“-ATIUM-” | | | |
| | | | e.)[“-TIAN-” e.1)AND NOT: | | | |
| | | | IN RULES 162.a-162.e] | | | |
| | | | f.)[“-TIA” f.1)AND NOT: | | | |
| | | | IN RULES 162.f-162.i] | | | |
| | | | g.)“-TIATE-” | | | |
| | | | h.)“-TIATI-” | | | |
| | | | i.)“-TIABL-” | | | |
| | | | j.)“-TIATO-” | | | |
| | | | k.)“-TIARY-” | | | |
| | | | l.)“-CHRISTIAN-” l.1)AND NOT: | | | |
| | | | IN RULES 162.j-162.l} | | | |
| | | | m.)“-TIENT-” | | | |
| 165 | T | TTH | “-MATTH-” | 0 | | NOT NEW |
| 168 | T | TT | “-TT-” | T | | NOT NEW, |
| | | TD | “-TD-” | | | EXCEPT FOR NEW |
| | | | | | | EXCEPTIONS |
| | | | | | | ABOVE |
| 169 | T | | (else) | T | | NOT NEW, |
| | | | | | | EXCEPT FOR NEW |
| | | | | | | EXCEPTIONS |
| | | | | | | ABOVE |
| 170 | V | VV | “-VV-” | F | | NOT NEW |
| 171 | V | | (else) | F | | NOT NEW |
| 172 | W | | a.)“-WR-” | (silent) | | b.) and c.) treat as |
| | | | b.)“-<vowel>W-” | | | vowel |
| | | | c.)“-<letter>W<vowel>-” | | | NOT NEW |
| 173 | W | | “W<vowel>-” | A | F | treat as an initial |
| | | | | | | vowel |
| | | | | | | NOT NEW |
| 174 | W | WH | a.)“-WHOOSH-” | A | | treat as vowel |
| | | | b.)“-WHOOP-” | OR | | NOT NEW EXCEPT |
| | | | c.)“-WHOMP-” | (silent) | | h.1) |
| | | | d.)“-WHORL-” | | | |
| | | | e.)“-WHORT-” | | | |
| | | | f.)“-WHOA-” | | | |
| | | | g.)“-WHOP-” | | | |
| | | | h.)[“WH-” h.1)AND NOT IN RULE | | | |
| | | | GROUP 175] | | | |
| 175.a | W | | a.)“-EWSKI-” | (treat | F | match germanic |
| | | | b.)“-EWSKY-” | as | | words |
| | | | c.)“-OWSKI-” | non- | | NOT NEW |
| | | | d.)“-OWSKY-” | initial | | |
| | | | e.)“-<vowel>W” | vowel | | |
| | | | f.)“SCH-W-” | and | | |
| | | | | don't | | |
| | | | | encode) | | |
| 175.b | W | WICZ, | a.)“-WICZ-” | TS | FX | code to match |
| | | WITZ | b.)“-WITZ-” | | | english and polish |
| | | | | | | NOT NEW |
| 176 | X | | a.)“-XYLO-” | S | | greek root - |
| | | | b.)“-XYLE-” | | | represents ‘KS’ |
| | | | c.)“-XENO-” | | | sound in greek but |
| | | | d.)“-XANTH-” | | | ‘K’ dropped in |
| | | | | | | English |
| | | | | | | NOT NEW, |
| | | | | | | EXCEPT INCLUDES |
| | | | | | | NON INITIAL, AND |
| | | | | | | EXCLUDES OTHER |
| | | | | | | CONTEXTS |
| 180 | X | | a.)“-IAUX” | (silent) | | pronounced as in |
| | | | b.)“-EAUX” | | | french |
| | | | c.)“-IEUX” | | | NOT NEW EXCEPT |
| | | | d.)“-AIX” | | | FOR g.) and h.) |
| | | | e.)“-AUX” | | | |
| | | | f.)“-OUX” | | | |
| 182 | X | | (else) | KS | | NOT NEW, |
| | | | | | | EXCEPT FOR NEW |
| | | | | | | EXCEPTIONS, |
| | | | | | | ABOVE |
| 185 | Z | ZZ | b.)“-ZZI” | TS | S | Italian |
| | | | e.)“-PIZZICATO-” | | | NEW EXCEPT b.), |
| | | | | | | e.) |
| 188 | Z | ZH | “-ZH-” | J | | NOT NEW |
| 189 | Z | ZZ | [“-ZZ-” AND NOT: | S | | NOT NEW, |
| | | | IN RULE GROUP 185] | | | EXCEPT FOR NEW |
| | | | | | | EXCEPTIONS, |
| | | | | | | ABOVE |
| 190 | Z | | (else) | S | | NOT NEW, |
| | | | | | | EXCEPT FOR NEW |
| | | | | | | EXCEPTIONS, |
| | | | | | | ABOVE |

TABLE 4
M3 correspondence to Double Metaphone

| M3 Rule | | | DOUBLE METAPHONE: | | | |
|---|---|---|---|---|---|---|
| Group | Letter | Digraph | Rule | Encoding | Alternate | Remarks |
| 0 | A, E, I | | ALL INITIAL VOWELS | A | | DM0 |
| | O, U, | | IN DM ARE MAPPED TO | | | |
| | W, Y | | ‘A’; OTHERWISE, | | | |
| | | | VOWELS NOT ENCODED | | | |
| 00 | E or UE | | N/A | | | |
| 000 | E | LE | | | | |
| 1 | B | | a.)“-UMB” | (silent) | | DM1 |
| | | | b.)“-UMBER” | | | “dumb” and |
| | | | c.)“-<vowel>MB” | | | “dumber”, “limb” |
| | | | | | | but not “limber” |
| 2 | B | BB | | | | |
| | | BP | | | | |
| 3 | B | | (else) | P | | DM2 |
| 4 | C | | | | | |
| 5 | C | | “CAESAR-” | S | | DM5 |
| | | | | | | special case |
| 6 | C | CC | a.)“ACC-” | KS | | DM15 |
| | | | b.)“-UCCES-” | | | |
| | | | c.)“-UCCEE-” | | | |
| 7 | C | CC | [“-CC-” AND NOT: | K | | DM17 |
| | | | IN RULE GROUPS DM15 | | | |
| | | | OR DM16] | | | |
| 8 | C | CC | “CIA-” | X | | DM14 |
| | | | [a.)“-CCI-” | | | “focaccia” |
| | | | b.)“-CCE-” | X | | DM16 |
| | | | c.)[“-CCH-” AND | | | |
| | | | NOT: “-CCHU-”] | | | |
| | | | AND NOT: IN RULE | | | |
| | | | GROUP DM15 | | | |
| | | | AND NOT: “MCC-”] | | | |
| 9 | C | CH | a.)[“- | K | | DM4 |
| | | | <consonant>ACH-” | | | various Germanic |
| | | | AND NOT: | | | |
| | | | “-ACHI-” | | | |
| | | | “-ACHE-”] | | | |
| | | | b.)“-BACHER-” | | | |
| | | | c.)“-MACHER-” | | | |
| | | | “-CHAE-” | K | X | DM7 |
| | | | | | | “Michael” |
| | C | CH | “-CHIA-” | K | | DM6 |
| | | | a.)“-CHARAC-” | | | Italian |
| | | | b.)“-CHARIS-” | K | X | DM9 |
| | | | c.)[“-CHOR-” AND | | | Greek roots |
| | | | NOT: | | | |
| | | | “-CHORE-”] | | | |
| | | | d.)“-CHYM-” | | | |
| | | | e.)“-CHIA-” | | | |
| | | | f.)“-CHEM-” | | | |
| | | | g.)“-CHLO-” | | | |
| | | | h.)(IF IN A WORD | | | |
| | | | STARTING WITH “VAN” | | | |
| | | | OR “VON”) | | | |
| | | | i.)“SCH-” | | | |
| | | | j.)“-ORCHES-” | | | |
| | | | k.)“-ARCHIT-” | | | |
| | | | l.)“-ORCHID-” | | | |
| | | | m.)“-CHT-” | | | |
| | | | n.)“-CHS-” | | | |
| | | | m.)<“A” OR “O” OR | | | |
| | | | “U” OR “E”>“CH”<“L” | | | |
| | | | OR “R” OR “N” OR | | | |
| | | | “M” OR “B” OR “H” | | | |
| | | | OR “F” OR “V” OR | | | |
| | | | “W” OR “ ”> | | | |
| | C | CH | | | | |
| | C | CH | “MCH-” | K | | DM10 |
| | | | | | | “McHugh” |
| 10 | C | CH | | | | |
| 11 | C | CH | | | | |
| 12 | C | CH | a.)“-OACH-” | X | | DM8 |
| | | | b.)“-EACH-” | | | |
| | | | c.)“-EECH-” | | | |
| | | | “-CH-” | X | K | DM11 |
| | | | “CH-” | X | | DM12 |
| 13 | C | CK | a.)“-CK-” | K | | DM18 |
| | | CG | b.)“-CG-” | | | |
| | | CQ | c.)“-CQ-” | | | |
| 14 | C | | a.)“-<vowel>CIA-” | X | | DM19 |
| | | | b.)“-<vowel>CIO-” | | | |
| | | | c.)“-<vowel>CIE-” | | | |
| | | | d.)“-CEOUS-” | | | |
| 15 | C | | a.)[“-CI-” AND NOT: | S | | DM20 |
| | | | IN RULE GROUP | | | |
| | | | DM19a-c] | | | |
| | | | b.)“-CY-” | | | |
| | | | c.)[“-CE-” AND NOT: | | | |
| | | | IN RULE GROUP | | | |
| | | | DM19d] | | | |
| 16 | C | | | | | |
| 17 | C | C | | | | |
| 17.a | C | CZ | “-CZ-” AND NOT: “- | S | X | DM13 |
| | | | WICZ-” | | | e.g. ‘czerny’ |
| 18 | C | CK | | | | |
| | | CQ | | | | |
| 19 | C | | (else) | K | | DM20.a |
| 20 | C | | | S | | DM3 |
| 21 | D | DG | [“-DG-” AND NOT IN | TK | | DM22 |
| | | | DM21] | | | |
| 22 | D | DG | a.)“-DG<“I” OR “E” | J | | DM21 |
| | | | OR “Y”>-” | | | “edge” |
| | | | b.)“-DG” | | | |
| 23 | D | DJ | | | | |
| 24 | D | DT | | | | |
| 25 | D | DT | (else) D, DT, DD | T | | DM23 |
| | | DD | | | | |
| 26 | D | | | | | |
| 27 | D | | | | | |
| 28 | D | | (else) D, DT, DD | T | | DM23 |
| 29 | F | FF | | F | | DM24 |
| 30 | F | | | F | | DM25 |
| 31 | G | (treated as | | N | | DM32 |
| | | dipthong “GN”) | | | | “align”, “impugn” |
| | | a.)“-<vowel>GN” | | | | |
| | | b.)“GN-” | | | | |
| 32 | G | GG | | | | |
| 33 | G | GG | | | | |
| 34 | G | GG | | | | |
| 35 | G | GH | a.)“-<consonant>GH-” | K | | DM26 |
| | | | b.)[“GH-” AND NOT: | | | |
| | | | “GHI-”] | | | |
| 36 | G | GH | “GHI-” | J | | DM27 |
| 37 | G | GH | a.)“-<consonant>GH-” | K | | DM26 |
| | | | b.)[“GH-” AND NOT: | | | |
| | | | “GHI-”] | | | |
| 38 | G | GH | <“C” OR “G” OR “L” | F | | DM29 |
| | | | OR “R” OR | | | “laugh”, “rough” |
| | | | “T”><vowel>UGH-” | | | |
| 39 | G | GH | | | | |
| 40 | G | GH | | | | |
| 41 | G | GH | a.)“-<“B” OR “H” OR | (silent) | | DM28 |
| | | | “D”><vowel>GH-” | | | “Hugh” |
| | | | b.)“-<“B” OR “H” OR | | | “bough”, “dough” |
| | | | “D”><vowel><vowel>GH-” | | | “broughton” |
| | | | c.)“-<“B” OR | | | |
| | | | “H”><letter><vowel> | | | |
| | | | <vowel>GH-” | | | |
| | | | d.)“-IGH-” | | | |
| 42 | G | GH | | | | |
| 43 | G | GH | | | | |
| 44 | G | GH | <“C” OR “G” OR “L” | F | | DM29 |
| | | | OR “R” OR | | | “laugh”, “rough” |
| | | | “T”><vowel>UGH-” | | | |
| 45 | G | GH | (else) | K | | DM30 |
| 46 | G | G | | | | |
| 47 | G | G | | | | |
| 48 | G | [“<vowel>GN-” AND | | K | N | DM31 |
| | | NOT: “W” OR “K” OR | | K | | “agnelli” |
| | | “CZ” OR “WITZ” IN | | | | DM33 |
| | | WORD] | | | | |
| | | (else dipthong | | | | |
| | | “GN”) | | | | |
| 49 | G | (treated as | | (silent) | | DM32 |
| | | dipthong “GN”) | | | | “align”, “impugn” |
| | | a.)“-<vowel>GN” | | | | |
| | | b.)“GN-” | | | | |
| 50 | G | (treated as | | (silent) | | DM32 |
| | | dipthong “GN”) | | | | “align”, “impugn” |
| | | a.)“-<vowel>GN” | | | | |
| | | b.)“GN-” | | | | |
| 51 | G | | | | | |
| 52 | G | (treated as | | KL | L | DM34 |
| | | dipthong “GL”) | | | | “tagliaro” |
| | | “-GLI-” AND NOT: | | | | |
| | | “W” OR “K” OR “CZ” | | | | |
| | | OR “WITZ” IN WORD] | | | | |
| 53 | G | a.)[“-GY-” AND | | K | J | DM35 |
| | | NOT:“-IGY-”, “-OGY-”, | | | | |
| | | “-RGY-”,“-OGY-”] | | | | |
| | | b.)“G<“ES” OR “EP” | | | | |
| | | OR “EB” OR “EL” OR | | | | |
| | | “EY” OR “IB” OR | | | | |
| | | “IL” OR “IN” OR | | | | |
| | | “IE” OR “EI” OR | | | | |
| | | “ER”>-” | | | | |
| | | c.)[“-GER-” AND | | | | |
| | | NOT:“-DANGER-”, “- | | | | |
| | | MANGER-”,“-RANGER-”, | | | | |
| | | “-EG-”,“-IG-”] | | | | |
| 54 | G | “-G<“E” OR “I” OR | | J | K | DM38 |
| | | “Y”>-” AND NOT: IN | | | | |
| | | DM35 OR DM36 OR | | | | |
| | | DM37 | | | | |
| 55 | G | | | | | |
| 56 | G | “-G<“E” OR “I” OR | | J | K | DM38 |
| | | “Y”>-” AND NOT: IN | | | | |
| | | DM35 OR DM36 OR | | | | |
| | | DM37 | | | | |
| 57 | G | a.)“-GET-” | | K | | DM36 |
| | | b.)<“SCH-” OR “VAN-” | | | | |
| | | OR “VON-”>G<“E” | | | | |
| | | OR “I” OR “Y”>-” | | | | |
| 58 | G | “-G<“E” OR “I” OR | | J | K | DM38 |
| | | “Y”>-” AND NOT: IN | | | | |
| | | DM35 OR DM36 OR | | | | |
| | | DM37 | | | | |
| 59 | G | | | | | |
| 60 | G | | | | | |
| 61 | G | | | | | |
| 62 | G | | | | | |
| 63 | G | | | | | |
| 64 | G | a.)[“-GY-” AND | | K | J | DM35 |
| | | NOT:“-IGY-”, “-OGY-”, | | | | |
| | | “-RGY-”,“-OGY-”] | | | | |
| | | b.)“G<“ES” OR “EP” | | | | |
| | | OR “EB” OR “EL” OR | | | | |
| | | “EY” OR “IB” OR | | | | |
| | | “IL” OR “IN” OR | | | | |
| | | “IE” OR “EI” OR | | | | |
| | | “ER”>-” | | | | |
| | | c.)[“-GER-” AND | | | | |
| | | NOT:“-DANGER-”, “- | | | | |
| | | MANGER-”,“-RANGER-”, | | | | |
| | | “-EG-”,“-IG-”] | | | | |
| 64 | G | | | | | |
| 65 | G | “-GIER” | | J | | DM37 |
| | | | | | | “rogier” |
| 66 | G | | | | | |
| 67 | G | (else) | | K | | DM39 |
| 68 | H | | | | | |
| 69 | H | HS | | | | |
| 70 | H | | | | | |
| 71 | H | (else) | | (silent) | | DM41 |
| 72 | H | a.)“H<vowel>-” | | H | | DM40 |
| | | b.)“- | | | | |
| | | <vowel>H<vowel>-” | | | | |
| 73 | H | (else) | | (silent) | | DM41 |
| 74 | J | | a.)“JOSE” | H | | DM42 |
| | | | b.)“SAN-J-” | | | spanish |
| 75 | J | “J-” AND NOT: | | J | A | DM44 |
| | | “JOSE-” | | | | “jankelowicz/yankelowitz” |
| 76 | J | a.)“-JOSE-” | | J | H | DM43 |
| | | b.)[“-<vowel>J<“A” | | | | |
| | | OR “O”>-” AND | | | | |
| | | NOT: “W” OR “K” OR | | | | |
| | | “CZ” OR “WITZ” IN | | | | |
| | | WORD] | | | | |
| 77 | J | | | | | |
| 78 | J | a.)“-J<“L” OR “T” | | (silent) | | DM45 |
| | | OR “K” OR “S” OR | | | | |
| | | “N” OR “M” OR “B” | | | | |
| | | OR “Z”>-” | | | | |
| | | b.)“-<“S” OR “K” OR | | | | |
| | | “L”>J-” | | | | |
| 79 | J | J, JJ | (else) | J | | DM46 |
| 80 | K | | | | | |
| 81 | K | “KN-” | | (silent) | | DM47 |
| 82 | K | | | | | |
| 83 | K | KK | (else) | K | | DM47.a |
| 84 | K | | (else) | K | | DM47.a |
| 85 | L | | | | | |
| 86 | L | | | | | |
| 87 | L | | | | | |
| 88 | L | | | | | |
| 89 | L | “-LN” | | (silent) | | DM48 |
| | | | | | | “lincoln” |
| 90 | L | LL | | | | |
| 91 | L | LL | a.)“-ALLE” | L | (treat | DM49 |
| | | | b.)“-ILLO” | | as | “gallegos” |
| | | | c.)“-ILLA” | | internal | |
| | | | d.)“-ALLE-<“AS” OR | | vowel | |
| | | | “OS” OR “A” OR | | and | |
| | | | “O”>” | | the | |
| | | | | | refore | |
| | | | | | don't | |
| | | | | | encode) | |
| 92 | L | (else) | | L | | DM50 |
| 93 | M | | | | | |
| 94 | M | MP | | | | |
| 95 | M | MM | | M | | DM51 |
| 96 | M | | | M | | DM51 |
| 97 | N | | | | | |
| 98 | N | NC | a.)“-NCE” | NT | | DM52 |
| | | | b.)“-NCY” | | | “accountance’ == “accountants” |
| 99 | NN | (else) | | N | | DM53 |
| 100 | N | (else) | | N | | DM53 |
| 101 | Ñ | | | N | | DM54 |
| 102 | P | a.)“-PSYCH-” | | (silent) | | DM56 |
| | | b.)“PN-” | | | | “psalm”, “raspberry” |
| | | c.)“PS-” | | | | |
| | | d.)“-PB-” | | | | |
| 103 | P | PT | | | | |
| 104 | P | PHTH | | | | |
| 105 | P | PH | | | | |
| 106 | P | PH | “-PH-” | F | | DM55 |
| 107 | P | PS | | | | |
| 108 | P | | | | | |
| 109 | P | a.)“-PSYCH-” | | (silent) | | DM56 |
| | | b.)“PN-” | | | | “psalm”, “raspberry” |
| | | c.)“PS-” | | | | |
| | | d.)“-PB-” | | | | |
| 110 | P | PB | (else - “-PP-” | P | | DM57 |
| | | PP | ONLY!) | | | |
| 111 | P | | (else) | P | | DM57 |
| 112 | Q | QQ | “-QQ-” | K | | DM58 |
| 113 | Q | | (else) | K | | DM58 |
| 114 | R | | [“-IER” AND NOT: “- | (silent) | | DM59 |
| | | | MEIER” OR “-MAIER” | | | |
| | | | OR [“W” OR “K” OR | | | |
| | | | “CZ” OR “WITZ” IN | | | |
| | | | WORD]] | | | |
| 115 | R | RR | “-RR-” | R | | DM60 |
| 116 | R | (else) | | R | | DM60 |
| 117 | S | | a.)“-ISL-” | (silent) | | DM61 |
| | | | b.)“-YSL-” | | | |
| | | | c.)“-AIS” | | | |
| | | | d.)“-OIS” | | | |
| 118 | S | a.)“-ISL-” | | (silent) | | DM61 |
| | | b.)“-YSL-” | | | | |
| | | c.)“-AIS” | | | | |
| | | d.)“-OIS” | | | | |
| 119 | S | ST | | | | |
| 120 | S | SC | | | | |
| 121 | S | STH | | | | |
| 122 | S | a.)“SUGAR-” | | X | S | DM62 |
| | | [b.)“SCH<consonant>-” | | | | special case for |
| | | AND NOT: “SCHW-”] | | | | “sugar” |
| 123 | S | | | | | |
| 124 | S | SH | [a.)“-SH-” AND NOT: | X | | DM63 |
| | | | “-SHEIM-” OR “- | | | “issue” |
| | | | SHOEK-” OR “-SHOLM-” | | | |
| | | | OR “-SHOLZ-”] | | | |
| | | | b.)“-ISSU-” | | | |
| | | | c.)“-SUA-” | | | |
| | | | d.)“-SUO-” | | | |
| | | | [e.)“-<vowel>SSIO-” | | | |
| | | | AND NOT: “-CISSIO-”] | | | |
| | | | f.)“-<consonant> | | | |
| | | | SI<“A” | | | |
| | | | OR “O”>-” | | | |
| 125 | S | | | | | |
| 126 | S | SCH | | | | |
| 127 | S | SCH | a.)“-SCHER-” | X | SK | DM66 |
| | | | b.)“-SCHEN-” | SK | | DM67 |
| | | | a.)“-SCHOO-” | | | |
| | | | b.)“-SCHUY-” | | | |
| | | | c.)“-SCHED-” | | | |
| | | | d.)“-SCHEM-” | | | |
| 128 | S | SCH | [“-SCH-” AND NOT IN | X | | DM68 |
| | | | DM62, DM66, DM67] | | | |
| 129 | S | | | | | |
| 130 | S | | | | | |
| 131 | S | | | | | |
| 132 | S | | | | | |
| 133 | S | | | | | |
| 134 | S | SS | a.)“-CISSIO-” | J | | DM64 |
| | | | b.)“-<vowel>SI<“A” | | | |
| | | | OR “O”>-” | | | |
| 135 | S | SS | [a.)“-SH-” AND NOT: | X | | DM63 |
| | | | “-SHEIM-” OR “- | | | “issue” |
| | | | SHOEK-” OR “-SHOLM-” | | | |
| | | | OR “-SHOLZ-”] | | | |
| | | | b.)“-ISSU-” | | | |
| | | | c.)“-SUA-” | | | |
| | | | d.)“-SUO-” | | | |
| | | | [e.)“-<vowel>SSIO-” | | | |
| | | | AND NOT: “-CISSIO-”] | | | |
| | | | f.)“- | | | |
| | | | <consonant>SI<“A” | | | |
| | | | OR “O”>-” | | | |
| 136 | S | SS | [a.)“-SH-” AND NOT: | X | | DM63 |
| | | | “-SHEIM-” OR “- | | | “issue” |
| | | | SHOEK-” OR “-SHOLM-” | | | |
| | | | OR “-SHOLZ-”] | | | |
| | | | b.)“-ISSU-” | | | |
| | | | c.)“-SUA-” | | | |
| | | | d.)“-SUO-” | | | |
| | | | [e.)“-<vowel>SSIO-” | | | |
| | | | AND NOT: “-CISSIO-”] | | | |
| | | | f.)“- | | | |
| | | | <consonant>SI<“A” | | | |
| | | | OR “O”>-” | | | |
| 137 | S | | | | | |
| 138 | S | | | | | |
| 139 | S | a.)“-CISSIO-” | | J | | DM64 |
| | | b.)“-<vowel>SI<“A” | | | | |
| | | OR “O”>-” | | | | |
| 140 | S | | | | | |
| 141 | S | | | | | |
| 142 | S | | | | | |
| 142.a | S | a.)“SM-” | | S | X | DM65 |
| | | b.)“SN-” | | | | add “sh” |
| | | c.)“SW-” | | | | pronounciation to |
| | | d.)“SL-” | | | | make germanic and |
| | | e.)“-SZ-” | | | | slavic origin names |
| | | | | | | match up with |
| | | | | | | native spellings |
| 143 | S | SC | | | | |
| 144 | S | SC | | | | |
| 145 | S | SC | a.)“-SCI-” | S | | DM69 |
| | | | b.)“-SCE-” | | | |
| | | | c.)“-SCY-” | | | |
| 146 | S | SC | “-SC-” AND NOT In | SK | | DM70 |
| | | | DM69 | | | |
| 147 | S | | | | | |
| 148 | S | | | | | |
| 149 | S | SS | | | | |
| | | SZ | | | | |
| 150 | S | (else) | | S | | DM71 |
| 151 | T | | | | | |
| 152 | T | TH | a.)“-THOOD-” | T | | DM73 |
| | | | b.)“-THEAD-” | | | ‘H’ from another |
| | | | c.)“-THEID-” | | | word, also |
| | | | d.)“-THOM-” | | | exceptions e.g. |
| | | | e.)“-THAM-” | | | “thomas” |
| | | | f.)“V<“A” OR “O”>N- | | | |
| | | | TH-” | | | |
| | | | g.)“SCH-TH-” | | | |
| 153 | T | a.)“-THOOD-” | | T | | DM73 |
| | | b.)“-THEAD-” | | | | ‘H’ from another |
| | | c.)“-THEID-” | | | | word, also |
| | | d.)“-THOM-” | | | | exceptions e.g. |
| | | e.)“-THAM-” | | | | “thomas” |
| | | f.)“V<“A” OR “O”>N- | | | | |
| | | TH-” | | | | |
| | | g.)“SCH-TH-” | | | | |
| 154 | T | TH | | | | |
| 155 | T | TH | | | | |
| 156 | T | TH | [“-TH-” OR “-TTH-” | 0 | | DM74 |
| | | | IF NOT IN DM73] | | | 0′ represents “TH” |
| | | | | | | sound |
| 157 | T | TCH | | | | |
| 158 | T | | | | | |
| 159 | T | a.)“-TUA-” AND NOT | | X | | |
| | | AT BEGINNING OR | | | | |
| | | WORD | | | | |
| | | b.)“-TUR-” AND NOT | | | | |
| | | AT BEGINNING OF | | | | |
| | | WORD | | | | |
| | | c.)“-TIO-” | | | | |
| | | d.)“-TIOUS-” | | | | |
| | | e.)“-TIA-” | | | | |
| | | f.)“-TCH-” | | | | |
| 160 | T | | | | | |
| 161 | T | | | | | |
| 162 | T | | | | | |
| 163 | T | a.)“-TUA-” AND NOT | | X | | DM72 |
| | | AT BEGINNING OR | | | | |
| | | WORD | | | | |
| | | b.)“-TUR-” AND NOT | | | | |
| | | AT BEGINNING OF | | | | |
| | | WORD | | | | |
| | | c.)“-TIO-” | | | | |
| | | d.)“-TIOUS-” | | | | |
| | | e.)“-TIA-” | | | | |
| | | f.)“-TCH-” | | | | |
| 164 | T | | | | | |
| 165 | T | TTH | | | | |
| 166 | T | TSCH | | | | |
| 167 | T | TZSCH | | | | |
| 168 | T | TT | (else) | T | | DM75 |
| | | TD | | | | |
| 169 | T | (else) | | T | | DM75 |
| 170 | V | VV | | F | | DM76 |
| 171 | V | | | F | | DM76 |
| 172 | W | | “WR-” | (silent) | | DM77 |
| | | | (treat as dipthong) | R | | DM78 |
| | | | “-WR-” | | | |
| 173 | W | “W<vowel>-” | | A | F | DM79 |
| | | | | | | match germanic |
| | | | | | | names |
| 174 | W | WH | “WH-” | A | | DM80 |
| 175 | W | WH | | | | |
| 175.a | W | a.)“-EWSKI-” | | (treat | F | DM81 |
| | | b.)“-EWSKY-” | | as non- | | match germanic |
| | | c.)“-OWSKI-” | | initial | | words |
| | | d.)“-OWSKY-” | | vowel | | |
| | | e.)“-<vowel>W” | | and | | |
| | | f.)“SCH-W-” | | don't | | |
| | | | | encode) | | |
| 175.b | W | WICZ, | a.)“-WICZ-” | TS | FX | DM82 |
| | | WITZ | b.)“-WITZ-” | | | code to match |
| | | | | | | english and polish |
| 176 | X | | “X-” | S | | DM83 |
| 177 | X | | | | | |
| 178 | X | | | | | |
| 179 | X | | | | | |
| 180 | X | a.)“-IAUX” | | (silent) | | DM84 |
| | | b.)“-EAUX” | | | | french endings |
| | | c.)“-IEUX” | | | | |
| | | d.)“-AUX” | | | | |
| | | e.)“-OUX” | | | | |
| 181 | X | XX | (else) | KS | | DM85 |
| | | XC | | | | |
| 182 | X | (else) | | KS | | DM85 |
| 183 | Z | ZS | | | | |
| 184 | Z | | | | | |
| 185 | Z | ZZ | “-ZZI” | TS | | DM86 |
| | | | | | | italian e.g. “abruzzi” |
| 186 | Z | | | | | |
| 187 | Z | | | | | |
| 188 | Z | ZH | “-ZH-” | J | | DM87 |
| | | | | | | chinese e.g. “zhao” |
| 189 | Z | ZZ | a.)“-ZZO-” | S | TS | DM88 |
| | | | b.)“-ZZI-” | | | |
| | | | c.)“-ZZA-” | | | |
| | | | d.)[“W” OR “K” OR | | | |
| | | | “CZ” OR “WITZ” IN | | | |
| | | | WORD AND NOT “-ZT-”] | | | |

| | | | | |
|---|---|---|---|---|
| 190 | Z | (else) | S | DM89 |

TABLE 5
M3 correspondence to original Metaphone

| M3 Rule | | | METAPHONE: | | |
|---|---|---|---|---|---|
| Group | Letter | Digraph | Rule | Encoding | Remarks |
| 0 | A, E, I | | a.)“A-” | (all initial vowels mapped AS | M0 |
| | O, U, | | b.)“E-” | IS, e.g. | |
| | W, Y | | c.)“I-” | A => A, | |
| | | | d.)“O-” | E => E, | |
| | | | e.)“U-” | I => I, etc.) | |
| | | | f.)“Y<vowel>-” | Otherwise, vowels not | |
| | | | | encoded | |
| 00 | E or UE | | | | |
| 000 | E | LE | | | |
| 1 | B | | “-MB” | (silent) | M1 |
| 2 | B | BB | | | |
| | | BP | | | |
| 3 | B | | (else) | B | M2 |
| | | | | | Original |
| | | | | | Metaphone |
| | | | | | does |
| | | | | | not map |
| | | | | | B's to ‘P’ |
| 4 | C | | | | |
| 5 | C | | | | |
| 6 | C | CC | | | |
| 7 | C | CC | | | |
| 8 | C | CC | | | |
| 9 | C | CH | | | |
| 10 | C | CH | | | |
| 11 | C | CH | | | |
| 12 | C | CH | a.)“-CIA-” | X | M3 |
| | | | b.)“-CH-” | | |
| 13 | C | CK | | | |
| | | CG | | | |
| | | CQ | | | |
| 14 | C | | a.)“-CIA-” | X | M3 |
| | | | b.)“-CH-” | | |
| 15 | C | | [a.)“-CI-” AND | S | M4 |
| | | | NOT IN M3] | | |
| | | | b.)“-CE-” | | |
| | | | c.)“-CY-” | | |
| 16 | C | | | | |
| 17 | C | C | | | |
| 17.a | C | CZ | | | |
| 18 | C | CK | (only encode one ‘K’ if | K | M17 |
| | | CQ | -“CK-”) | | |
| 19 | C | | (else) | K | M5 |
| 20 | C | | | | |
| 21 | D | DG | | | |
| 22 | D | DG | a.)“-DGI-” | J | M6 |
| | | | b.)“-DGE-” | | |
| | | | c.) “-DGY-” | | |
| 23 | D | DJ | | | |
| 24 | D | DT | | | |
| 25 | D | DT | | | |
| | | DD | | | |
| 26 | D | | | | |
| 27 | D | | | | |
| 28 | D | | (else) | T | M7 |
| | | | | | ? doesn't |
| | | | | | account |
| | | | | | for ‘DD’, |
| | | | | | ‘DT’? |
| 29 | F | FF | | | |
| 30 | F | | | F | M8 |
| 31 | G | | | | |
| 32 | G | GG | | | |
| 33 | G | GG | | | |
| 34 | G | GG | | | |
| 35 | G | GH | | | |
| 36 | G | GH | | | |
| 37 | G | GH | | | |
| 38 | G | GH | “-GH-” AND NOT | F | M10 |
| | | | IN M9 | | |
| 39 | G | GH | | | |
| 40 | G | GH | | | |
| 41 | G | GH | a.)“B<letter><letter> | (silent) | M9 |
| | | | GH” | | |
| | | | b.)“D<letter><letter> | | |
| | | | GH” | | |
| | | | c.)“- | | |
| | | | H<letter><letter> | | |
| | | | GH” | | |
| | | | d.)“- | | |
| | | | H<letter><letter> | | |
| | | | <letter>GH” | | |
| 42 | G | GH | | | |
| 43 | G | GH | | | |
| 44 | G | GH | | | |
| 45 | G | GH | | | |
| 46 | G | G | | | |
| 47 | G | G | | | |
| 48 | G | | | | |
| 49 | G | a.)“-GNED” | | (silent) | M11 |
| | | b.)“-GN” | | | |
| | | c.)“GN-” | | | |
| 50 | G | a.)“-GNED” | | (silent) | M11 |
| | | b.)“-GN” | | | |
| | | c.)“GN-” | | | |
| 51 | G | | | | |
| 52 | G | | | | |
| 53 | G | | | | |
| 54 | G | a.)“-<NOT | | J | M12 |
| | | “G”>GE-” | | | |
| | | b.)“-<NOT | | | |
| | | “G”>GI-” | | | |
| | | c.)“-<NOT | | | |
| | | “G”>GY-” | | | |
| 55 | G | | | | |
| 56 | G | a.)“-<NOT | | J | M12 |
| | | “G”>GE-” | | | |
| | | b.)“-<NOT | | | |
| | | “G”>GI-” | | | |
| | | c.)“-<NOT | | | |
| | | “G”>GY-” | | | |
| 57 | G | | | | |
| 58 | G | | | | |
| 59 | G | | | | |
| 60 | G | | | | |
| 61 | G | | | | |
| 62 | G | | | | |
| 63 | G | | | | |
| 64 | G | | | | |
| 65 | G | | | | |
| 66 | G | | | | |
| 67 | G | (else) | | K | M13 |
| 68 | H | | | | |
| 69 | H | HS | | | |
| 70 | H | | | | |
| 71 | H | | | | |
| 72 | H | a.)“<NOT “C” OR | | H | M14 |
| | | “G” OR “P” OR | | | |
| | | “S” OR | | | |
| | | “T”>H<vowel>-” | | | |
| 73 | H | (else) | | (silent) | M15 |
| 74 | J | | | | |
| 75 | J | | | | |
| 76 | J | | | | |
| 77 | J | | | | |
| 78 | J | | | | |
| 79 | J | J, JJ | | J | M16 |
| 80 | K | | | | |
| 81 | K | | | (silent) | M18 |
| 82 | K | | | | |
| 83 | K | KK | | | |
| 84 | K | (else) | | K | M19 |
| 85 | L | | | | |
| 86 | L | | | | |
| 87 | L | | | | |
| 88 | L | | | | |
| 89 | L | | | | |
| 90 | L | LL | | | |
| 91 | L | LL | | | |
| 92 | L | | | L | M20 |
| 93 | M | | | | |
| 94 | M | MP | | | |
| 95 | M | MM | | | |
| 96 | M | | | M | M21 |
| 97 | N | | | | |
| 98 | N | NC | | | |
| 99 | NN | | | | |
| 100 | N | | | | |
| 101 | Ñ | | | N | M22 |
| 102 | P | “PN-” | | (silent) | M24 |
| 103 | P | PT | | | |
| 104 | P | PHTH | | | |
| 105 | P | PH | | | |
| 106 | P | PH | “-PH-” | F | M23 |
| 107 | P | PS | | | |
| 108 | P | | | | |
| 109 | P | | | | |
| 110 | P | PB | | | |
| | | PP | | | |
| 111 | P | (else) | | P | M25 |
| 112 | Q | QQ | | | |
| 113 | Q | | | K | M26 |
| 114 | R | | | | |
| 115 | R | RR | | | |
| 116 | R | | | R | M27 |
| 117 | S | | | | |
| 118 | S | | | | |
| 119 | S | ST | | | |
| 120 | S | SC | | | |
| 121 | S | STH | | | |
| 122 | S | | | | |
| 123 | S | | | | |
| 124 | S | SH | a.)“-SIO-” | X | M28 |
| | | | b.)“-SIA-” | | |
| | | | c.)“-SH-” | | |
| 125 | S | | | | |
| 126 | S | SCH | | | |
| 127 | S | SCH | | | |
| 128 | S | SCH | | | |
| 129 | S | | | | |
| 130 | S | | | | |
| 131 | S | | | | |
| 132 | S | | | | |
| 133 | S | | | | |
| 134 | S | SS | | | |
| 135 | S | SS | | | |
| 136 | S | SS | | | |
| 137 | S | | | | |
| 138 | S | | | | |
| 139 | S | a.)“-SIO-” | | X | M28 |
| | | b.)“-SIA-” | | | |
| | | c.)“-SH-” | | | |
| 140 | S | | | | |
| 141 | S | a.)“-SIO-” | | X | M28 |
| | | b.)“-SIA-” | | | |
| | | c.)“-SH-” | | | |
| 142 | S | a.)“-SIO-” | | X | M28 |
| | | b.)“-SIA-” | | | |
| | | c.)“-SH-” | | | |
| 142.a | S | | | | |
| 143 | S | SC | | | |
| 153 | T | | | | |
| 154 | T | TH | | | |
| 155 | T | TH | | | |
| 156 | T | TH | “-TH-” | 0 | M32 |
| 157 | T | TCH | | | |
| 158 | T | | | | |
| 159 | T | | | | |
| 160 | T | | | | |
| 161 | T | | | | |
| 162 | T | | | | |
| 163 | T | a.)“-TIA-” | | X | M31 |
| | | b.)“-TIO-” | | | |
| 164 | T | | | | |
| 165 | T | TTH | | | |
| 166 | T | TSCH | | | |
| 167 | T | TZSCH | | | |
| 168 | T | TT | | | |
| | | TD | | | |
| 169 | T | (else) | | T | M33 |
| 170 | V | VV | | | |
| 171 | V | | | F | M34 |
| 172 | W | | “-W<vowel>-” | W | M35 |
| | | | (treat as | R | M36 |
| | | | dipthong) | | |
| | | | “-WR-” | | |
| 173 | W | “-W<vowel>-” | | W | M35 |
| 174 | W | WH | “WH-” | W | M37 |
| | | | (else IF NOT IN | (don't encode) | M38 |
| | | | ANY RULES ABOVE | | |
| | | | TREAT AS VOWEL | | |
| | | | & DON'T ENCODE) | | |
| 175 | W | WH | | | |
| 175.a | W | | | | |
| 175.b | W | WICZ, | | | |
| | | WITZ | | | |
| 176 | X | | “X-” | S | M39 |
| 177 | X | | | | |
| 178 | X | | | | |
| 179 | X | | | | |
| 180 | X | | | | |
| 181 | X | XX | | | |
| | | XC | | | |
| 182 | X | (else) | | KS | M40 |
| 183 | Z | ZS | | | |
| 184 | Z | | | | |
| 185 | Z | ZZ | | | |
| 186 | Z | | | | |
| 187 | Z | | | | |
| 188 | Z | ZH | | | |
| 189 | Z | ZZ | | | |
| 190 | Z | | | S | M41 |

TABLE 6
M3 correspondence to Kucera patent

| Rule | | | Kucera: | | |
|---|---|---|---|---|---|
| Group | Letter | Digraph | Rule | Encoding | Remarks |
| 0 | A, E, I | | (See Kucera vowel encoding | | |
| | O, U, | | rules: | | |
| | W, Y | | K10, K11, K12, K13, K16, K17, | | |
| | | | K18,, K19, K20, K21, K34, K41, | | |
| | | | K35, K36, K37, K38, K39, K40, | | |
| | | | K41) | | |
| 00 | E or UE | | | | |
| 000 | E | LE | | | |
| 1 | B | | | | |
| 2 | B | BB | “-b-” | b | K24 |
| | | BP | “-bb-” | | |
| 3 | B | | | | |
| 4 | C | | | | |
| 5 | C | | | | |
| 6 | C | CC | | | |
| 7 | C | CC | | | |
| 8 | C | CC | | | |
| 9 | C | CH | | | |
| 9 | C | CH | | | |
| (continued) | | | | | |
| 9 | C | CH | | | |
| (cont.) | | | | | |
| 9 | C | CH | | | |
| (cont.) | | | | | |
| 10 | C | CH | | | |
| 11 | C | CH | | | |
| 12 | C | CH | | | |
| 13 | C | CK | | | |
| | | CG | | | |
| | | CQ | | | |
| 14 | C | | | | |
| 15 | C | | a.)“-ci-” | s | K1 |
| | | | b.)“-ce-” | | |
| | | | c.)“-cy-” | | |
| 16 | C | | | | |
| 17 | C | C | | | |
| 17.a | C | CZ | | | |
| 18 | C | CK | | | |
| | | CQ | | | |
| 19 | C | | (else) | k | K23, K24 |
| | | | “-c-” | | |
| | | | “-cc-” | | |
| 20 | ç | | | | |
| 21 | D | DG | | | |
| 22 | D | DG | “-dg-” | g | K22 |
| 23 | D | DJ | | | |
| 24 | D | DT | | | |
| 25 | D | DT | | | |
| | | DD | | | |
| 26 | D | | | | |
| 27 | D | | | | |
| 28 | D | | (else) | d | K24 |
| | | | “-d-” | | |
| | | | “-dd-” | | |
| 29 | F | FF | “-f-” | f | K24 |
| | | | “-ff-” | | |
| 30 | F | | “-f-” | f | K24 |
| | | | “-ff-” | | |
| 31 | G | | | | |
| 32 | G | GG | | | |
| 33 | G | GG | | | |
| 34 | G | GG | | | |
| 35 | G | GH | | | |
| 36 | G | GH | | | |
| 37 | G | GH | | | |
| 38 | G | GH | | | |
| 39 | G | GH | “-ght-” | t | K29 |
| 40 | G | GH | | | |
| 41 | G | GH | | | |
| 42 | G | GH | | | |
| 43 | G | GH | | | |
| 44 | G | GH | | | |
| 45 | G | GH | | | |
| 46 | G | G | | | |
| 47 | G | G | | | |
| 48 | G | | | | |
| 49 | G | | | | |
| 50 | G | “-gn-” | | n | K31 |
| 51 | G | | | | |
| 52 | G | | | | |
| 53 | G | | | | |
| 54 | G | | | | |
| 55 | G | | | | |
| 56 | G | | | | |
| 57 | G | | | | |
| 58 | G | | | | |
| 59 | G | | | | |
| 60 | G | | | | |
| 61 | G | | | | |
| 62 | G | | | | |
| 63 | G | | | | |
| 64 | G | | | | |
| 64 | G | | | | |
| (cont.) | | | | | |
| 65 | G | | | | |
| 66 | G | | | | |
| 67 | G | (else) | | g | K24 |
| | | “-g-” | | | |
| | | “-gg-” | | | |
| 68 | H | | | | |
| 69 | H | HS | | | |
| 70 | H | | | | |
| 71 | H | | | | |
| 72 | H | “-h-” | | h | |
| 73 | H | | | | |
| 74 | J | | | | |
| 75 | J | | | | |
| 76 | J | | | | |
| 77 | J | | | | |
| 78 | J | | | | |
| 79 | J | J, JJ | “-j-” | J | K24 |
| | | | “-jj-” | | |
| 80 | K | | | | |
| 81 | K | “kn-” | | n | K32 |
| 82 | K | | | | |
| 83 | K | KK | (else) | k | K24 |
| | | | “-k-” | | |
| | | | “-kk-” | | |
| 84 | K | (else) | | k | K24 |
| | | “-k-” | | | |
| | | “-kk-” | | | |
| 85 | L | | | | |
| 86 | L | | | | |
| 87 | L | | | | |
| 88 | L | | | | |
| 89 | L | | | | |
| 90 | L | LL | | | |
| 91 | L | LL | | | |
| 92 | L | “-l-” | | l | K24 |
| | | “-ll-” | | | |
| 93 | M | | | | |
| 94 | M | MP | | | |
| 95 | M | MM | | | |
| 96 | M | “-m-” | | m | K24 |
| | | “-mm-” | | | |
| 97 | N | | | | |
| 98 | N | NC | | | |
| 99 | NN | | | | |
| 100 | N | “-n-” | | n | K24 |
| | | “-nn-” | | | |
| 101 | Ñ | | | | |
| 102 | P | “ps-” | | s | K27 |
| | | “pn-” | | n | K32 |
| 103 | P | PT | | | |
| 104 | P | PHTH | | | |
| 105 | P | PH | | | |
| 106 | P | PH | “-ph-” | f | K30 |
| 107 | P | PS | | | |
| 108 | P | | | | |
| 109 | P | | | | |
| 110 | P | PB | | | |
| | | PP | | | |
| 111 | P | (else) | | p | K24 |
| | | “-p-” | | | |
| | | “-pp-” | | | |
| 112 | Q | QQ | | | |
| 113 | Q | | (else) | q | K24 |
| | | | “-q-” | | |
| | | | “-qq-” | | |
| 114 | R | | | | |
| 115 | R | RR | | | |
| 116 | R | (else) | | r | K24 |
| | | “-r-” | | | |
| | | “-rr-” | | | |
| 117 | S | | | | |
| 118 | S | | | | |
| 119 | S | ST | | | |
| 120 | S | SC | | | |
| 121 | S | STH | | | |
| 122 | S | | | | |
| 123 | S | | | | |
| 124 | S | SH | | | |
| 125 | S | | | | |
| 126 | S | SCH | | | |
| 127 | S | SCH | | | |
| 128 | S | SCH | | | |
| 129 | S | | | | |
| 130 | S | | | | |
| 131 | S | | | | |
| 132 | S | | | | |
| 133 | S | | | | |
| 134 | S | SS | | | |
| 135 | S | SS | “- | sh | K14 |
| | | | <letter><letter>si<a, | | |
| | | | o,u>-” | | |
| 136 | S | SS | | | |
| 137 | S | | | | |
| 138 | S | | | | |
| 139 | S | | | | |
| 140 | S | | | | |
| 141 | S | | | | |
| 142 | S | | | | |
| 142.a | S | | | | |
| 143 | S | SC | | | |
| 144 | S | SC | | | |
| 145 | S | SC | | | |
| 146 | S | SC | | | |
| 147 | S | | | | |
| 148 | S | | | | |
| 149 | S | SS | | | |
| | | SZ | | | |
| 150 | S | (else) | | s | K24 |
| | | “-s-” | | | |
| | | “-ss-” | | | |
| 151 | T | | | | |
| 152 | T | TH | | | |
| 153 | T | | | | |
| 154 | T | TH | | | |
| 155 | T | TH | | | |
| 156 | T | TH | | | |
| 157 | T | TCH | “-tch-” | kh | K7 |
| 158 | T | | | | |
| 159 | T | | a.)“<letter><letter> | kh | K8 |
| | | | tur<vowel>-” | kh | K9 |
| | | | b.)“<letter><letter> | | |
| | | | tun<vowel>-” | | |
| | | | c.)“<letter><letter> | | |
| | | | tun<vowel>-” | | |
| | | | d.)“<letter><letter> | | |
| | | | tul<vowel>-” | | |
| | | | a.)“<letter><letter> | | |
| | | | tuo-” | | |
| | | | b.)“<letter><letter> | | |
| | | | tua-” | | |
| | | | c.)“<letter><letter> | | |
| | | | tue-” | | |
| 160 | T | | a.)“<letter><letter> | kh | K8 |
| | | | tur<vowel>-” | | |
| | | | b.)“<letter><letter> | | |
| | | | tun<vowel>-” | | |
| | | | c.)“<letter><letter> | | |
| | | | tun<vowel>-” | | |
| | | | d.)“<letter><letter> | | |
| | | | tul<vowel>-” | | |
| 161 | T | | | | |
| 162 | T | | | | |
| 163 | T | | “- | sh | K14 |
| | | | <letter><letter>ti<a, | | |
| | | | o,u>-” | | |
| 164 | T | | | | |
| 165 | T | TTH | | | |
| 166 | T | TSCH | | | |
| 167 | T | TZSCH | | | |
| 168 | T | TT | (else) | t | K24 |
| | | TD | “-t-” | | |
| | | | “-tt-” | | |
| 169 | T | (else) | | t | K24 |
| | | “-t-” | | | |
| | | “-tt-” | | | |
| 170 | V | VV | “-v-” | v | K24 |
| | | | “-vv-” | | |
| 171 | V | | “-v-” | v | K24 |
| | | | “-vv-” | | |
| 172 | W | | “wr-” | r | K4 |
| 173 | W | (else) | | w | K24 |
| | | “-w-” | | | |
| | | “-ww-” | | | |
| 174 | W | WH | a.)“-whe-” | w | K6 |
| | | | b.)“-whi-” | | |
| | | | c.)“-wha-” | | |
| | | | d.)“-why-” | | |
| 175 | W | WH | “who-” | h | K5 |
| 175.a | W | | | | |
| 175.b | W | WICZ, | | | |
| | | WITZ | | | |
| 176 | X | | | | |
| 177 | X | | | | |
| 178 | X | | | | |
| 179 | X | | | | |
| 180 | X | | | | |
| 181 | X | XX | | | |
| | | XC | | | |
| 182 | X | “-x-” | | x | K24 |
| | | “-xx-” | | | |
| 183 | Z | ZS | | | |
| 184 | Z | | | | |
| 185 | Z | ZZ | | | |
| 186 | Z | | | | |
| 187 | Z | | | | |
| 188 | Z | ZH | | | |
| 189 | Z | ZZ | (non initial) | s | K2 |
| | | | “-z-” | | |
| | | | “-zz-” | | |

| | | | | |
|---|---|---|---|---|
| 190 | Z | (else) | z | K24 |
| | | “-z-” | | |
| | | “-zz-” | | |

TABLE 7
M3 correspondence to Soundex

| M3 Rule | | | Soundex: | |
|---|---|---|---|---|
| Group | Letter | Digraph | Rule | Encoding |
| 0 | A, E, I | | a.)“A-” | Encoded as is if |
| | O, U, | | b.)“E-” | initial letter in word, |
| | W, Y | | c.)“I-” | else not encoded. |
| | | | d.)“O-” | |
| | | | e.)“U-” | |
| | | | f.)“Y-” | |
| 00 | E or UE | | | |
| 000 | E | LE | | |
| 1 | B | | | |
| 2 | B | BB | | |
| | | BP | | |
| 3 | B | | “-B-” | Encoded as is if |
| | | | | initial letter in word, |
| | | | | else encoded as ‘1’ - |
| | | | | unless previous |
| | | | | encoded symbol is also ‘1’. |
| 4 | C | | | |
| 5 | C | | | |
| 6 | C | CC | | |
| 7 | C | CC | | |
| 8 | C | CC | | |
| 9 | C | CH | | |
| 9 | C | CH | | |
| 9 | C | CH | | |
| 9 | C | CH | | |
| 10 | C | CH | | |
| 11 | C | CH | | |
| 12 | C | CH | | |
| 13 | C | CK | | |
| | | CG | | |
| | | CQ | | |
| 14 | C | | | |
| 15 | C | | | |
| 16 | C | | | |
| 17 | C | C | | |
| 17.a | C | CZ | | |
| 18 | C | CK | | |
| | | CQ | | |
| 19 | C | | “-C-” | Encoded as is if |
| | | | | initial letter in word, |
| | | | | else encoded as ‘2’ - |
| | | | | unless previous |
| | | | | encoded symbol is |
| | | | | also ‘2’. |
| 20 | C | | | |
| 21 | D | DG | | |
| 22 | D | DG | | |
| 23 | D | DJ | | |
| 24 | D | DT | | |
| 25 | D | DT | | |
| | | DD | | |
| 26 | D | | | |
| 27 | D | | | |
| 28 | D | | “-D-” | Encoded as is if |
| | | | | initial letter in word, |
| | | | | else encoded as ‘3’ - |
| | | | | unless previous |
| | | | | encoded symbol is |
| | | | | also ‘3’. |
| 29 | F | FF | | |
| 30 | F | | “-F-” | Encoded as is if |
| | | | | initial letter in word, |
| | | | | else encoded as ‘1’ - |
| | | | | unless previous |
| | | | | encoded symbol is |
| | | | | also ‘1’. |
| 31 | G | | | |
| 32 | G | GG | | |
| 33 | G | GG | | |
| 34 | G | GG | | |
| 35 | G | GH | | |
| 36 | G | GH | | |
| 37 | G | GH | | |
| 38 | G | GH | | |
| 39 | G | GH | | |
| 40 | G | GH | | |
| 41 | G | GH | | |
| 42 | G | GH | | |
| 43 | G | GH | | |
| 44 | G | GH | | |
| 45 | G | GH | | |
| 46 | G | G | | |
| 47 | G | G | | |
| 48 | G | | | |
| 49 | G | | | |
| 50 | G | | | |
| 51 | G | | | |
| 52 | G | | | |
| 53 | G | | | |
| 54 | G | | | |
| 55 | G | | | |
| 56 | G | | | |
| 57 | G | | | |
| 58 | G | | | |
| 59 | G | | | |
| 60 | G | | | |
| 61 | G | | | |
| 62 | G | | | |
| 63 | G | | | |
| 64 | G | | | |
| | G | | | |
| 65 | G | | | |
| 66 | G | | | |
| 67 | G | “-G-” | | Encoded as is if |
| | | | | initial letter in word, |
| | | | | else encoded as ‘2’ - |
| | | | | unless previous |
| | | | | encoded symbol is |
| | | | | also ‘2’. |
| 68 | H | | | |
| 69 | H | HS | | |
| 70 | H | | | |
| 71 | H | | | |
| 72 | H | | | |
| 73 | H | “-H-” | | Encoded as is if |
| | | | | initial letter in word, |
| | | | | else not encoded. |
| 74 | J | | | |
| 75 | J | | | |
| 76 | J | | | |
| 77 | J | | | |
| 78 | J | | | |
| 79 | J | J, JJ | “-J-” | Encoded as is if |
| | | | | initial letter in word, |
| | | | | else encoded as ‘2’ - |
| | | | | unless previous |
| | | | | encoded symbol is |
| | | | | also ‘2’. |
| 80 | K | | | |
| 81 | K | | | |
| 82 | K | | | |
| 83 | K | KK | | |
| 84 | K | “-K-” | | Encoded as is if |
| | | | | initial letter in word, |
| | | | | else encoded as ‘2’ - |
| | | | | unless previous |
| | | | | encoded symbol is |
| | | | | also ‘2’. |
| 85 | L | | | |
| 86 | L | | | |
| 87 | L | | | |
| 88 | L | | | |
| 89 | L | | | |
| 90 | L | LL | | |
| 91 | L | LL | | |
| 92 | L | “-L-” | | Encoded as is if |
| | | | | initial letter in word, |
| | | | | else encoded as ‘4’ - |
| | | | | unless previous |
| | | | | encoded symbol is |
| | | | | also ‘4’. |
| 93 | M | | | |
| 94 | M | MP | | |
| 95 | M | MM | | |
| 96 | M | “-M-” | | Encoded as is if |
| | | | | initial letter in word, |
| | | | | else encoded as ‘5’ - |
| | | | | unless previous |
| | | | | encoded symbol is |
| | | | | also ‘5’. |
| 97 | N | | | |
| 98 | N | NC | | |
| 99 | NN | | | |
| 100 | N | | | |
| 101 | Ñ | “-N-” | | Encoded as is if |
| | | | | initial letter in word, |
| | | | | else encoded as ‘5’ - |
| | | | | unless previous |
| | | | | encoded symbol is |
| | | | | also ‘5’. |
| 102 | P | | | |
| 103 | P | PT | | |
| 104 | P | PHTH | | |
| 105 | P | PH | | |
| 106 | P | PH | | |
| 107 | P | PS | | |
| 108 | P | | | |
| 109 | P | | | |
| 110 | P | PB | | |
| | | PP | | |
| 111 | P | “-P-” | | Encoded as is if |
| | | | | initial letter in word, |
| | | | | else encoded as ‘1’ - |
| | | | | unless previous |
| | | | | encoded symbol is |
| | | | | also ‘1’. |
| 112 | Q | QQ | | |
| 113 | Q | | “-Q-” | Encoded as is if |
| | | | | initial letter in word, |
| | | | | else encoded as ‘2’ - |
| | | | | unless previous |
| | | | | encoded symbol is |
| | | | | also ‘2’. |
| 114 | R | | | |
| 115 | R | RR | | |
| 116 | R | “-R-” | | Encoded as is if |
| | | | | initial letter in word, |
| | | | | else encoded as ‘6’ - |
| | | | | unless previous |
| | | | | encoded symbol is |
| | | | | also ‘6’. |
| 117 | S | | | |
| 118 | S | | | |
| 119 | S | ST | | |
| 120 | S | SC | | |
| 121 | S | STH | | |
| 122 | S | | | |
| 123 | S | | | |
| 124 | S | SH | | |
| 125 | S | | | |
| 126 | S | SCH | | |
| 127 | S | SCH | | |
| 128 | S | SCH | | |
| 129 | S | | | |
| 130 | S | | | |
| 131 | S | | | |
| 132 | S | | | |
| 133 | S | | | |
| 134 | S | SS | | |
| 135 | S | SS | | |
| 136 | S | SS | | |
| 137 | S | | | |
| 138 | S | | | |
| 139 | S | | | |
| 140 | S | | | |
| 141 | S | | | |
| 142 | S | | | |
| 142.a | S | | | |
| 143 | S | SC | | |
| 144 | S | SC | | |
| 145 | S | SC | | |
| 146 | S | SC | | |
| 147 | S | | | |
| 148 | S | | | |
| 149 | S | SS | | |
| | | SZ | | |
| 150 | S | “-S-” | | Encoded as is if |
| | | | | initial letter in word, |
| | | | | else encoded as ‘2’ - |
| | | | | unless previous |
| | | | | encoded symbol is |
| | | | | also ‘2’. |
| 151 | T | | | |
| 152 | T | TH | | |
| 153 | T | | | |
| 154 | T | TH | | |
| 155 | T | TH | | |
| 156 | T | TH | | |
| 157 | T | TCH | | |
| 158 | T | | | |
| 159 | T | | | |
| 160 | T | | | |
| 161 | T | | | |
| 162 | T | | | |
| 163 | T | | | |
| 164 | T | | | |
| 165 | T | TTH | | |
| 166 | T | TSCH | | |
| 167 | T | TZSCH | | |
| 168 | T | TT | | |
| | | TD | | |
| 169 | T | “-T-” | | Encoded as is if |
| | | | | initial letter in word, |
| | | | | else encoded as ‘3’ - |
| | | | | unless previous |
| | | | | encoded symbol is |
| | | | | also ‘3’. |
| 170 | V | VV | | |
| 171 | V | | “-V-” | Encoded as is if |
| | | | | initial letter in word, |
| | | | | else encoded as ‘1’ - |
| | | | | unless previous |
| | | | | encoded symbol is |
| | | | | also ‘1’. |
| 172 | W | | | |
| 173 | W | | | |
| 174 | W | WH | | |
| 175 | W | WH | | |
| 175.a | W | | | |
| 175.b | W | WICZ, | “-W-” | Encoded as is if |
| | | WITZ | | initial letter in word, |
| | | | | else not encoded. |
| 176 | X | | | |
| 177 | X | | | |
| 178 | X | | | |
| 179 | X | | | |
| 180 | X | | | |

| 181 | X | XX | |
|---|---|---|---|
| | | XC | |
| 182 | X | “-X-” | Encoded as is if |
| | | | initial letter in word, |
| | | | else encoded as ‘2’ - |
| | | | unless previous |
| | | | encoded symbol is |
| | | | also ‘2’. |
| 183 | Z | ZS | |
| 184 | Z | | |
| 185 | Z | ZZ | |
| 186 | Z | | |
| 187 | Z | | |
| 188 | Z | ZH | |
| 189 | Z | ZZ | |
| 190 | Z | “-Z-” | Encoded as is if |
| | | | initial letter in word, |
| | | | else encoded as ‘2’ - |
| | | | unless previous |
| | | | encoded symbol is |
| | | | also ‘2’. |

TABLE 8

| | | | DOUBLE METAPHONE: | | | |
|---|---|---|---|---|---|---|
| DM0 | A, E, I, O, | | ALL INITIAL VOWELS IN DM ARE | A | | |
| | U, Y | | MAPPED TO ‘A’; OTHERWISE, VOWELS | | | |
| | | | NOT ENCODED | | | |
| DM1 | B | | a.)“-UMB” | (silent) | | “dumb” and |
| | | | b.)“-UMBER” | | | “dumber”, |
| | | | c.)“-<vowel>MB” | | | “limb” but not |
| | | | | | | “limber” |
| DM2 | B | | (else) | P | | |
| DM3 | ç | | “-ç-” | S | | |
| DM4 | C | CH | a.)[“-<consonant>ACH-” AND NOT: | K | | various |
| | | | “-ACHI-” | | | germanic |
| | | | “-ACHE-”] | | | |
| | | | b.)“-BACHER-” | | | |
| | | | c.)“-MACHER-” | | | |
| DM5 | C | | “CAESAR-” | S | | special case |
| DM6 | C | CH | “-CHIA-” | K | | italian |
| DM7 | C | CH | “-CHAE-” | K | X | find ‘michael’ |
| DM8 | C | CH | a.)“-OACH-” | X | | |
| | | | b.)“-EACH-” | | | |
| | | | c.)“-EECH-” | | | |
| DM9 | C | CH | a.)“-CHARAC-” | K | | greek roots |
| | | | b.)“-CHARIS-” | | | |
| | | | c.)[“-CHOR-” AND NOT: | | | |
| | | | “-CHORE-”] | | | |
| | | | d.)“-CHYM-” | | | |
| | | | e.)“-CHIA-” | | | |
| | | | f.)“-CHEM-” | | | |
| | | | g.)“-CHLO-” | | | |
| | | | h.)(IF IN A WORD STARTING WITH | | | |
| | | | “VAN” OR “VON”) | | | |
| | | | i.)“SCH-” | | | |
| | | | j.)“-ORCHES-” | | | |
| | | | k.)“-ARCHIT-” | | | |
| | | | l.)“-ORCHID-” | | | |
| | | | m.)“-CHT-” | | | |
| | | | n.)“-CHS-” | | | |
| | | | m.)<“A” OR “O” OR “U” OR | | | |
| | | | “E“>“CH”<“L” OR “R” OR “N” OR “M” | | | |
| | | | OR “B” OR “H” OR “F” OR “V” OR “W” | | | |
| | | | OR “ ”> | | | |
| DM10 | C | CH | “MCH-” | K | | e.g. ‘McHugh’ |
| DM11 | C | CH | (else)“-CH-” | X | K | |
| DM12 | C | CH | (else)“CH-” | X | | |
| DM13 | C | CZ | “-CZ-” AND NOT: “-WICZ-” | S | X | e.g.‘czerny’ |
| DM14 | C | | “-CIA-” | X | | e.g. ‘focaccia’ |
| DM15 | C | CC | a.)“ACC-” | KS | | |
| | | | b.)“-UCCES-” | | | |
| | | | c.)“-UCCEE-” | | | |
| DM16 | C | CC | [a.)“-CCI-” | X | | |
| | | | b.)“-CCE-” | | | |
| | | | c.)[“-CCH-” AND NOT: “-CCHU-”] | | | |
| | | | AND NOT: IN RULE GROUP DM15 | | | |
| | | | AND NOT: “MCC-”] | | | |
| DM17 | C | CC | [“-CC-” AND NOT: | K | | |
| | | | IN RULE GROUPS DM15 OR DM16] | | | |
| DM18 | C | CK, | a.)“-CK-” | K | | |
| | | CG, | b.)“-CG-” | | | |
| | | CQ | c.)“-CQ-” | | | |
| DM19 | C | | a.)“-<vowel>CIA-” | X | | |
| | | | b.)“-<vowel>CIO-” | | | |
| | | | c.)“-<vowel>CIE-” | | | |
| | | | d.)“-CEOUS-” | | | |
| DM20 | C | | a.)[“-CI-” AND NOT: | S | | |
| | | | IN RULE GROUP DM19a-c] | | | |
| | | | b.)“-CY-” | | | |
| | | | c.)[“-CE-” AND NOT: | | | |
| | | | IN RULE GROUP DM19d] | | | |
| DM20.a | C | | (else) | K | | |
| DM21 | D | DG | a.)“-DG<“I” OR “E” OR “Y”>-” | J | | “edge” |
| | | | b.)“-DG” | | | |
| DM22 | D | DG | (else) | TK | | else other“- |
| | | | | | | DG-”, e.g. |
| | | | | | | “edgar” |
| DM23 | D | D, | (else) | T | | |
| | | DD, | | | | |
| | | DT | | | | |
| DM24 | F | FF | | F | | |
| DM25 | F | | (else) | F | | |
| DM26 | G | GH | a.)“-<consonant>GH-” | K | | |
| | | | b.)[“GH-” AND NOT: “GHI-”] | | | |
| DM27 | G | GH | “GHI-” | J | | |
| DM28 | G | GH | a.)“-<“B” OR “H” OR “D”><vowel>GH-” | (silent) | | “Hugh” |
| | | | b.)“-<“B” OR “H” OR | | | “bough”, |
| | | | “D”><vowel><vowel>GH-” | | | “dough” |
| | | | c.)“-<“B” OR | | | “broughton” |
| | | | “H”><letter><vowel><vowel>GH-” | | | |
| | | | d.)“-IGH-” | | | |
| DM29 | G | GH | <“C” OR “G” OR “L” OR “R” OR | F | | “laugh”, |
| | | | “T”><vowel>UGH-” | | | “rough” |
| DM30 | G | GH | (else) | K | | |
| DM31 | G | GN | [“<vowel>GN-” AND NOT: “W” OR “K” | KN | N | “agnelli” |
| | | | OR “CZ” OR “WITZ” IN WORD] | | | |
| DM32 | G | GN | a.)“-<vowel>GN” | N | | “align”, |
| | | | b.)“GN-” | | | “impugn” |
| DM33 | G | GN | (else) | KN | | |
| DM34 | G | GL | “-GLI-” AND NOT: “W” OR “K” OR | KL | L | “tagliaro” |
| | | | “CZ” OR “WITZ” IN WORD] | | | |
| DM35 | G | | a.)[“-GY-” AND NOT:“-IGY-”, “-OGY- | K | J | |
| | | | ”, “-RGY-”, “-OGY-”] | | | |
| | | | b.)“G<“ES” OR “EP” OR “EB” OR “EL” | | | |
| | | | OR “EY” OR “IB” OR “IL” OR “IN” OR | | | |
| | | | “IE” OR “EI” OR “ER”>-” | | | |
| | | | c.)[“-GER-” AND NOT:“-DANGER-”, “- | | | |
| | | | MANGER-”, “-RANGER-”, “-EG-”, “-IG-”] | | | |
| DM36 | G | | a.)“-GET-” | K | | |
| | | | b.)<“SCH-” OR “VAN-” OR “VON- | | | |
| | | | ”>G<“E” OR “I” OR “Y”>-” | | | |
| DM37 | G | | “-GIER” | J | | “rogier” |
| DM38 | G | | “-G<“E” OR “I” OR “Y”>-” AND NOT: | J | K | |
| | | | IN DM35 OR DM36 OR DM37 | | | |
| DM39 | G | | (else) | K | | |
| DM40 | H | | a.)“H<vowel>-” | H | | |
| | | | b.)“-<vowel>H<vowel>-” | | | |
| DM41 | H | | (else) | (silent) | | |
| DM42 | J | | a.)“JOSE” | H | | spanish |
| | | | b.)“SAN-J-” | | | |
| DM43 | J | | a.)“-JOSE-” | J | H | |
| | | | b.)[“-<vowel>J<“A” OR “O”>-” AND | | | |
| | | | NOT: “W” OR “K” OR “CZ” OR “WITZ” | | | |
| | | | IN WORD] | | | |
| DM44 | J | | “J-” AND NOT: “JOSE-” | J | A | “jankelowicz/yankelowitz” |
| DM45 | J | | a.)“-J<“L” OR “T” OR “K” OR “S” OR | (silent) | | |
| | | | “N” OR “M” OR “B” OR “Z”>-” | | | |
| | | | b.)“-<“S” OR “K” OR “L”>J-” | | | |
| DM46 | J | J, | (else) | J | | |
| | | JJ | | | | |
| DM47 | K | | “KN-” | (silent) | | |
| DM47.a | K | K, | (else) | K | | |
| | | KK | | | | |
| DM48 | L | | “-LN” | (silent) | | “lincoln” |
| DM49 | L | LL | a.)“-ALLE” | L | (treat | “gallegos” |
| | | | b.)“-ILLO” | | as | |
| | | | c.)“-ILLA” | | internal | |
| | | | d.)“-ALLE-<“AS” OR “OS” OR “A” OR | | vowel | |
| | | | “O”>” | | andtherefore | |
| | | | | | don't | |
| | | | | | encode) | |
| DM50 | L | | (else) | L | | |
| DM51 | M | | | M | | |
| DM52 | N | | a.)“-NCE” | NT | | “accountance’ |
| | | | b.)“-NCY” | | | == |
| DM53 | N | | (else) | N | | “accountants” |
| DM54 | Ñ | | | N | | |
| DM55 | P | PH | “-PH-” | F | | |
| DM56 | P | | a.)“-PSYCH-” | (silent) | | “psalm”, |
| | | | b.)“PN-” | | | “raspberry” |
| | | | c.)“PS-” | | | |
| | | | d.)“-PB-” | | | |
| DM57 | P | P, | (else) | P | | |
| | | PP | | | | |
| DM58 | Q | Q, | | K | | |
| | | QQ | | | | |
| DM59 | R | | [“-IER” AND NOT: “-MEIER” OR “- | (silent) | | |
| | | | MAIER” OR [“W” OR “K” OR “CZ” OR | | | |
| | | | “WITZ” IN WORD]] | | | |
| DM60 | R | | (else) | R | | |
| DM61 | S | | a.)“-ISL-” | (silent) | | |
| | | | b.)“-YSL-” | | | |
| | | | c.)“-AIS” | | | |
| | | | d.)“-OIS” | | | |
| DM62 | S | | a.)“SUGAR-” | X | S | special case |
| | | | [b.)“SCH <consonant>-” AND NOT: | | | for “sugar” |
| | | | “SCHW-”] | | | |
| DM63 | S | SH, | [a.)“-SH-” AND NOT: “-SHEIM-” OR | X | | “issue” |
| | | SS | “-SHOEK-” OR “-SHOLM-” OR “-SHOLZ- | | | |
| | | | ”] | | | |
| | | | b.)“-ISSU-” | | | |
| | | | c.)“-SUA-” | | | |
| | | | d.)“-SUO-” | | | |
| | | | [e.)“-<vowel>SSIO-” AND NOT: “- | | | |
| | | | CISSIO-”] | | | |
| | | | f.)“-<consonant>SI<“A” OR “O”>-” | | | |
| DM64 | S | | a.)“-CISSIO-” | J | | |
| | | | b.)“-<vowel>SI<“A” OR “O”>-” | | | |
| DM65 | S | | a.)“SM-” | S | X | add “sh” |
| | | | b.)“SN-” | | | pronounciation |
| | | | c.)“SW-” | | | to make |
| | | | d.)“SL-” | | | germanic and |
| | | | e.)“-SZ-” | | | slavic origin |
| | | | | | | names match |
| | | | | | | up with native |
| | | | | | | spellings |
| DM66 | S | SCH | a.)“-SCHER-” | X | SK | |
| | | | b.)“-SCHEN-” | | | |
| DM67 | S | SCH | a.)“-SCHOO-” | SK | | |
| | | | b.)“-SCHUY-” | | | |
| | | | c.)“-SCHED-” | | | |
| | | | d.)“-SCHEM-” | | | |
| DM68 | S | SCH | [“-SCH-” AND NOT IN DM62, DM66, | X | | |
| | | | DM67] | | | |
| DM69 | S | SC | a.)“-SCI-” | S | | |
| | | | b.)“-SCE-” | | | |
| | | | c.)“-SCY-” | | | |
| DM70 | S | SC | “-SC-” AND NOT In DM69 | SK | | |
| DM71 | S | | (else) | S | | |
| DM72 | T | | a.)“-TUA-” AND NOT AT BEGINNING OR | X | | |
| | | | WORD | | | |
| | | | b.)“-TUR-” AND NOT AT BEGINNING OF | | | |
| | | | WORD | | | |
| | | | c.)“-TIO-” | | | |
| | | | d.)“-TIOUS-” | | | |
| | | | e.)“-TIA-” | | | |
| | | | f.)“-TCH-” | | | |
| DM73 | T | TH | a.)“-THOOD-” | T | | ‘H’ from |
| | | | b.)“-THEAD-” | | | another word, |
| | | | c.)“-THEID-” | | | also exceptions |
| | | | d.)“-THOM-” | | | e.g. “thomas” |
| | | | e.)“-THAM-” | | | |
| | | | f.)“V<“A” OR “O” >N-TH-” | | | |
| | | | g.)“SCH-TH-” | | | |
| DM74 | T | TH, | [“-TH-” OR “-TTH-” IF NOT IN DM73] | 0 | | ‘0’ represents |
| | | TTH | | | | “TH” sound |
| DM75 | T | T, | (else) | T | | |
| | | TT, | | | | |
| | | TD | | | | |
| DM76 | V | V, | | F | | |
| | | VV | | | | |
| DM77 | W | | “WR-” | (silent) | | |
| DM78 | W | WR | “-WR-” | R | | |
| DM79 | W | | “W<vowel>-” | A | F | match |
| | | | | | | germanic |
| | | | | | | names |
| DM80 | W | WH | “WH-” | A | | |
| DM81 | W | | a.)“-EWSKI-” | (treat | F | match |
| | | | b.)“-EWSKY-” | as | | germanic |
| | | | c.)“-OWSKI-” | non- | | words |
| | | | d.)“-OWSKY-” | initial | | |
| | | | e.)“-<vowel>W” | vowel | | |
| | | | f.)“SCH-W-” | and | | |
| | | | | don't | | |
| | | | | encode) | | |
| DM82 | W | WICZ, | a.)“-WICZ-” | TS | FX | code to match |
| | | WITZ | b.)“-WITZ-” | | | english and |
| | | | | | | polish |
| DM83 | X | | “X-” | S | | |
| DM84 | X | | a.)“-IAUX” | (silent) | | french endings |
| | | | b.)“-EAUX” | | | |
| | | | c.)“-IEUX” | | | |
| | | | d.)“-AUX” | | | |
| | | | e.)“-OUX” | | | |
| DM85 | X | X, | (else) | KS | | |
| | | XC, | | | | |
| | | XX | | | | |
| DM86 | Z | ZZ | “-ZZI” | TS | | italian e.g. |
| | | H | | | | “abruzzi” |
| DM87 | Z | ZH | “-ZH-” | J | | chinese e.g. |
| | | | | | | “zhao” |
| DM88 | Z | Z, | a.)“-ZZO-” | S | TS | |
| | | ZZ | b.)“-ZZI-” | | | |
| | | | c.)“-ZZA-” | | | |
| | | | d.)[“W” OR “K” OR “CZ” OR “WITZ” | | | |
| | | | IN WORD AND NOT “-ZT-”] | | | |
| DM89 | Z | | (else) | S | | |
| | | | METAPHONE: | | | |
| M0 | A, E, I, O, | | a.)“A-” | (all | | |
| | U, Y | | b.)“E-” | intital | | |
| | | | c.)“I-” | vowels | | |
| | | | d.)“O-” | maped | | |
| | | | e.)“U-” | As | | |
| | | | f.)“Y<vowel>-” | IS, | | |
| | | | | e.g. | | |
| | | | | A => A, | | |
| | | | | E => E, | | |
| | | | | I => I, | | |
| | | | | etc.) | | |
| M1 | B | | “-MB” | (silent) | | |
| M2 | B | | (else) | B | | |
| M3 | C | | a.)“-CIA-” | X | | |
| | | | b.)“-CH-” | | | |
| M4 | C | | [a.)“-CI-” AND NOT IN M3] | S | | |
| | | | b.)“-CE-” | | | |
| | | | c.)“-CY-” | | | |
| M5 | C | | (else) | K | | |
| M6 | D | DG | a.)“-DGI-” | J | | |
| | | | b.)“-DGE-” | | | |
| | | | c.)“-DGY-” | | | |
| M7 | D | | (else) | T | | |
| M8 | F | | | F | | |
| M9 | G | GH | a.)“B<letter><letter>GH” | (silent) | | |
| | | | b.)“D<letter><letter>GH” | | | |
| | | | c.)“-H<letter><letter>GH” | | | |
| | | | d.)“-H<letter><letter><letter>GH” | | | |
| M10 | G | GH | “-GH-” AND NOT IN M9 | F | | |
| M11 | G | | a.)“-GNED” | (silent) | | |
| | | | b.)“-GN” | | | |
| | | | c.)“GN-” | | | |
| M12 | G | | a.)“-<NOT “G”>GE-” | J | | |
| | | | b.)“-<NOT “G”>GI-” | | | |
| | | | c.)“-<NOT “G”>GY-” | | | |
| M13 | G | | (else) | K | | |
| M14 | H | | a.)“<NOT “C” OR “G” OR “P” OR “S” | H | | |
| | | | OR “T”>H<vowel>-” | | | |
| M15 | H | | (else) | (silent) | | |
| M16 | J | | | J | | |
| M17 | K | | “-CK-” | (silent- | | |
| | | | | encoded | | |
| | | | | by | | |
| | | | | preceeding | | |
| | | | | ‘C’) | | |
| M18 | K | KN | “KN-” | N | | |
| M19 | K | | (else) | K | | |
| M20 | L | | | L | | |
| M21 | M | | | M | | |
| M22 | N | | | N | | |
| M23 | P | PH | “-PH-” | F | | |
| M24 | P | PN | “PN-” | N | | |
| M25 | P | | (else) | P | | |
| M26 | Q | | | K | | |
| M27 | R | | | R | | |
| M28 | S | | a.)“-SIO-” | X | | |
| | | | b.)“-SIA-” | | | |
| | | | c.)“-SH-” | | | |
| M29 | S | SC | a.)“-SCI-” | S | | |
| | | | b.)“-SCE-” | | | |
| | | | c.)“-SCY-” | | | |
| M30 | S | | (else) | S | | |
| M31 | T | | a.)“-TIA-” | X | | |
| | | | b.)“-TIO-” | | | |
| M32 | T | | “-TH-” | 0 | | ‘0’ stands for |
| | | | | | | “TH” sound |
| M33 | T | | (else) | T | | |
| M34 | V | | | F | | |
| M35 | W | W | “-W<vowel>-” | W | | |
| M36 | W | WR | “WR-” | R | | |
| M37 | W | WH | “WH-” | W | | |
| M38 | W | | (else) | (treated | | |
| | | | | as | | |
| | | | | non- | | |
| | | | | intial | | |
| | | | | vowel | | |
| | | | | and | | |
| | | | | not | | |
| | | | | encoded) | | |
| M39 | X | | “X-” | S | | |
| M40 | X | | (else) | KS | | |
| M41 | Z | | | S | | |
| | | | | first | | |
| | | | | search | | |
| | | | KUCERA PATENT: | encoding | | |
| K17 | a | au, | a.)“-au<consonant>-” | oo | | |
| | | aw | b.)“-aw<consonant>-” | | | |
| | | | c.)“-au” | | | |
| | | | d.)“-aw” | | | |
| K19, | a | a, | a.)“-<letter><letter><letter>a” | — | | |
| K20, | | ae | b.)“-<letter><letter><letter>ae” | (called | | |
| K21 | | | c.)“a-” | “trace”) | | |
| | | | d.)“a<any # of vowels>-” | | | |
| K34 | a | | a.)“<all consonants>a-” | E | | |
| | | | b.)“<“trace”>a-” | | | |
| K41 | a | | (else) | (deleted) | | |
| K24 | b | b, | “-b-” | b | | |
| | | bb | “-bb-” | | | |
| K1 | c | | a.)“-ci-” | s | | |
| | | | b.)“-ce-” | | | |
| | | | c.)“-cy-” | | | |
| K23, | c | c, | (else) | k | | |
| K24 | | cc | | | | |
| K22 | d | dg | “-dg-” | g | | |
| K24 | d | d, | (else) | d | | |
| | | dd | “-d-” | | | |
| | | | “-dd-” | | | |
| K17 | e | eu, | a.)“-eu<consonant>-” | oo | | |
| | | ew | b.)“-ew<consonant>-” | | | |
| | | | c.)“-eu” | | | |
| | | | d.)“-ew” | | | |
| K18 | e | ea | “-ea” | — | | |
| | | | | (called | | |
| | | | | “trace”) | | |
| K21 | e | | “e-” | — | | |
| | | | “e<any # of vowels>-” | (called | | |
| | | | | “trace”) | | |
| K34 | e | | a.)“<all consonants>e-” | E | | |
| | | | b.)“<“trace”>e-” | | | |
| K41 | e | | (else) | (deleted) | | |
| K36 | E (as | | a.)“-<letter>Er<consonant>-” | (symbol E | | |
| | encoded | | b.)“-<letter>Er” | (deleted) | | |
| | symbol) | | | | | |
| K39 | E (as | | “-E<all consonants>-” | I | | |
| | encoded | | | | | |
| | symbol) | | | | | |
| K24 | f | f, ff | “-f-” | f | | |
| | | | “-ff-” | | | |
| K15 | g | gue | “<letter><letter>gue-” | ge | | |
| K29 | g | ght | “-ght-” | te | | |
| K31 | g | gn | “-gn-” | n | | |
| K24 | g | g, | (else) | g | | |
| | | gg | “-g-” | | | |
| | | | “-gg-” | | | |
| | h | | “-h-” | h | | |
| K11 | i | ie | “-<letter><letter>ie” | Y | | |
| K12 | i | | “-<vowel>i<vowel>-” | Y | | |
| K18 | i | ia | “-ia” | — | | |
| | | | | (called | | |
| | | | | “trace”) | | |
| K21 | i | | “i-” | — | | |
| | | | “i<any # of vowels>-” | (called | | |
| | | | | “trace”) | | |
| K34 | i | | a.)“<all consonants>i-” | E | | |
| | | | b.)“<“trace”>i-” | | | |
| K41 | i | | (else) | (deleted) | | |
| K24 | j | j, jj | “-j-” | j | | |
| | | | “-jj-” | | | |
| K25 | k | ks | “-ks-” | x | | |
| K32 | k | kn | “kn-” | n | | |
| K24 | k | k, | (else) | k | | |
| | | kk | “-k-” | | | |
| | | | “-kk-” | | | |
| K24 | l | l, | “-l-” | l | | |
| | | ll | “-ll-” | | | |
| K24 | m | m, | “-m-” | m | | |
| | | mm | “-mm-” | | | |
| K24 | n | n, | “-n-” | n | | |
| | | nn | “-nn-” | | | |
| K21 | o | | “o-” | — | | |
| | | | “o<any # of vowels>-” | (called | | |
| | | | | “trace”) | | |
| K35 | o | | a.)“<all consonants>o-” | O | | |
| | | | b.)“<“trace”>o-” | | | |
| K37, | o | o, | a.)“-<letter><letter>o” | O | | |
| K38 | | oe | b.)“-<letter><letter>oe” | | | |
| K41 | o | | (else) | (deleted) | | |
| K40 | O (as | | “-O<all consonants>-” | W | | |
| | encoded | | | | | |
| | symbol) | | | | | |
| K27 | p | ps | “ps-” | s | | |
| K30 | p | ph | “-ph-” | f | | |
| K32 | p | pn | “pn-” | n | | |
| K24 | p | p, | (else) | p | | |
| | | pp | “-p-” | | | |
| | | | “-pp-” | | | |
| K3 | q | qu | “-qu-” | kw | | |
| K24 | q | q, | (else) | q | | |
| | | qq | “-q-” | | | |
| | | | “-qq-” | | | |
| K28 | r | rh | “-rh-” | r | | |
| K24 | r | r, | (else) | r | | |
| | | rr | “-r-” | | | |
| | | | “-rr-” | | | |
| K14 | s | si | “-<letter><letter>si<a,o,u>-” | sh | | |
| K33 | s | sx | “-sx-” | x | | |
| K24 | s | s, | (else) | s | | |
| | | ss | “-s-” | | | |
| | | | “-ss-” | | | |
| K7 | t | tch | “-tch-” | kh | | |
| K8 | t | tu | a.)“<letter><letter>tur<vowel>-” | kh | | |
| | | | b.)“<letter><letter>tun<vowel>-” | | | |
| | | | c.)“<letter><letter>tun<vowel>-” | | | |
| | | | d.)“<letter><letter>tul<vowel>-” | | | |
| K9 | t | tu | a.)“<letter><letter>tuo-” | kho | | |
| | | <o, | b.)“<letter><letter>tua-” | | | |
| | | a, | c.)“<letter><letter>tue-” | | | |
| | | e> | | | | |
| K14 | t | ti | “-<letter><letter>ti<a,o,u>-” | sh | | |
| K24 | t | t, | (else) | t | | |
| | | tt | “-t-” | | | |
| | | | “-tt-” | | | |
| K16 | u | ue | “-ue-” AND NOT: IN K15 | oo | | |
| K21 | u | | “u-” | — | | |
| | | | “u<any # of vowels>-” | (called | | |
| | | | | “trace”) | | |
| K35 | u | | a.)“<all consonants>u-” | O | | |
| | | | b.)“<“trace”>u-” | | | |
| K37 | u | | “-<letter><letter>u” | O | | |
| K41 | u | | (else) | (deleted) | | |
| K24 | v | v, | “-v-” | v | | |
| | | vv | “-vv-” | | | |
| K4 | w | wr | “wr-” | r | | |
| K5 | w | wh | “who-” | h | | |
| K6 | w | wh | a.)“-whe-” | w | | |
| | | | b.)“-whi-” | | | |
| | | | c.)“-wha-” | | | |
| | | | d.)“-why-” | | | |
| K24 | w | w, | (else) | w | | |
| | | ww | “-w-” | | | |
| | | | “-ww-” | | | |
| K26 | x | xi | “-xion-” | xh | | |
| K24 | x | x, | (else) | x | | |
| | | xx | “-x-” | | | |
| | | | “-xx-” | | | |
| K10 | y | | “-<letter><letter>y” | Y | | |
| K12 | | | “-<vowel>y<vowel>-” | | | |
| K13 | y | | “-<consonant>y-” | i | | |
| K41 | y | | (else) | (deleted) | | |
| K2 | z | | (non initial) | s | | |
| | | | “-z-” | | | |
| | | | “-zz-” | | | |
| K24 | z | z, | (else) | z | | |
| | | zz | “z-” | | | |
| | | | “zz-” | | | |

What is claimed is:

1. A method for generating an Approximate Phonetic Representation (APR) of a given word, the word having a sequence of characters, the method comprising:
Receiving the word;
Generating the APR by applying at least one unique metaphone3 translation rule to encode one or more of the characters of the given word into a resulting APR; and
Returning the generated APR.

2. The Method of claim 1, wherein the Generating further includes applying zero or more public-domain translation rules.

3. The Method of claim 1, wherein the method further comprises: receiving a Vowel Encoding Setting with a value or either Initial-Only or All-Vowels; and the Generating further comprises encoding only an initial vowel character when the value is Initial-Only, and encoding each vowel character when the value is All-Vowels.

4. The method of claim 1, wherein the metaphone3 translation rules are selected from one or more metaphone3 Consonant vowel transposition rules.

5. The method of claim 1, wherein the metaphone3 translation rules are selected from one or more metaphone3 Familiar non-English rules.

6. The method of claim 1, wherein the metaphone3 translation rules are selected from one or more metaphone3 Vowel following consonant rules.

7. The method of claim 1, wherein the metaphone3 translation rules are selected from one or more metaphone3 H following consonant rules.

8. The method of claim 1, wherein the metaphone3 translation rules are selected from one or more metaphone3 Unpronounced consonant rules.

9. The method of claim 1, wherein the metaphone3 translation rules are selected from one or more metaphone3 Letter group rules.

10. The method of claim 1, wherein the metaphone3 translation rules are selected from one or more metaphone3 Exception Rules.

11. The method of claim 1, wherein the Generating the APR further comprises applying at least one rule from each of the following metaphone3 rules sets: Consonant Vowel Transposition Rule set and Vowel Following Consonant Rule set.

12. The method of claim 1, further comprising receiving a dictionary of words, the generating an APR of each word in the dictionary, returning the generated APR for each of the words in the dictionary.

13. The method of claim 1, further comprising receiving a dictionary of words, the generating an APR of each word in the dictionary, returning the generated APR for each of the words in the dictionary.

14. The method of claim 13, wherein the generated APR for each of the words in the dictionary is stored on a computer.

15. A method for generating an Approximate Phonetic Representation (APR) of a given word, the word having a sequence of characters, the method comprising:
Receiving the word;
Generating the APR by applying at least one metaphone3 translation rule to encode one or more of the characters of the given word into a resulting APR; and
Returning at least on Word corresponding to the resulting APR.

16. The Method of claim 15, wherein the Generating further includes applying at least one public-domain translation rules.

17. The Method of claim 15, wherein the method further comprises: receiving a Vowel Encoding Setting with a value or either Initial-Only or All-Vowels; and the Generating further comprises encoding only an initial vowel character when the value is Initial-Only, and encoding each vowel character when the value is All-Vowels.

18. The Method of claim 17, wherein the Generating the APR further comprises encoding at least one non-initial vowel character of the given word into the resulting APR.

19. A digital data processing apparatus for identifying one or more dictionary word corresponding with at least one approximate phonetic representation of a given word, said apparatus comprising:
An input means for accepting the given word;
A rule storage means for storing unique Metaphone3 rules;
An APR generation means coupled with said input means and the rule storage means for generating an APR representation of the given word;
A database storage means for storing a approximate phonetic representation corresponding to each of the one or more dictionary word, said database storage means including a storage means for storing digitally encoded information representative of said phonetic expression;
A database access means connected with said APR generation means and said database storage means for accessing the one or more dictionary word corresponding to the APR generated by the APR generation means; and
An output means connected with said database access means for generating a signal representative of the one or more dictionary word corresponding to the APR generated.

20. The digital data processing apparatus of claim 19, wherein the rule storage means further comprises a means for storing at least one public-domain translation rules.
